(19) United States
(12) Patent Application Publication
(10) Pub. No.: US 2020/0325376 A1
(43) Pub. Date: Oct. 15, 2020

(54) REFRIGERATION CYCLE APPARATUS

(71) Applicant: DAIKIN INDUSTRIES, LTD., Osaka (JP)

(72) Inventors: Eiji KUMAKURA, Osaka (JP); Takuro YAMADA, Osaka (JP); Atsushi YOSHIMI, Osaka (JP); Ikuhiro IWATA, Osaka (JP); Mitsushi ITANO, Osaka (JP); Daisuke KARUBE, Osaka (JP); Yuuki YOTSUMOTO, Osaka (JP); Kazuhiro TAKAHASHI, Osaka (JP); Tatsuya TAKAKUWA, Osaka (JP); Yuzo KOMATSU, Osaka (JP); Shun OHKUBO, Osaka (JP)

(73) Assignee: DAIKIN INDUSTRIES, LTD., Osaka (JP)

(21) Appl. No.: 16/912,161

(22) Filed: Jun. 25, 2020

Related U.S. Application Data
(63) Continuation-in-part of application No. 16/954,679, filed on Jun. 17, 2020.

(30) Foreign Application Priority Data
Dec. 18, 2017 (JP) 2017-242183
Dec. 18, 2017 (JP) 2017-242185
Dec. 18, 2017 (JP) 2017-242186
Dec. 18, 2017 (JP) 2017-242187
Oct. 5, 2018 (JP) PCT/JP2018/037483
Oct. 17, 2018 (JP) PCT/JP2018/038746
Oct. 17, 2018 (JP) PCT/JP2018/038747
Oct. 17, 2018 (JP) PCT/JP2018/038748
Oct. 17, 2018 (JP) PCT/JP2018/038749

(51) Int. Cl. C09K 5/04; F25B 9/00

(52) U.S. Cl. CPC C09K 5/045; F25B 9/006; C09K 2205/126; C09K 2205/40; C09K 2205/22

(57) ABSTRACT

A refrigeration cycle apparatus that is able to reduce the amount of refrigerant used while reducing a pressure loss in the case where a refrigerant containing at least 1,2-difluoroethylene is used is provided. In an air conditioner (1) including a refrigerant circuit (10), including a compressor (21), an outdoor heat exchanger (23), an outdoor expansion valve (24), and an indoor heat exchanger (31), and a refrigerant containing at least 1,2-difluoroethylene and sealed in the refrigerant circuit (10), the outdoor heat exchanger (23) has a heat transfer tube (23b) of which a pipe diameter is greater than or equal to 6.35 mm and less than 10.0 mm.

### TECHNICAL FIELD

The present disclosure relates to a refrigeration cycle apparatus.

### BACKGROUND ART

Hitherto, in refrigeration cycle apparatuses, such as air conditioners, R410A is often used as a refrigerant. R410A is a two-component mixed refrigerant of difluoromethane (CH₂F₂; HFC-32, or R32) and pentafluoroethane (C₂HF₅; HFC-125, or R125) and is a pseudo-azeotropic composition.

However, the global warming potential (GWP) of R410A is 2088, and, in recent years, because of growing concern about global warming, R32 that is a refrigerant having a lower GWP is used more often.

For this reason, for example, PTL 1 (International Publication No. 2015/141678) suggests various types of low-GWP refrigerant mixtures as alternatives to R410A.

As a refrigeration cycle apparatus using R32 as a refrigerant, as described in, for example, PTL 2 (Japanese Unexamined Patent Application Publication No. 2002-054888), setting a pipe diameter of each heat transfer tube of a heat exchanger to greater than or equal to 7 mm and less than or equal to 10 mm is suggested to improve energy efficiency in the case where R32 is used as a refrigerant.

### SUMMARY OF THE INVENTION

### Technical Problem

However, in the case where a refrigerant containing at least 1,2-difluoroethylene is used as a refrigerant having a sufficiently low GWP, the pipe diameter of each heat transfer tube of a heat exchanger, which is able to reduce the amount of refrigerant used while a pressure loss is reduced, has not been studied at all.

The contents of the present disclosure are described in view of the above-described points, and it is an object to provide a refrigeration cycle apparatus that is able to reduce the amount of refrigerant used while reducing a pressure loss in the case where a refrigerant containing at least 1,2-difluoroethylene is used.

### Solution to Problem

A refrigeration cycle apparatus according to a first aspect includes a refrigerant circuit and a refrigerant. The refrigerant circuit includes a compressor, a heat source-side heat exchanger, a decompression part, and a service-side heat exchanger. The refrigerant contains at least 1,2-difluoroethylene and is sealed in the refrigerant circuit. The heat source-side heat exchanger has a heat transfer tube of which a pipe diameter is greater than or equal to 6.35 mm and less than 10.0 mm.

The decompression part is not limited and may be an expansion valve or may be a capillary tube.

This refrigeration cycle apparatus is able to sufficiently reduce a GWP by using a refrigerant containing 1,2-difluoroethylene, and reduce the amount of refrigerant used while reducing a pressure loss.

A refrigeration cycle apparatus according to a second aspect is the refrigeration cycle apparatus of the first aspect, and the heat source-side heat exchanger has the heat transfer tube of which the pipe diameter is any one of 6.35 mm, 7.0 mm, 8.0 mm, and 9.5 mm.

A refrigeration cycle apparatus according to a third aspect is the refrigeration cycle apparatus of the first aspect or the second aspect, and the heat source-side heat exchanger has the heat transfer tube of which the pipe diameter is greater than or equal to 7.0 mm.

A refrigeration cycle apparatus according to a fourth aspect includes a refrigerant circuit and a refrigerant. The refrigerant circuit includes a compressor, a heat source-side heat exchanger, a decompression part, and a service-side heat exchanger. The refrigerant contains at least 1,2-difluoroethylene and is sealed in the refrigerant circuit. The service-side heat exchanger has a heat transfer tube of which a pipe diameter is greater than or equal to 4.0 mm and less than 10.0 mm.

This refrigeration cycle apparatus is able to sufficiently reduce a GWP by using a refrigerant containing 1,2-difluoroethylene, and reduce the amount of refrigerant used while reducing a pressure loss.

A refrigeration cycle apparatus according to a fifth aspect is the refrigeration cycle apparatus of the fourth aspect, and the service-side heat exchanger has the heat transfer tube of which the pipe diameter is less than or equal to 8.0 mm.

A refrigeration cycle apparatus according to a sixth aspect is the refrigeration cycle apparatus of the fourth aspect or the fifth aspect, and the service-side heat exchanger has the heat transfer tube of which the pipe diameter is any one of 4.0 mm, 5.0 mm, 6.35 mm, 7.0 mm, and 8.0 mm.
A refrigeration cycle apparatus according to a seventh aspect is the refrigeration cycle apparatus according to any of the first through sixth aspects, wherein
the refrigerant comprises trans-1,2-difluoroethylene (HFO-1132(E)), trifluoroethylene (HFO-1123), and 2,3,3,3-tetrafluoro-1-propene (R1234yf).

With this refrigeration cycle apparatus, high energy efficiency can be obtained by using a refrigerant having such performance that the refrigerant has a sufficiently low GWP and a refrigeration capacity (which may be referred to as cooling capacity or capacity) and a coefficient of performance (COP) equivalent to those of R410A.
A refrigeration cycle apparatus according to an eighth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.
A refrigeration cycle apparatus according to a ninth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
A refrigeration cycle apparatus according to a tenth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
A refrigeration cycle apparatus according to an eleventh aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PL is represented by coordinates (x, −0.1135x²+12.112x−280.43, 0.1135x²−13.112x+380.43)
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.
A refrigeration cycle apparatus according to a twelfth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
A refrigeration cycle apparatus according to a thirteenth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
A refrigeration cycle apparatus according to a fourteenth aspect is the refrigeration cycle apparatus according to the seventh aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
A refrigeration cycle apparatus according to a fifteenth aspect is the refrigeration cycle apparatus according to any of the first through sixth aspects, wherein
the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.

With this refrigeration cycle apparatus, high energy efficiency can be obtained by using a refrigerant having such performance that the refrigerant has a sufficiently low GWP and a coefficient of performance (COP) and a refrigeration capacity (which may be referred to as cooling capacity or capacity) equivalent to those of R410A and is classified with lower flammability (class 2L) under the standard of American Society of Heating Refrigeration and Air Conditioning Engineers (ASHRAE).
A refrigeration cycle apparatus according to a sixteenth aspect is the refrigeration cycle apparatus according to any of the first through sixth aspects, wherein
the refrigerant comprises HFO-1132(E) and HFO-1123 in a total amount of 99.5 mass % or more based on the entire refrigerant, and
the refrigerant comprises 45.1 mass % to 47.1 mass % of HFO-1132(E) based on the entire refrigerant.

With this refrigeration cycle apparatus, high energy efficiency can be obtained by using a refrigerant having such performance that the refrigerant has a sufficiently low GWP and a coefficient of performance (COP) and a refrigeration capacity (which may be referred to as cooling capacity or capacity) equivalent to those of R410A and is classified with lower flammability (class 2L) under the standard of American Society of Heating Refrigeration and Air Conditioning Engineers (ASHRAE).
A refrigeration cycle apparatus according to a seventeenth aspect is the refrigeration cycle apparatus according to any of the first through sixth aspects, wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801), and
   point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682), and
   point W (0.0, 100.0−a, 0.0),
   or on the straight lines GI and AB (excluding point G, point I, point A, point B, and point W);

if 26.7<a≤36.7, coordinates (x,y,z) in the ternary composition diagram are within the range of a figure surrounded by straight lines GI, IA, AB, BW, and WG that connect the following 5 points:

point G (0.0111a²−1.3152a+68.986, −0.0111a²+0.3152a+31.014, 0.0),
point I (0.0111a²−1.3152a+68.986, 0.0, −0.0111a²+0.3152a+31.014),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines GI and AB (excluding point G, point I, point A, point B, and point W);
and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines GI and AB (excluding point G, point I, point A, point B, and point W).

With this refrigeration cycle apparatus, high energy efficiency can be obtained by using a refrigerant having such performance that the refrigerant has a sufficiently low GWP and a refrigeration capacity (which may be referred to as cooling capacity or capacity) and a coefficient of performance (COP) equivalent to those of R410A.
A refrigeration cycle apparatus according to an eighteenth aspect is the refrigeration cycle apparatus according to any of the first through sixth aspects, wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636, −0.0105a²+0.8577a+33.177),
   point B (0.0, 0.0075a²−1.5156a+58.199, −0.0075a²+0.5156a+41.801), and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682), and
   point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714), and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines JK′, K′A, and AB (excluding point J, point B, and point W).

With this refrigeration cycle apparatus, high energy efficiency can be obtained by using a refrigerant having such performance that the refrigerant has a sufficiently low GWP and a refrigeration capacity (which may be referred to as cooling capacity or capacity) and a coefficient of performance (COP) equivalent to those of R410A.
A refrigeration cycle apparatus according to a nineteenth aspect is the refrigeration cycle apparatus according to any of the first through sixth aspects, wherein
the refrigerant comprises trans-1,2-difluoroethylene (HFO-1132(E)), difluoromethane (R32), and 2,3,3,3-tetrafluoro-1-propene (R1234yf),
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments U, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI;
the line segment U is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.

With this refrigeration cycle apparatus, high energy efficiency can be obtained by using a refrigerant having such performance that the refrigerant has a sufficiently low GWP and a refrigeration capacity (which may be referred to as cooling capacity or capacity) equivalent to that of R410A and is classified with lower flammability (class 2L) under the standard of American Society of Heating Refrigeration and Air Conditioning Engineers (ASHRAE).
A refrigeration cycle apparatus according to a twentieth aspect is the refrigeration cycle apparatus according to any of the first through sixth aspects, wherein
the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′(39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.

With this refrigeration cycle apparatus, high energy efficiency can be obtained by using a refrigerant having such performance that the refrigerant has a sufficiently low GWP and a refrigeration capacity (which may be referred to as cooling capacity or capacity) equivalent to that of R410A and is classified with lower flammability (class 2L) under the standard of American Society of Heating Refrigeration and Air Conditioning Engineers (ASHRAE).
A refrigeration cycle apparatus according to a twenty first aspect is the refrigeration cycle apparatus according to any of the first through sixth aspects, wherein
the refrigerant comprises HFO-1132(E), R32, and R1234yf,
   wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.

With this refrigeration cycle apparatus, high energy efficiency can be obtained by using a refrigerant having such performance that the refrigerant has a sufficiently low GWP and a refrigeration capacity (which may be referred to as cooling capacity or capacity) equivalent to that of R410A and is classified with lower flammability (class 2L) under the standard of American Society of Heating Refrigeration and Air Conditioning Engineers (ASHRAE).
A refrigeration cycle apparatus according to a twenty second aspect is the refrigeration cycle apparatus according to any of the first through sixth aspects, wherein
the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.

With this refrigeration cycle apparatus, high energy efficiency can be obtained by using a refrigerant having such performance that the refrigerant has a sufficiently low GWP and a refrigeration capacity (which may be referred to as cooling capacity or capacity) equivalent to that of R410A and is classified with lower flammability (class 2L) under the standard of American Society of Heating Refrigeration and Air Conditioning Engineers (ASHRAE).
A refrigeration cycle apparatus according to a twenty third aspect is the refrigeration cycle apparatus according to any of the first through sixth aspects, wherein
the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.

With this refrigeration cycle apparatus, high energy efficiency can be obtained by using a refrigerant having such performance that the refrigerant has a sufficiently low GWP and a refrigeration capacity (which may be referred to as cooling capacity or capacity) equivalent to that of R410A and is classified with lower flammability (class 2L) under the standard of American Society of Heating Refrigeration and Air Conditioning Engineers (ASHRAE).
A refrigeration cycle apparatus according to a twenty fourth aspect is the refrigeration cycle apparatus according to any of the first through sixth aspects, wherein
the refrigerant comprises trans-1,2-difluoroethylene (HFO-1132(E)), trifluoroethylene (HFO-1123), and difluoromethane (R32),
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines.

With this refrigeration cycle apparatus, high energy efficiency can be obtained by using a refrigerant having such performance that the refrigerant has a sufficiently low GWP and a coefficient of performance (COP) equivalent to that of R410A.
A refrigeration cycle apparatus according to a twenty fifth aspect is the refrigeration cycle apparatus according to any of the first through sixth aspects, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments U, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment U is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines.

With this refrigeration cycle apparatus, high energy efficiency can be obtained by using a refrigerant having such performance that the refrigerant has a sufficiently low GWP and a coefficient of performance (COP) equivalent to that of R410A.
A refrigeration cycle apparatus according to a twenty sixth aspect is the refrigeration cycle apparatus according to any of the first through sixth aspects, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines.

With this refrigeration cycle apparatus, high energy efficiency can be obtained by using a refrigerant having such performance that the refrigerant has a sufficiently low GWP and a coefficient of performance (COP) equivalent to that of R410A.
A refrigeration cycle apparatus according to a twenty seventh aspect is the refrigeration cycle apparatus according to any of the first through sixth aspects, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z), and
the line segments JR and GI are straight lines.

With this refrigeration cycle apparatus, high energy efficiency can be obtained by using a refrigerant having such performance that the refrigerant has a sufficiently low GWP and a coefficient of performance (COP) equivalent to that of R410A.
A refrigeration cycle apparatus according to a twenty eighth aspect is the refrigeration cycle apparatus according to any of the first through sixth aspects, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line.

With this refrigeration cycle apparatus, high energy efficiency can be obtained by using a refrigerant having such performance that the refrigerant has a sufficiently low GWP and a coefficient of performance (COP) equivalent to that of R410A.
A refrigeration cycle apparatus according to a twenty ninth aspect is the refrigeration cycle apparatus according to any of the first through sixth aspects, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines.
With this refrigeration cycle apparatus, high energy efficiency can be obtained by using a refrigerant having such performance that the refrigerant has a sufficiently low GWP and a coefficient of performance (COP) equivalent to that of R410A.

### BRIEF DESCRIPTION OF THE DRAWINGS

FIG. 1 is a schematic view of an instrument used for a flammability test.

FIG. 2 is a diagram showing points A to T and line segments that connect these points in a ternary composition diagram in which the sum of HFO-1132(E), HFO-1123, and R1234yf is 100 mass %.

FIG. 3 is a diagram showing points A to C, D′, G, I, J, and K′, and line segments that connect these points to each other in a ternary composition diagram in which the sum of HFO-1132(E), HFO-1123, and R1234yf is (100−a) mass %.

FIG. 4 is a diagram showing points A to C, D′, G, I, J, and K′, and line segments that connect these points to each other in a ternary composition diagram in which the sum of HFO-1132(E), HFO-1123, and R1234yf is 92.9 mass % (the content of R32 is 7.1 mass %).

FIG. 5 is a diagram showing points A to C, D′, G, I, J, K′, and W, and line segments that connect these points to each other in a ternary composition diagram in which the sum of HFO-1132(E), HFO-1123, and R1234yf is 88.9 mass % (the content of R32 is 11.1 mass %).

FIG. 6 is a diagram showing points A, B, G, I, J, K′, and W, and line segments that connect these points to each other in a ternary composition diagram in which the sum of HFO-1132(E), HFO-1123, and R1234yf is 85.5 mass % (the content of R32 is 14.5 mass %).

FIG. 7 is a diagram showing points A, B, G, I, J, K′, and W, and line segments that connect these points to each other in a ternary composition diagram in which the sum of HFO-1132(E), HFO-1123, and R1234yf is 81.8 mass % (the content of R32 is 18.2 mass %).

FIG. 8 is a diagram showing points A, B, G, I, J, K′, and W, and line segments that connect these points to each other in a ternary composition diagram in which the sum of HFO-1132(E), HFO-1123, and R1234yf is 78.1 mass % (the content of R32 is 21.9 mass %).

FIG. 9 is a diagram showing points A, B, G, I, J, K′, and W, and line segments that connect these points to each other in a ternary composition diagram in which the sum of HFO-1132(E), HFO-1123, and R1234yf is 73.3 mass % (the content of R32 is 26.7 mass %).

FIG. 10 is a diagram showing points A, B, G, I, J, K′, and W, and line segments that connect these points to each other in a ternary composition diagram in which the sum of HFO-1132(E), HFO-1123, and R1234yf is 70.7 mass % (the content of R32 is 29.3 mass %).

FIG. 11 is a diagram showing points A, B, G, I, J, K′, and W, and line segments that connect these points to each other in a ternary composition diagram in which the sum of HFO-1132(E), HFO-1123, and R1234yf is 63.3 mass % (the content of R32 is 36.7 mass %).

FIG. 12 is a diagram showing points A, B, G, I, J, K′, and W, and line segments that connect these points to each other in a ternary composition diagram in which the sum of HFO-1132(E), HFO-1123, and R1234yf is 55.9 mass % (the content of R32 is 44.1 mass %).

FIG. 13 is a diagram showing points A, B, G, I, J, K′, and W, and line segments that connect these points to each other in a ternary composition diagram in which the sum of HFO-1132(E), HFO-1123, and R1234yf is 52.2 mass % (the content of R32 is 47.8 mass %).

FIG. 14 is a view showing points A to C, E, G, and I to W; and line segments that connect points A to C, E, G, and I to W in a ternary composition diagram in which the sum of HFO-1132(E), R32, and R1234yf is 100 mass %.

FIG. 15 is a view showing points A to U; and line segments that connect the points in a ternary composition diagram in which the sum of HFO-1132(E), HFO-1123, and R32 is 100 mass %.

FIG. 16 is a schematic configuration diagram of a refrigerant circuit according to a first embodiment.

FIG. 17 is a schematic control block configuration diagram of a refrigeration cycle apparatus according to the first embodiment.

FIG. 18 is a schematic appearance perspective view of an outdoor unit according to the first embodiment.

FIG. 19 is a perspective view that shows the schematic structure of the inside of the outdoor unit according to the first embodiment.

FIG. 20 is a schematic appearance perspective view of an indoor unit according to the first embodiment.

FIG. 21 is a side cross-sectional view that shows the schematic structure of the inside of the indoor unit according to the first embodiment.

FIG. 22 is a schematic configuration diagram of a refrigerant circuit according to a second embodiment.

FIG. 23 is a schematic control block configuration diagram of a refrigeration cycle apparatus according to the second embodiment.

FIG. 24 is a schematic appearance perspective view of an outdoor unit according to the second embodiment.

FIG. 25 is a perspective view that shows the schematic structure of the inside of the outdoor unit according to the second embodiment.

FIG. 26 is a schematic appearance perspective view of an indoor unit according to the second embodiment.

FIG. 27 is a side cross-sectional view that shows the schematic structure of the inside of the indoor unit according to the second embodiment.

FIG. 28 is a schematic configuration diagram of a refrigerant circuit according to a third embodiment.

FIG. 29 is a schematic control block configuration diagram of a refrigeration cycle apparatus according to the third embodiment.

FIG. 30 is a schematic appearance perspective view of an outdoor unit according to the third embodiment.

FIG. 31 is an exploded perspective view that shows the schematic structure of the inside of the outdoor unit according to the third embodiment.

### DESCRIPTION OF EMBODIMENTS

### (1) Definition of Terms

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC). Non-fluorocarbon compounds include propane (R290), propylene (R1270), butane (R600), isobutane (R600a), carbon dioxide (R744), ammonia (R717), and the like.

In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”

In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller.

The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.

In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.

In the present specification, a refrigerant having a “WCF lower flammability” means that the most flammable composition (worst case of formulation for flammability: WCF) has a burning velocity of 10 cm/s or less according to the US ANSI/ASHRAE Standard 34-2013. Further, in the present specification, a refrigerant having

“ASHRAE lower flammability” means that the burning velocity of WCF is 10 cm/s or less, that the most flammable fraction composition (worst case of fractionation for flammability: WCFF), which is specified by performing a leakage test during storage, shipping, or use based on ANSI/ASHRAE 34-2013 using WCF, has a burning velocity of 10 cm/s or less, and that flammability classification according to the US ANSI/ASHRAE Standard 34-2013 is determined to classified as be “Class 2L.”

In the present specification, a refrigerant having an “RCL of x % or more” means that the refrigerant has a refrigerant concentration limit (RCL), calculated in accordance with the US ANSI/ASHRAE Standard 34-2013, of x % or more. RCL refers to a concentration limit in the air in consideration of safety factors. RCL is an index for reducing the risk of acute toxicity, suffocation, and flammability in a closed space where humans are present. RCL is determined in accordance with the ASHRAE Standard. More specifically,

RCL is the lowest concentration among the acute toxicity exposure limit (ATEL), the oxygen deprivation limit (ODL), and the flammable concentration limit (FCL), which are respectively calculated in accordance with sections 7.1.1, 7.1.2, and 7.1.3 of the ASHRAE Standard.

In the present specification, temperature glide refers to an absolute value of the difference between the initial temperature and the end temperature in the phase change process of a composition containing the refrigerant of the present disclosure in the heat exchanger of a refrigerant system.

### (2) Refrigerant

### (2-1) Refrigerant Component

Any one of various refrigerants such as refrigerant A, refrigerant B, refrigerant C, refrigerant D, and refrigerant E, details of these refrigerant are to be mentioned later, can be used as the refrigerant.

### (2-2) Use of Refrigerant

The refrigerant according to the present disclosure can be preferably used as a working fluid in a refrigerating machine.

The composition according to the present disclosure is suitable for use as an alternative refrigerant for HFC refrigerant such as R410A, R407C and R404 etc, or HCFC refrigerant such as R22 etc.

### (3) Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.

The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil.

Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### (3-1) Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

### (3-2) Tracer

A tracer is added to the refrigerant composition according to the present disclosure at a detectable concentration such that when the refrigerant composition has been diluted, contaminated, or undergone other changes, the tracer can trace the changes.

The refrigerant composition according to the present disclosure may comprise a single tracer, or two or more tracers.

The tracer is not limited, and can be suitably selected from commonly used tracers. Preferably, a compound that cannot be an impurity inevitably mixed in the refrigerant of the present disclosure is selected as the tracer.

Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a fluorocarbon, a hydrochlorocarbon, a fluorocarbon, or a fluoroether.

The following compounds are preferable as the tracer.

FC-14 (tetrafluoromethane, CF₄)
HCC-40 (chloromethane, CH₃Cl)
HFC-23 (trifluoromethane, CHF₃)
HFC-41 (fluoromethane, CH₃Cl)
HFC-125 (pentafluoroethane, CF₃CHF₂)
HFC-134a (1,1,1,2-tetrafluoroethane, CF₃CH₂F)
HFC-134 (1,1,2,2-tetrafluoroethane, CHF₂CHF₂)
HFC-143a (1,1,1-trifluoroethane, CF₃CH₃)
HFC-143 (1,1,2-trifluoroethane, CHF₂CH₂F)
HFC-152a (1,1-difluoroethane, CHF₂CH₃)
HFC-152 (1,2-difluoroethane, CH₂FCH₂F)
HFC-161 (fluoroethane, CH₃CH₂F)
HFC-245fa (1,1,1,3,3-pentafluoropropane, CF₃CH₂CHF₂)
HFC-236fa (1,1,1,3,3,3-hexafluoropropane, CF₃CH₂CF₃)
HFC-236ea (1,1,1,2,3,3-hexafluoropropane, CF₃CHFCHF₂)
HFC-227ea (1,1,1,2,3,3,3-heptafluoropropane, CF₃CHFCF₃)
HCFC-22 (chlorodifluoromethane, CHClF₂)
HCFC-31 (chlorofluoromethane, CH₂C₁F)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether, CF₃OCH₂F)
HFE-143a (trifluoromethyl-methyl ether, CF₃OCH₃)
HFE-227ea (trifluoromethyl-tetrafluoroethyl ether, CF₃OCHFCF₃)
HFE-236fa (trifluoromethyl-trifluoroethyl ether, CF₃OCH₂CF₃)

The tracer compound may be present in the refrigerant composition at a total concentration of about 10 parts per million (ppm) to about 1000 ppm. Preferably, the tracer compound is present in the refrigerant composition at a total concentration of about 30 ppm to about 500 ppm, and most preferably, the tracer compound is present at a total concentration of about 50 ppm to about 300 ppm.

### (3-3) Ultraviolet Fluorescent Dye

The refrigerant composition according to the present disclosure may comprise a single ultraviolet fluorescent dye, or two or more ultraviolet fluorescent dyes.

The ultraviolet fluorescent dye is not limited, and can be suitably selected from commonly used ultraviolet fluorescent dyes.

Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### (3-4) Stabilizer

The refrigerant composition according to the present disclosure may comprise a single stabilizer, or two or more stabilizers.

The stabilizer is not limited, and can be suitably selected from commonly used stabilizers.

Examples of stabilizers include nitro compounds, ethers, and amines.

Examples of nitro compounds include aliphatic nitro compounds, such as nitromethane and nitroethane; and aromatic nitro compounds, such as nitro benzene and nitro styrene.

Examples of ethers include 1,4-dioxane.

Examples of amines include 2,2,3,3,3-pentafluoropropylamine and diphenylamine.

Examples of stabilizers also include butylhydroxyxylene and benzotriazole.

The content of the stabilizer is not limited. Generally, the content of the stabilizer is preferably 0.01 to 5 mass %, and more preferably 0.05 to 2 mass %, based on the entire refrigerant.

### (3-5) Polymerization Inhibitor

The refrigerant composition according to the present disclosure may comprise a single polymerization inhibitor, or two or more polymerization inhibitors.

The polymerization inhibitor is not limited, and can be suitably selected from commonly used polymerization inhibitors.

Examples of polymerization inhibitors include 4-methoxy-1-naphthol, hydroquinone, hydroquinone methyl ether, dimethyl-t-butylphenol, 2,6-di-tert-butyl-p-cresol, and benzotriazole.

The content of the polymerization inhibitor is not limited. Generally, the content of the polymerization inhibitor is preferably 0.01 to 5 mass %, and more preferably 0.05 to 2 mass %, based on the entire refrigerant.

### (4) Refrigeration Oil—Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### (4-1) Refrigeration Oil

The refrigeration oil is not limited, and can be suitably selected from commonly used refrigeration oils. In this case, refrigeration oils that are superior in the action of increasing the miscibility with the mixture and the stability of the mixture, for example, are suitably selected as necessary.

The base oil of the refrigeration oil is preferably, for example, at least one member selected from the group consisting of polyalkylene glycols (PAG), polyol esters (POE), and polyvinyl ethers (PVE).

The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.

A refrigeration oil with a kinematic viscosity of 5 to 400 cSt at 40° C. is preferable from the standpoint of lubrication.

The refrigeration oil-containing working fluid according to the present disclosure may further optionally contain at least one additive. Examples of additives include compatibilizing agents described below.

### (4-2) Compatibilizing Agent

The refrigeration oil-containing working fluid according to the present disclosure may comprise a single compatibilizing agent, or two or more compatibilizing agents.

The compatibilizing agent is not limited, and can be suitably selected from commonly used compatibilizing agents.

Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### (5) Various Refrigerants

Hereinafter, the refrigerants A to E, which are the refrigerants used in the present embodiment, will be described in detail.

In addition, each description of the following refrigerant A, refrigerant B, refrigerant C, refrigerant D, and refrigerant E is each independent. The alphabet which shows a point or a line segment, the number of an Examples, and the number of a comparative examples are all independent of each other among the refrigerant A, the refrigerant B, the refrigerant C, the refrigerant D, and the refrigerant E. For example, the first embodiment of the refrigerant A and the first embodiment of the refrigerant B are different embodiment from each other.

### (5-1) Refrigerant A

The refrigerant A according to the present disclosure is a mixed refrigerant comprising trans-1,2-difluoroethylene (HFO-1132(E)), trifluoroethylene (HFO-1123), and 2,3,3,3-tetrafluoro-1-propene (R1234yf).

The refrigerant A according to the present disclosure has various properties that are desirable as an R410A-alternative refrigerant, i.e., a refrigerating capacity and a coefficient of performance that are equivalent to those of R410A, and a sufficiently low GWP.

The refrigerant A according to the present disclosure is a composition comprising HFO-1132(E) and R1234yf, and optionally further comprising HFO-1123, and may further satisfy the following requirements. This refrigerant also has various properties desirable as an alternative refrigerant for R410A; i.e., it has a refrigerating capacity and a coefficient of performance that are equivalent to those of R410A, and a sufficiently low GWP.

### Requirements

Preferable refrigerant A is as follows:

When the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:

point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0),
point C (32.9, 67.1, 0.0), and
point O (100.0, 0.0, 0.0),
or on the above line segments (excluding the points on the line CO);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3,
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and the line segments BD, CO, and OA are straight lines.
When the requirements above are satisfied, the refrigerant according to the present disclosure has a refrigerating capacity ratio of 85% or more relative to that of R410A, and a COP of 92.5% or more relative to that of R410A.
When the mass % of HFO-1132(E), HFO-1123, and R1234yf, based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant A has a WCF lower flammability according to the ASHRAE Standard (the WCF composition has a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²-0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant exhibits a lower flammability (Class 2L) according to the ASHRAE Standard (the WCF composition and the WCFF composition have a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point (32.9, 67.1, 0.0),
   or on the above line segments (excluding the points on the line segment CJ);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

When the requirements above are satisfied, the refrigerant according to the present disclosure has a refrigerating capacity ratio of 85% or more relative to that of R410A, and a COP of 92.5% or more relative to that of R410A; furthermore, the refrigerant has an RCL of 40 g/m³ or more.
When the mass % of HFO-1132(E), HFO-1123, and R1234yf based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
When the requirements above are satisfied, the refrigerant according to the present disclosure has a refrigerating capacity ratio of 85% or more relative to that of R410A, and a COP of 95% or more relative to that of R410A; furthermore, the refrigerant has an RCL of 40 g/m³ or more.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
When the requirements above are satisfied, the refrigerant according to the present disclosure has a COP of 95% or more relative to that of R410A, and an RCL of 40 g/m³ or more, furthermore, the refrigerant has a condensation temperature glide of 1° C. or less.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′(30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
When the requirements above are satisfied, the refrigerant according to the present disclosure has a refrigerating capacity ratio of 85% or more relative to that of R410A, a COP of 95% or more relative to that of R410A, and an RCL of 40 g/m³ or more furthermore, the refrigerant has a discharge pressure of 105% or more relative to that of R410A.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments Od, dg, gh, and hO that connect the following 4 points:
   point d (87.6, 0.0, 12.4),
   point g (18.2, 55.1, 26.7),
   point h (56.7, 43.3, 0.0), and
   point o (100.0, 0.0, 0.0),
   or on the line segments Od, dg, gh, and hO (excluding the points O and h);
the line segment dg is represented by coordinates (0.0047y²−1.5177y+87.598, y, −0.0047y²+0.5177y+12.402),
the line segment gh is represented by coordinates (−0.0134z²−1.0825z+56.692, 0.0134z²+0.0825z+43.308, z), and
the line segments hO and Od are straight lines.
When the requirements above are satisfied, the refrigerant according to the present disclosure has a refrigerating capacity ratio of 92.5% or more relative to that of R410A, and a COP ratio of 92.5% or more relative to that of R410A.
The refrigerant A according to the present disclosure is preferably a refrigerant wherein
when the mass % of HFO-1132(E), HFO-1123, and R1234yf, based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments lg, gh, hi, and il that connect the following 4 points:
   point l (72.5, 10.2, 17.3),
   point g (18.2, 55.1, 26.7),
   point h (56.7, 43.3, 0.0), and
   point i (72.5, 27.5, 0.0) or
   on the line segments lg, gh, and il (excluding the points h and i);
the line segment lg is represented by coordinates (0.0047y²−1.5177y+87.598, y, −0.0047y²+0.5177y+12.402),
the line gh is represented by coordinates (−0.0134z²−1.0825z+56.692, 0.0134z²+0.0825z+43.308, z), and
the line segments hi and il are straight lines.
When the requirements above are satisfied, the refrigerant according to the present disclosure has a refrigerating capacity ratio of 92.5% or more relative to that of R410A, and a COP ratio of 92.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments Od, de, ef, and fO that connect the following 4 points:
   point d (87.6, 0.0, 12.4),
   point e (31.1, 42.9, 26.0),
   point f (65.5, 34.5, 0.0), and
   point O (100.0, 0.0, 0.0),
   or on the line segments Od, de, and ef (excluding the points O and f);
the line segment de is represented by coordinates (0.0047y²−1.5177y+87.598, y, −0.0047y²+0.5177y+12.402),
the line segment ef is represented by coordinates (−0.0064z²−1.1565z+65.501, 0.0064z²+0.1565z+34.499, z), and
the line segments fO and Od are straight lines.
When the requirements above are satisfied, the refrigerant according to the present disclosure has a refrigerating capacity ratio of 93.5% or more relative to that of R410A, and a COP ratio of 93.5% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments le, ef, fi, and il that connect the following 4 points:
   point l (72.5, 10.2, 17.3),
   point e (31.1, 42.9, 26.0),
   point f (65.5, 34.5, 0.0), and
   point i (72.5, 27.5, 0.0),
   or on the line segments le, ef, and il (excluding the points f and i);
the line segment le is represented by coordinates (0.0047y²−1.5177y+87.598, y, −0.0047y²+0.5177y+12.402),
the line segment ef is represented by coordinates (−0.0134z²−1.0825z+56.692, 0.0134z²+0.0825z+43.308, z), and
the line segments fi and il are straight lines.
When the requirements above are satisfied, the refrigerant according to the present disclosure has a refrigerating capacity ratio of 93.5% or more relative to that of R410A, and a COP ratio of 93.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments Oa, ab, bc, and cO that connect the following 4 points:
   point a (93.4, 0.0, 6.6),
   point b (55.6, 26.6, 17.8),
   point c (77.6, 22.4, 0.0), and
   point O (100.0, 0.0, 0.0),
   or on the line segments Oa, ab, and bc (excluding the points O and c);
the line segment ab is represented by coordinates (0.0052y²−1.5588y+93.385, y, −0.0052y²+0.5588y+6.615),
the line segment bc is represented by coordinates (−0.0032z²−1.1791z+77.593, 0.0032z²+0.1791z+22.407, z), and
the line segments cO and Oa are straight lines.
When the requirements above are satisfied, the refrigerant according to the present disclosure has a refrigerating capacity ratio of 95% or more relative to that of R410A, and a COP ratio of 95% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments kb, bj, and jk that connect the following 3 points:
   point k (72.5, 14.1, 13.4),
   point b (55.6, 26.6, 17.8), and
   point j (72.5, 23.2, 4.3),
   or on the line segments kb, bj, and jk;
the line segment kb is represented by coordinates (0.0052y²−1.5588y+93.385, y, and −0.0052y²+0.5588y+6.615),
the line segment bj is represented by coordinates (−0.0032z²−1.1791z+77.593, 0.0032z²+0.1791z+22.407, z), and
the line segment jk is a straight line.
When the requirements above are satisfied, the refrigerant according to the present disclosure has a refrigerating capacity ratio of 95% or more relative to that of R410A, and a COP ratio of 95% or more relative to that of R410A; furthermore, the refrigerant has a lower flammability (Class 2L) according to the ASHRAE Standard.
The refrigerant according to the present disclosure may further comprise other additional refrigerants in addition to HFO-1132(E), HFO-1123, and R1234yf, as long as the above properties and effects are not impaired. In this respect, the refrigerant according to the present disclosure preferably comprises HFO-1132(E), HFO-1123, and R1234yf in a total amount of 99.5 mass % or more, more preferably 99.75 mass % or more, and still more preferably 99.9 mass % or more, based on the entire refrigerant.
The refrigerant according to the present disclosure may comprise HFO-1132(E), HFO-1123, and R1234yf in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### (Examples of Refrigerant A)

The present disclosure is described in more detail below with reference to Examples of refrigerant A. However, refrigerant A is not limited to the Examples.
The GWP of R1234yf and a composition consisting of a mixed refrigerant R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of R410A and compositions each comprising a mixture of HFO-1132(E), HFO-1123, and R1234yf was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
Further, the RCL of the mixture was calculated with the LFL of HFO-1132(E) being 4.7 vol. %, the LFL of HFO-1123 being 10 vol. %, and the LFL of R1234yf being 6.2 vol. %, in accordance with the ASHRAE Standard 34-2013.
   Evaporating temperature: 5° C.
   Condensation temperature: 45° C.
   Degree of superheating: 5 K
   Degree of subcooling: 5 K
   Compressor efficiency: 70%
Tables 1 to 34 show these values together with the GWP of each mixed refrigerant.

TABLE 1

| | | | Comp. | Comp. | | Example | | Comp. |
|---|---|---|---|---|---|---|---|---|
| | | Comp. | Ex. 2 | Ex. 3 | Example | 2 | Example | Ex. 4 |
| Item | Unit | Ex. 1 | O | A | 1 | A′ | 3 | B |
| HFO-1132(E) | mass % | R410A | 100.0 | 68.6 | 49.0 | 30.6 | 14.1 | 0.0 |
| HFO-1123 | mass % | | 0.0 | 0.0 | 14.9 | 30.0 | 44.8 | 58.7 |
| R1234yf | mass % | | 0.0 | 31.4 | 36.1 | 39.4 | 41.1 | 41.3 |
| GWP | — | 2088 | 1 | 2 | 2 | 2 | 2 | 2 |
| COP ratio | % (relative to | 100 | 99.7 | 100.0 | 98.6 | 97.3 | 96.3 | 95.5 |
| | 410A) | | | | | | | |
| Refrigerating | % (relative to | 100 | 98.3 | 85.0 | 85.0 | 85.0 | 85.0 | 85.0 |
| capacity ratio | 410A) | | | | | | | |
| Condensation | ° C. | 0.1 | 0.00 | 1.98 | 3.36 | 4.46 | 5.15 | 5.35 |
| glide | | | | | | | | |
| Discharge | % (relative to | 100.0 | 99.3 | 87.1 | 88.9 | 90.6 | 92.1 | 93.2 |
| pressure | 410A) | | | | | | | |
| RCL | g/m³ | — | 30.7 | 37.5 | 44.0 | 52.7 | 64.0 | 78.6 |

TABLE 2

| | | Comp. | | Example | | Comp. | Comp. | Example | Comp. |
|---|---|---|---|---|---|---|---|---|---|
| | | Ex. 5 | Example | 5 | Example | Ex. 6 | Ex. 7 | 7 | Ex. 8 |
| Item | Unit | C | 4 | C′ | 6 | D | E | E′ | F |
| HFO-1132(E) | mass % | 32.9 | 26.6 | 19.5 | 10.9 | 0.0 | 58.0 | 23.4 | 0.0 |
| HFO-1123 | mass % | 67.1 | 68.4 | 70.5 | 74.1 | 80.4 | 42.0 | 48.5 | 61.8 |
| R1234yf | mass % | 0.0 | 5.0 | 10.0 | 15.0 | 19.6 | 0.0 | 28.1 | 38.2 |
| GWP | — | 1 | 1 | 1 | 1 | 2 | 1 | 2 | 2 |
| COP ratio | % | 92.5 | 92.5 | 92.5 | 92.5 | 92.5 | 95.0 | 95.0 | 95.0 |
| | (relative | | | | | | | | |
| | to 410A) | | | | | | | | |
| Refrigerating | % | 107.4 | 105.2 | 102.9 | 100.5 | 97.9 | 105.0 | 92.5 | 86.9 |
| capacity ratio | (relative | | | | | | | | |
| | to 410A) | | | | | | | | |
| Condensation | ° C. | 0.16 | 0.52 | 0.94 | 1.42 | 1.90 | 0.42 | 3.16 | 4.80 |
| glide | | | | | | | | | |
| Discharge | % | 119.5 | 117.4 | 115.3 | 113.0 | 115.9 | 112.7 | 101.0 | 95.8 |
| pressure | (relative | | | | | | | | |
| | to 410A) | | | | | | | | |
| RCL | g/m³ | 53.5 | 57.1 | 62.0 | 69.1 | 81.3 | 41.9 | 46.3 | 79.0 |

TABLE 3

| | | Comp. | Example | Example | Example | Example | Example |
|---|---|---|---|---|---|---|---|
| | | Ex. 9 | 8 | 9 | 10 | 11 | 12 |
| Item | Unit | J | P | L | N | N′ | K |
| HFO-1132(E) | mass % | 47.1 | 55.8 | 63.1 | 68.6 | 65.0 | 61.3 |
| HFO-1123 | mass % | 52.9 | 42.0 | 31.9 | 16.3 | 7.7 | 5.4 |
| R1234yf | mass % | 0.0 | 2.2 | 5.0 | 15.1 | 27.3 | 33.3 |
| GWP | — | 1 | 1 | 1 | 1 | 2 | 2 |
| COP ratio | % (relative to | 93.8 | 95.0 | 96.1 | 97.9 | 99.1 | 99.5 |
| | 410A) | | | | | | |
| Refrigerating capacity | % (relative to | 106.2 | 104.1 | 101.6 | 95.0 | 88.2 | 85.0 |
| ratio | 410A) | | | | | | |
| Condensation glide | ° C. | 0.31 | 0.57 | 0.81 | 1.41 | 2.11 | 2.51 |
| Discharge pressure | % (relative to | 115.8 | 111.9 | 107.8 | 99.0 | 91.2 | 87.7 |
| | 410A) | | | | | | |
| RCL | g/m³ | 46.2 | 42.6 | 40.0 | 38.0 | 38.7 | 39.7 |

TABLE 4

| | | Example | Example | Example | Example | Example | Example | Example |
|---|---|---|---|---|---|---|---|---|
| | | 13 | 14 | 15 | 16 | 17 | 18 | 19 |
| Item | Unit | L | M | Q | R | S | S′ | T |
| HFO-1132(E) | mass % | 63.1 | 60.3 | 62.8 | 49.8 | 62.6 | 50.0 | 35.8 |
| HFO-1123 | mass % | 31.9 | 6.2 | 29.6 | 42.3 | 28.3 | 35.8 | 44.9 |
| R1234yf | mass % | 5.0 | 33.5 | 7.6 | 7.9 | 9.1 | 14.2 | 19.3 |
| GWP | — | 1 | 2 | 1 | 1 | 1 | 1 | 2 |
| COP ratio | % (relative to | 96.1 | 99.4 | 96.4 | 95.0 | 96.6 | 95.8 | 95.0 |
| | 410A) | | | | | | | |
| Refrigerating | % (relative to | 101.6 | 85.0 | 100.2 | 101.7 | 99.4 | 98.1 | 96.7 |
| capacity ratio | 410A) | | | | | | | |
| Condensation glide | ° C. | 0.81 | 2.58 | 1.00 | 1.00 | 1.10 | 1.55 | 2.07 |
| Discharge pressure | % (relative to | 107.8 | 87.9 | 106.0 | 109.6 | 105.0 | 105.0 | 105.0 |
| | 410A) | | | | | | | |
| RCL | g/m³ | 40.0 | 40.0 | 40.0 | 44.8 | 40.0 | 44.4 | 50.8 |

TABLE 5

| | | Comp. | | |
|---|---|---|---|---|
| | | Ex. 10 | Example 20 | Example 21 |
| Item | Unit | G | H | I |
| HFO-1132(E) | mass % | 72.0 | 72.0 | 72.0 |
| HFO-1123 | mass % | 28.0 | 14.0 | 0.0 |
| R1234yf | mass % | 0.0 | 14.0 | 28.0 |
| GWP | — | 1 | 1 | 2 |
| COP ratio | % (relative | 96.6 | 98.2 | 99.9 |
| | to 410A) | | | |
| Refrigerating | % (relative | 103.1 | 95.1 | 86.6 |
| capacity ratio | to 410A) | | | |
| Condensation glide | ° C. | 0.46 | 1.27 | 1.71 |
| Discharge pressure | % (relative | 108.4 | 98.7 | 88.6 |
| | to 410A) | | | |
| RCL | g/m³ | 37.4 | 37.0 | 36.6 |

TABLE 6

| | | Comp. | Comp. | Example | Example | Example | Example | Example | Comp. |
|---|---|---|---|---|---|---|---|---|---|
| Item | Unit | Ex. 11 | Ex. 12 | 22 | 23 | 24 | 25 | 26 | Ex. 13 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R1234yf | mass % | 5.0 | 5.0 | 5.0 | 5.0 | 5.0 | 5.0 | 5.0 | 5.0 |
| GWP | — | 1 | 1 | 1 | 1 | 1 | 1 | 1 | 1 |
| COP ratio | % (relative to | 91.4 | 92.0 | 92.8 | 93.7 | 94.7 | 95.8 | 96.9 | 98.0 |
| | 410A) | | | | | | | | |
| Refrigerating | % (relative to | 105.7 | 105.5 | 105.0 | 104.3 | 103.3 | 102.0 | 100.6 | 99.1 |
| capacity ratio | 410A) | | | | | | | | |
| Condensation | ° C. | 0.40 | 0.46 | 0.55 | 0.66 | 0.75 | 0.80 | 0.79 | 0.67 |
| glide | | | | | | | | | |
| Discharge | % (relative to | 120.1 | 118.7 | 116.7 | 114.3 | 111.6 | 108.7 | 105.6 | 102.5 |
| pressure | 410A) | | | | | | | | |
| RCL | g/m³ | 71.0 | 61.9 | 54.9 | 49.3 | 44.8 | 41.0 | 37.8 | 35.1 |

TABLE 7

| | | Comp. | Example | Example | Example | Example | Example | Example | Comp. |
|---|---|---|---|---|---|---|---|---|---|
| Item | Unit | Ex. 14 | 27 | 28 | 29 | 30 | 31 | 32 | Ex. 15 |
| HFO-1132(E) | mass % | 10.0 | 20.0 | 30.0 | 40.0 | 50.0 | 60.0 | 70.0 | 80.0 |
| HFO-1123 | mass % | 80.0 | 70.0 | 60.0 | 50.0 | 40.0 | 30.0 | 20.0 | 10.0 |
| R1234yf | mass % | 10.0 | 10.0 | 10.0 | 10.0 | 10.0 | 10.0 | 10.0 | 10.0 |
| GWP | — | 1 | 1 | 1 | 1 | 1 | 1 | 1 | 1 |
| COP ratio | % (relative to | 91.9 | 92.5 | 93.3 | 94.3 | 95.3 | 96.4 | 97.5 | 98.6 |
| | 410A) | | | | | | | | |
| Refrigerating | % (relative to | 103.2 | 102.9 | 102.4 | 101.5 | 100.5 | 99.2 | 97.8 | 96.2 |
| capacity ratio | 410A) | | | | | | | | |
| Condensation | ° C. | 0.87 | 0.94 | 1.03 | 1.12 | 1.18 | 1.18 | 1.09 | 0.88 |
| glide | | | | | | | | | |
| Discharge | % (relative to | 116.7 | 115.2 | 113.2 | 110.8 | 108.1 | 105.2 | 102.1 | 99.0 |
| pressure | 410A) | | | | | | | | |
| RCL | g/m³ | 70.5 | 61.6 | 54.6 | 49.1 | 44.6 | 40.8 | 37.7 | 35.0 |

TABLE 8

| | | Comp. | Example | Example | Example | Example | Example | Example | Comp. |
|---|---|---|---|---|---|---|---|---|---|
| Item | Unit | Ex. 16 | 33 | 34 | 35 | 36 | 37 | 38 | Ex. 17 |
| HFO-1132(E) | mass % | 10.0 | 20.0 | 30.0 | 40.0 | 50.0 | 60.0 | 70.0 | 80.0 |
| HFO-1123 | mass % | 75.0 | 65.0 | 55.0 | 45.0 | 35.0 | 25.0 | 15.0 | 5.0 |
| R1234yf | mass % | 15.0 | 15.0 | 15.0 | 15.0 | 15.0 | 15.0 | 15.0 | 15.0 |
| GWP | — | 1 | 1 | 1 | 1 | 1 | 1 | 1 | 1 |
| COP ratio | % (relative to | 92.4 | 93.1 | 93.9 | 94.8 | 95.9 | 97.0 | 98.1 | 99.2 |
| | 410A) | | | | | | | | |
| Refrigerating | % (relative to | 100.5 | 100.2 | 99.6 | 98.7 | 97.7 | 96.4 | 94.9 | 93.2 |
| capacity ratio | 410A) | | | | | | | | |
| Condensation | ° C. | 1.41 | 1.49 | 1.56 | 1.62 | 1.63 | 1.55 | 1.37 | 1.05 |
| glide | | | | | | | | | |
| Discharge | % (relative to | 113.1 | 111.6 | 109.6 | 107.2 | 104.5 | 101.6 | 98.6 | 95.5 |
| pressure | 410A) | | | | | | | | |
| RCL | g/m³ | 70.0 | 61.2 | 54.4 | 48.9 | 44.4 | 40.7 | 37.5 | 34.8 |

TABLE 9

| | | Example | Example | Example | Example | Example | Example | Example |
|---|---|---|---|---|---|---|---|---|
| Item | Unit | 39 | 40 | 41 | 42 | 43 | 44 | 45 |
| HFO-1132(E) | mass % | 10.0 | 20.0 | 30.0 | 40.0 | 50.0 | 60.0 | 70.0 |
| HFO-1123 | mass % | 70.0 | 60.0 | 50.0 | 40.0 | 30.0 | 20.0 | 10.0 |
| R1234yf | mass % | 20.0 | 20.0 | 20.0 | 20.0 | 20.0 | 20.0 | 20.0 |
| GWP | — | 2 | 2 | 2 | 2 | 2 | 2 | 2 |
| COP ratio | % (relative to | 93.0 | 93.7 | 94.5 | 95.5 | 96.5 | 97.6 | 98.7 |
| | 410A) | | | | | | | |
| Refrigerating | % (relative to | 97.7 | 97.4 | 96.8 | 95.9 | 94.7 | 93.4 | 91.9 |
| capacity ratio | 410A) | | | | | | | |
| Condensation | ° C. | 2.03 | 2.09 | 2.13 | 2.14 | 2.07 | 1.91 | 1.61 |
| glide | | | | | | | | |
| Discharge pressure | % (relative to | 109.4 | 107.9 | 105.9 | 103.5 | 100.8 | 98.0 | 95.0 |
| | 410A) | | | | | | | |
| RCL | g/m3 | 69.6 | 60.9 | 54.1 | 48.7 | 44.2 | 40.5 | 37.4 |

TABLE 10

| | | Example | Example | Example | Example | Example | Example | Example |
|---|---|---|---|---|---|---|---|---|
| Item | Unit | 46 | 47 | 48 | 49 | 50 | 51 | 52 |
| HFO-1132(E) | mass % | 10.0 | 20.0 | 30.0 | 40.0 | 50.0 | 60.0 | 70.0 |
| HFO-1123 | mass % | 65.0 | 55.0 | 45.0 | 35.0 | 25.0 | 15.0 | 5.0 |
| R1234yf | mass % | 25.0 | 25.0 | 25.0 | 25.0 | 25.0 | 25.0 | 25.0 |
| GWP | — | 2 | 2 | 2 | 2 | 2 | 2 | 2 |
| COP ratio | % (relative | 93.6 | 94.3 | 95.2 | 96.1 | 97.2 | 98.2 | 99.3 |
| | to 410A) | | | | | | | |
| Refrigerating | % (relative | 94.8 | 94.5 | 93.8 | 92.9 | 91.8 | 90.4 | 88.8 |
| capacity ratio | to 410A) | | | | | | | |
| Condensation | ° C. | 2.71 | 2.74 | 2.73 | 2.66 | 2.50 | 2.22 | 1.78 |
| glide | | | | | | | | |
| Discharge | % (relative | 105.5 | 104.0 | 102.1 | 99.7 | 97.1 | 94.3 | 91.4 |
| pressure | to 410A) | | | | | | | |
| RCL | g/m³ | 69.1 | 60.5 | 53.8 | 48.4 | 44.0 | 40.4 | 37.3 |

TABLE 11

| | | Example | Example | Example | Example | Example | Example |
|---|---|---|---|---|---|---|---|
| Item | Unit | 53 | 54 | 55 | 56 | 57 | 58 |
| HFO-1132(E) | mass % | 10.0 | 20.0 | 30.0 | 40.0 | 50.0 | 60.0 |
| HFO-1123 | mass % | 60.0 | 50.0 | 40.0 | 30.0 | 20.0 | 10.0 |
| R1234yf | mass % | 30.0 | 30.0 | 30.0 | 30.0 | 30.0 | 30.0 |
| GWP | — | 2 | 2 | 2 | 2 | 2 | 2 |
| COP ratio | % (relative to | 94.3 | 95.0 | 95.9 | 96.8 | 97.8 | 98.9 |
| | 410A) | | | | | | |
| Refrigerating | % (relative to | 91.9 | 91.5 | 90.8 | 89.9 | 88.7 | 87.3 |
| capacity ratio | 410A) | | | | | | |
| Condensation | ° C. | 3.46 | 3.43 | 3.35 | 3.18 | 2.90 | 2.47 |
| glide | | | | | | | |
| Discharge | % (relative to | 101.6 | 100.1 | 98.2 | 95.9 | 93.3 | 90.6 |
| pressure | 410A) | | | | | | |
| RCL | g/m³ | 68.7 | 60.2 | 53.5 | 48.2 | 43.9 | 40.2 |

TABLE 12

| | | Example | Example | Example | Example | Example | Comp. |
|---|---|---|---|---|---|---|---|
| Item | Unit | 59 | 60 | 61 | 62 | 63 | Ex. 18 |
| HFO-1132(E) | mass % | 10.0 | 20.0 | 30.0 | 40.0 | 50.0 | 60.0 |
| HFO-1123 | mass % | 55.0 | 45.0 | 35.0 | 25.0 | 15.0 | 5.0 |
| R1234yf | mass % | 35.0 | 35.0 | 35.0 | 35.0 | 35.0 | 35.0 |
| GWP | — | 2 | 2 | 2 | 2 | 2 | 2 |
| COP ratio | % (relative to | 95.0 | 95.8 | 96.6 | 97.5 | 98.5 | 99.6 |
| | 410A) | | | | | | |
| Refrigerating | % (relative to | 88.9 | 88.5 | 87.8 | 86.8 | 85.6 | 84.1 |
| capacity ratio | 410A) | | | | | | |
| Condensation | ° C. | 4.24 | 4.15 | 3.96 | 3.67 | 3.24 | 2.64 |
| glide | | | | | | | |
| Discharge | % (relative to | 97.6 | 96.1 | 94.2 | 92.0 | 89.5 | 86.8 |
| pressure | 410A) | | | | | | |
| RCL | g/m³ | 68.2 | 59.8 | 53.2 | 48.0 | 43.7 | 40.1 |

TABLE 13

| | | | | Comp. Ex. | Comp. Ex. | Comp. Ex. |
|---|---|---|---|---|---|---|
| Item | Unit | Example 64 | Example 65 | 19 | 20 | 21 |
| HFO-1132(E) | mass % | 10.0 | 20.0 | 30.0 | 40.0 | 50.0 |
| HFO-1123 | mass % | 50.0 | 40.0 | 30.0 | 20.0 | 10.0 |
| R1234yf | mass % | 40.0 | 40.0 | 40.0 | 40.0 | 40.0 |
| GWP | — | 2 | 2 | 2 | 2 | 2 |
| COP ratio | % (relative to | 95.9 | 96.6 | 97.4 | 98.3 | 99.2 |
| | 410A) | | | | | |
| Refrigerating | % (relative to | 85.8 | 85.4 | 84.7 | 83.6 | 82.4 |
| capacity ratio | 410A) | | | | | |
| Condensation | ° C. | 5.05 | 4.85 | 4.55 | 4.10 | 3.50 |
| glide | | | | | | |
| Discharge | % (relative to | 93.5 | 92.1 | 90.3 | 88.1 | 85.6 |
| pressure | 410A) | | | | | |
| RCL | g/m³ | 67.8 | 59.5 | 53.0 | 47.8 | 43.5 |

TABLE 14

| | | Example | Example | Example | Example | Example | Example | Example | Example |
|---|---|---|---|---|---|---|---|---|---|
| Item | Unit | 66 | 67 | 68 | 69 | 70 | 71 | 72 | 73 |
| HFO-1132(E) | mass % | 54.0 | 56.0 | 58.0 | 62.0 | 52.0 | 54.0 | 56.0 | 58.0 |
| HFO-1123 | mass % | 41.0 | 39.0 | 37.0 | 33.0 | 41.0 | 39.0 | 37.0 | 35.0 |
| R1234yf | mass % | 5.0 | 5.0 | 5.0 | 5.0 | 7.0 | 7.0 | 7.0 | 7.0 |
| GWP | — | 1 | 1 | 1 | 1 | 1 | 1 | 1 | 1 |
| COP ratio | % (relative | 95.1 | 95.3 | 95.6 | 96.0 | 95.1 | 95.4 | 95.6 | 95.8 |
| | to 410A) | | | | | | | | |
| Refrigerating | % (relative | 102.8 | 102.6 | 102.3 | 101.8 | 101.9 | 101.7 | 101.5 | 101.2 |
| capacity ratio | to 410A) | | | | | | | | |
| Condensation | ° C. | 0.78 | 0.79 | 0.80 | 0.81 | 0.93 | 0.94 | 0.95 | 0.95 |
| glide | | | | | | | | | |
| Discharge | % (relative | 110.5 | 109.9 | 109.3 | 108.1 | 109.7 | 109.1 | 108.5 | 107.9 |
| pressure | to 410A) | | | | | | | | |
| RCL | g/m³ | 43.2 | 42.4 | 41.7 | 40.3 | 43.9 | 43.1 | 42.4 | 41.6 |

TABLE 15

| | | Example | Example | Example | Example | Example | Example | Example | Example |
|---|---|---|---|---|---|---|---|---|---|
| Item | Unit | 74 | 75 | 76 | 77 | 78 | 79 | 80 | 81 |
| HFO-1132(E) | mass % | 60.0 | 62.0 | 61.0 | 58.0 | 60.0 | 62.0 | 52.0 | 54.0 |
| HFO-1123 | mass % | 33.0 | 31.0 | 29.0 | 30.0 | 28.0 | 26.0 | 34.0 | 32.0 |
| R1234yf | mass % | 7.0 | 7.0 | 10.0 | 12.0 | 12.0 | 12.0 | 14.0 | 14.0 |
| GWP | — | 1 | 1 | 1 | 1 | 1 | 1 | 1 | 1 |
| COP ratio | % (relative | 96.0 | 96.2 | 96.5 | 96.4 | 96.6 | 96.8 | 96.0 | 96.2 |
| | to 410A) | | | | | | | | |
| Refrigerating | % (relative | 100.9 | 100.7 | 99.1 | 98.4 | 98.1 | 97.8 | 98.0 | 97.7 |
| capacity ratio | to 410A) | | | | | | | | |
| Condensation | ° C. | 0.95 | 0.95 | 1.18 | 1.34 | 1.33 | 1.32 | 1.53 | 1.53 |
| glide | | | | | | | | | |
| Discharge | % (relative | 107.3 | 106.7 | 104.9 | 104.4 | 103.8 | 103.2 | 104.7 | 104.1 |
| pressure | to 410A) | | | | | | | | |
| RCL | g/m³ | 40.9 | 40.3 | 40.5 | 41.5 | 40.8 | 40.1 | 43.6 | 42.9 |

TABLE 16

| | | Example | Example | Example | Example | Example | Example | Example | Example |
|---|---|---|---|---|---|---|---|---|---|
| Item | Unit | 82 | 83 | 84 | 85 | 86 | 87 | 88 | 89 |
| HFO-1132(E) | mass % | 56.0 | 58.0 | 60.0 | 48.0 | 50.0 | 52.0 | 54.0 | 56.0 |
| HFO-1123 | mass % | 30.0 | 28.0 | 26.0 | 36.0 | 34.0 | 32.0 | 30.0 | 28.0 |
| R1234yf | mass % | 14.0 | 14.0 | 14.0 | 16.0 | 16.0 | 16.0 | 16.0 | 16.0 |
| GWP | — | 1 | 1 | 1 | 1 | 1 | 1 | 1 | 1 |
| COP ratio | % (relative | 96.4 | 96.6 | 96.9 | 95.8 | 96.0 | 96.2 | 96.4 | 96.7 |
| | to 410A) | | | | | | | | |
| Refrigerating | % (relative | 97.5 | 97.2 | 96.9 | 97.3 | 97.1 | 96.8 | 96.6 | 96.3 |
| capacity ratio | to 410A) | | | | | | | | |
| Condensation | ° C. | 1.51 | 1.50 | 1.48 | 1.72 | 1.72 | 1.71 | 1.69 | 1.67 |
| glide | | | | | | | | | |
| Discharge | % (relative | 103.5 | 102.9 | 102.3 | 104.3 | 103.8 | 103.2 | 102.7 | 102.1 |
| pressure | to 410A) | | | | | | | | |
| RCL | g/m³ | 42.1 | 41.4 | 40.7 | 45.2 | 44.4 | 43.6 | 42.8 | 42.1 |

TABLE 17

| | | Example | Example | Example | Example | Example | Example | Example | Example |
|---|---|---|---|---|---|---|---|---|---|
| Item | Unit | 90 | 91 | 92 | 93 | 94 | 95 | 96 | 97 |
| HFO-1132(E) | mass % | 58.0 | 60.0 | 42.0 | 44.0 | 46.0 | 48.0 | 50.0 | 52.0 |
| HFO-1123 | mass % | 26.0 | 24.0 | 40.0 | 38.0 | 36.0 | 34.0 | 32.0 | 30.0 |
| R1234yf | mass % | 16.0 | 16.0 | 18.0 | 18.0 | 18.0 | 18.0 | 18.0 | 18.0 |
| GWP | — | 1 | 1 | 2 | 2 | 2 | 2 | 2 | 2 |
| COP ratio | % (relative | 96.9 | 97.1 | 95.4 | 95.6 | 95.8 | 96.0 | 96.3 | 96.5 |
| | to 410A) | | | | | | | | |
| Refrigerating | % (relative | 96.1 | 95.8 | 96.8 | 96.6 | 96.4 | 96.2 | 95.9 | 95.7 |
| capacity ratio | to 410A) | | | | | | | | |
| Condensation | ° C. | 1.65 | 1.63 | 1.93 | 1.92 | 1.92 | 1.91 | 1.89 | 1.88 |
| glide | | | | | | | | | |
| Discharge | % (relative | 101.5 | 100.9 | 104.5 | 103.9 | 103.4 | 102.9 | 102.3 | 101.8 |
| pressure | to 410A) | | | | | | | | |
| RCL | g/m³ | 41.4 | 40.7 | 47.8 | 46.9 | 46.0 | 45.1 | 44.3 | 43.5 |

TABLE 18

| | | Example | Example | Example | Example | Example | Example | Example | Example |
|---|---|---|---|---|---|---|---|---|---|
| Item | Unit | 98 | 99 | 100 | 101 | 102 | 103 | 104 | 105 |
| HFO-1132(E) | mass % | 54.0 | 56.0 | 58.0 | 60.0 | 36.0 | 38.0 | 42.0 | 44.0 |
| HFO-1123 | mass % | 28.0 | 26.0 | 24.0 | 22.0 | 44.0 | 42.0 | 38.0 | 36.0 |
| R1234yf | mass % | 18.0 | 18.0 | 18.0 | 18.0 | 20.0 | 20.0 | 20.0 | 20.0 |
| GWP | — | 2 | 2 | 2 | 2 | 2 | 2 | 2 | 2 |
| COP ratio | % (relative | 96.7 | 96.9 | 97.1 | 97.3 | 95.1 | 95.3 | 95.7 | 95.9 |
| to 410A) | | | | | | | | | |
| Refrigerating | % (relative | 95.4 | 95.2 | 94.9 | 94.6 | 96.3 | 96.1 | 95.7 | 95.4 |
| capacity ratio | to 410A) | | | | | | | | |
| Condensation | ° C. | 1.86 | 1.83 | 1.80 | 1.77 | 2.14 | 2.14 | 2.13 | 2.12 |
| glide | | | | | | | | | |
| Discharge | % (relative | 101.2 | 100.6 | 100.0 | 99.5 | 104.5 | 104.0 | 103.0 | 102.5 |
| pressure | to 410A) | | | | | | | | |
| RCL | g/m³ | 42.7 | 42.0 | 41.3 | 40.6 | 50.7 | 49.7 | 47.7 | 46.8 |

TABLE 19

| | | Example | Example | Example | Example | Example | Example | Example | Example |
|---|---|---|---|---|---|---|---|---|---|
| Item | Unit | 106 | 107 | 108 | 109 | 110 | 111 | 112 | 113 |
| HFO-1132(E) | mass % | 46.0 | 48.0 | 52.0 | 54.0 | 56.0 | 58.0 | 34.0 | 36.0 |
| HFO-1123 | mass % | 34.0 | 32.0 | 28.0 | 26.0 | 24.0 | 22.0 | 44.0 | 42.0 |
| R1234yf | mass % | 20.0 | 20.0 | 20.0 | 20.0 | 20.0 | 20.0 | 22.0 | 22.0 |
| GWP | — | 2 | 2 | 2 | 2 | 2 | 2 | 2 | 2 |
| COP ratio | % (relative | 96.1 | 96.3 | 96.7 | 96.9 | 97.2 | 97.4 | 95.1 | 95.3 |
| | to 410A) | | | | | | | | |
| Refrigerating | % (relative | 95.2 | 95.0 | 94.5 | 94.2 | 94.0 | 93.7 | 95.3 | 95.1 |
| capacity ratio | to 410A) | | | | | | | | |
| Condensation | ° C. | 2.11 | 2.09 | 2.05 | 2.02 | 1.99 | 1.95 | 2.37 | 2.36 |
| glide | | | | | | | | | |
| Discharge | % (relative | 101.9 | 101.4 | 100.3 | 99.7 | 99.2 | 98.6 | 103.4 | 103.0 |
| pressure | to 410A) | | | | | | | | |
| RCL | g/m³ | 45.9 | 45.0 | 43.4 | 42.7 | 41.9 | 41.2 | 51.7 | 50.6 |

TABLE 20

| | | Example | Example | Example | Example | Example | Example | Example | Example |
|---|---|---|---|---|---|---|---|---|---|
| Item | Unit | 114 | 115 | 116 | 117 | 118 | 119 | 120 | 121 |
| HFO-1132(E) | mass % | 38.0 | 40.0 | 42.0 | 44.0 | 46.0 | 48.0 | 50.0 | 52.0 |
| HFO-1123 | mass % | 40.0 | 38.0 | 36.0 | 34.0 | 32.0 | 30.0 | 28.0 | 26.0 |
| R1234yf | mass % | 22.0 | 22.0 | 22.0 | 22.0 | 22.0 | 22.0 | 22.0 | 22.0 |
| GWP | — | 2 | 2 | 2 | 2 | 2 | 2 | 2 | 2 |
| COP ratio | % (relative | 95.5 | 95.7 | 95.9 | 96.1 | 96.4 | 96.6 | 96.8 | 97.0 |
| | to 410A) | | | | | | | | |
| Refrigerating | % (relative | 94.9 | 94.7 | 94.5 | 94.3 | 94.0 | 93.8 | 93.6 | 93.3 |
| capacity ratio | to 410A) | | | | | | | | |
| Condensation | ° C. | 2.36 | 2.35 | 2.33 | 2.32 | 2.30 | 2.27 | 2.25 | 2.21 |
| glide | | | | | | | | | |
| Discharge | % (relative | 102.5 | 102.0 | 101.5 | 101.0 | 100.4 | 99.9 | 99.4 | 98.8 |
| pressure | to 410A) | | | | | | | | |
| RCL | g/m³ | 49.6 | 48.6 | 47.6 | 46.7 | 45.8 | 45.0 | 44.1 | 43.4 |

TABLE 21

| | | Example | Example | Example | Example | Example | Example | Example | Example |
|---|---|---|---|---|---|---|---|---|---|
| Item | Unit | 122 | 123 | 124 | 125 | 126 | 127 | 128 | 129 |
| HFO-1132(E) | mass % | 54.0 | 56.0 | 58.0 | 60.0 | 32.0 | 34.0 | 36.0 | 38.0 |
| HFO-1123 | mass % | 24.0 | 22.0 | 20.0 | 18.0 | 44.0 | 42.0 | 40.0 | 38.0 |
| R1234yf | mass % | 22.0 | 22.0 | 22.0 | 22.0 | 24.0 | 24.0 | 24.0 | 24.0 |
| GWP | — | 2 | 2 | 2 | 2 | 2 | 2 | 2 | 2 |
| COP ratio | % (relative | 97.2 | 97.4 | 97.6 | 97.9 | 95.2 | 95.4 | 95.6 | 95.8 |
| | to 410A) | | | | | | | | |
| Refrigerating | % (relative | 93.0 | 92.8 | 92.5 | 92.2 | 94.3 | 94.1 | 93.9 | 93.7 |
| capacity ratio | to 410A) | | | | | | | | |
| Condensation | ° C. | 2.18 | 2.14 | 2.09 | 2.04 | 2.61 | 2.60 | 2.59 | 2.58 |
| glide | | | | | | | | | |
| Discharge | % (relative | 98.2 | 97.7 | 97.1 | 96.5 | 102.4 | 101.9 | 101.5 | 101.0 |
| pressure | to 410A) | | | | | | | | |
| RCL | g/m³ | 42.6 | 41.9 | 41.2 | 40.5 | 52.7 | 51.6 | 50.5 | 49.5 |

TABLE 22

| | | Example | Example | Example | Example | Example | Example | Example | Example |
|---|---|---|---|---|---|---|---|---|---|
| Item | Unit | 130 | 131 | 132 | 133 | 134 | 135 | 136 | 137 |
| HFO-1132(E) | mass % | 40.0 | 42.0 | 44.0 | 46.0 | 48.0 | 50.0 | 52.0 | 54.0 |
| HFO-1123 | mass % | 36.0 | 34.0 | 32.0 | 30.0 | 28.0 | 26.0 | 24.0 | 22.0 |
| R1234yf | mass % | 24.0 | 24.0 | 24.0 | 24.0 | 24.0 | 24.0 | 24.0 | 24.0 |
| GWP | — | 2 | 2 | 2 | 2 | 2 | 2 | 2 | 2 |
| COP ratio | % (relative | 96.0 | 96.2 | 96.4 | 96.6 | 96.8 | 97.0 | 97.2 | 97.5 |
| | to 410A) | | | | | | | | |
| Refrigerating | % (relative | 93.5 | 93.3 | 93.1 | 92.8 | 92.6 | 92.4 | 92.1 | 91.8 |
| capacity ratio | to 410A) | | | | | | | | |
| Condensation | ° C. | 2.56 | 2.54 | 2.51 | 2.49 | 2.45 | 2.42 | 2.38 | 2.33 |
| glide | | | | | | | | | |
| Discharge | % (relative | 100.5 | 100.0 | 99.5 | 98.9 | 98.4 | 97.9 | 97.3 | 96.8 |
| pressure | to 410A) | | | | | | | | |
| RCL | g/m³ | 48.5 | 47.5 | 46.6 | 45.7 | 44.9 | 44.1 | 43.3 | 42.5 |

TABLE 23

| | | Example | Example | Example | Example | Example | Example | Example | Example |
|---|---|---|---|---|---|---|---|---|---|
| Item | Unit | 138 | 139 | 140 | 141 | 142 | 143 | 144 | 145 |
| HFO-1132(E) | mass % | 56.0 | 58.0 | 60.0 | 30.0 | 32.0 | 34.0 | 36.0 | 38.0 |
| HFO-1123 | mass % | 20.0 | 18.0 | 16.0 | 44.0 | 42.0 | 40.0 | 38.0 | 36.0 |
| R1234yf | mass % | 24.0 | 24.0 | 24.0 | 26.0 | 26.0 | 26.0 | 26.0 | 26.0 |
| GWP | — | 2 | 2 | 2 | 2 | 2 | 2 | 2 | 2 |
| COP ratio | % (relative | 97.7 | 97.9 | 98.1 | 95.3 | 95.5 | 95.7 | 95.9 | 96.1 |
| | to 410A) | | | | | | | | |
| Refrigerating | % (relative | 91.6 | 91.3 | 91.0 | 93.2 | 93.1 | 92.9 | 92.7 | 92.5 |
| capacity ratio | to 410A) | | | | | | | | |
| Condensation | ° C. | 2.28 | 2.22 | 2.16 | 2.86 | 2.85 | 2.83 | 2.81 | 2.79 |
| glide | | | | | | | | | |
| Discharge | % (relative | 96.2 | 95.6 | 95.1 | 101.3 | 100.8 | 100.4 | 99.9 | 99.4 |
| pressure | to 410A) | | | | | | | | |
| RCL | g/m³ | 41.8 | 41.1 | 40.4 | 53.7 | 52.6 | 51.5 | 50.4 | 49.4 |

TABLE 24

| | | Example | Example | Example | Example | Example | Example | Example | Example |
|---|---|---|---|---|---|---|---|---|---|
| Item | Unit | 146 | 147 | 148 | 149 | 150 | 151 | 152 | 153 |
| HFO-1132(E) | mass % | 40.0 | 42.0 | 44.0 | 46.0 | 48.0 | 50.0 | 52.0 | 54.0 |
| HFO-1123 | mass % | 34.0 | 32.0 | 30.0 | 28.0 | 26.0 | 24.0 | 22.0 | 20.0 |
| R1234yf | mass % | 26.0 | 26.0 | 26.0 | 26.0 | 26.0 | 26.0 | 26.0 | 26.0 |
| GWP | — | 2 | 2 | 2 | 2 | 2 | 2 | 2 | 2 |
| COP ratio | % (relative | 96.3 | 96.5 | 96.7 | 96.9 | 97.1 | 97.3 | 97.5 | 97.7 |
| | to 410A) | | | | | | | | |
| Refrigerating | % (relative | 92.3 | 92.1 | 91.9 | 91.6 | 91.4 | 91.2 | 90.9 | 90.6 |
| capacity ratio | to 410A) | | | | | | | | |
| Condensation | ° C. | 2.77 | 2.74 | 2.71 | 2.67 | 2.63 | 2.59 | 2.53 | 2.48 |
| glide | | | | | | | | | |
| Discharge | % (relative | 99.0 | 98.5 | 97.9 | 97.4 | 96.9 | 96.4 | 95.8 | 95.3 |
| pressure | to 410A) | | | | | | | | |
| RCL | g/m³ | 48.4 | 47.4 | 46.5 | 45.7 | 44.8 | 44.0 | 43.2 | 42.5 |

TABLE 25

| | | Example | Example | Example | Example | Example | Example | Example | Example |
|---|---|---|---|---|---|---|---|---|---|
| Item | Unit | 154 | 155 | 156 | 157 | 158 | 159 | 160 | 161 |
| HFO-1132(E) | mass % | 56.0 | 58.0 | 60.0 | 30.0 | 32.0 | 34.0 | 36.0 | 38.0 |
| HFO-1123 | mass % | 18.0 | 16.0 | 14.0 | 42.0 | 40.0 | 38.0 | 36.0 | 34.0 |
| R1234yf | mass % | 26.0 | 26.0 | 26.0 | 28.0 | 28.0 | 28.0 | 28.0 | 28.0 |
| GWP | — | 2 | 2 | 2 | 2 | 2 | 2 | 2 | 2 |
| COP ratio | % (relative | 97.9 | 98.2 | 98.4 | 95.6 | 95.8 | 96.0 | 96.2 | 96.3 |
| | to 410A) | | | | | | | | |
| Refrigerating | % (relative | 90.3 | 90.1 | 89.8 | 92.1 | 91.9 | 91.7 | 91.5 | 91.3 |
| capacity ratio | to 410A) | | | | | | | | |
| Condensation | ° C. | 2.42 | 2.35 | 2.27 | 3.10 | 3.09 | 3.06 | 3.04 | 3.01 |
| glide | | | | | | | | | |
| Discharge | % (relative | 94.7 | 94.1 | 93.6 | 99.7 | 99.3 | 98.8 | 98.4 | 97.9 |
| pressure | to 410A) | | | | | | | | |
| RCL | g/m³ | 41.7 | 41.0 | 40.3 | 53.6 | 52.5 | 51.4 | 50.3 | 49.3 |

TABLE 26

| | | Example | Example | Example | Example | Example | Example | Example | Example |
|---|---|---|---|---|---|---|---|---|---|
| Item | Unit | 162 | 163 | 164 | 165 | 166 | 167 | 168 | 169 |
| HFO-1132(E) | mass % | 40.0 | 42.0 | 44.0 | 46.0 | 48.0 | 50.0 | 52.0 | 54.0 |
| HFO-1123 | mass % | 32.0 | 30.0 | 28.0 | 26.0 | 24.0 | 22.0 | 20.0 | 18.0 |
| R1234yf | mass % | 28.0 | 28.0 | 28.0 | 28.0 | 28.0 | 28.0 | 28.0 | 28.0 |
| GWP | — | 2 | 2 | 2 | 2 | 2 | 2 | 2 | 2 |
| COP ratio | % (relative | 96.5 | 96.7 | 96.9 | 97.2 | 97.4 | 97.6 | 97.8 | 98.0 |
| | to 410A) | | | | | | | | |
| Refrigerating | % (relative | 91.1 | 90.9 | 90.7 | 90.4 | 90.2 | 89.9 | 89.7 | 89.4 |
| capacity ratio | to 410A) | | | | | | | | |
| Condensation | ° C. | 2.98 | 2.94 | 2.90 | 2.85 | 2.80 | 2.75 | 2.68 | 2.62 |
| glide | | | | | | | | | |
| Discharge | % (relative | 97.4 | 96.9 | 96.4 | 95.9 | 95.4 | 94.9 | 94.3 | 93.8 |
| pressure | to 410A) | | | | | | | | |
| RCL | g/m³ | 48.3 | 47.4 | 46.4 | 45.6 | 44.7 | 43.9 | 43.1 | 42.4 |

TABLE 27

| | | Example | Example | Example | Example | Example | Example | Example | Example |
|---|---|---|---|---|---|---|---|---|---|
| Item | Unit | 170 | 171 | 172 | 173 | 174 | 175 | 176 | 177 |
| HFO-1132(E) | mass % | 56.0 | 58.0 | 60.0 | 32.0 | 34.0 | 36.0 | 38.0 | 42.0 |
| HFO-1123 | mass % | 16.0 | 14.0 | 12.0 | 38.0 | 36.0 | 34.0 | 32.0 | 28.0 |
| R1234yf | mass % | 28.0 | 28.0 | 28.0 | 30.0 | 30.0 | 30.0 | 30.0 | 30.0 |
| GWP | — | 2 | 2 | 2 | 2 | 2 | 2 | 2 | 2 |
| COP ratio | % (relative | 98.2 | 98.4 | 98.6 | 96.1 | 96.2 | 96.4 | 96.6 | 97.0 |
| | to 410A) | | | | | | | | |
| Refrigerating | % (relative | 89.1 | 88.8 | 88.5 | 90.7 | 90.5 | 90.3 | 90.1 | 89.7 |
| capacity ratio | to 410A) | | | | | | | | |
| Condensation | ° C. | 2.54 | 2.46 | 2.38 | 3.32 | 3.30 | 3.26 | 3.22 | 3.14 |
| glide | | | | | | | | | |
| Discharge | % (relative | 93.2 | 92.6 | 92.1 | 97.7 | 97.3 | 96.8 | 96.4 | 95.4 |
| pressure | to 410A) | | | | | | | | |
| RCL | g/m³ | 41.7 | 41.0 | 40.3 | 52.4 | 51.3 | 50.2 | 49.2 | 47.3 |

TABLE 28

| | | Example | Example | Example | Example | Example | Example | Example | Example |
|---|---|---|---|---|---|---|---|---|---|
| Item | Unit | 178 | 179 | 180 | 181 | 182 | 183 | 184 | 185 |
| HFO-1132(E) | mass % | 44.0 | 46.0 | 48.0 | 50.0 | 52.0 | 54.0 | 56.0 | 58.0 |
| HFO-1123 | mass % | 26.0 | 24.0 | 22.0 | 20.0 | 18.0 | 16.0 | 14.0 | 12.0 |
| R1234yf | mass % | 30.0 | 30.0 | 30.0 | 30.0 | 30.0 | 30.0 | 30.0 | 30.0 |
| GWP | — | 2 | 2 | 2 | 2 | 2 | 2 | 2 | 2 |
| COP ratio | % (relative | 97.2 | 97.4 | 97.6 | 97.8 | 98.0 | 98.3 | 98.5 | 98.7 |
| | to 410A) | | | | | | | | |
| Refrigerating | % (relative | 89.4 | 89.2 | 89.0 | 88.7 | 88.4 | 88.2 | 87.9 | 87.6 |
| capacity ratio | to 410A) | | | | | | | | |
| Condensation | ° C. | 3.08 | 3.03 | 2.97 | 2.90 | 2.83 | 2.75 | 2.66 | 2.57 |
| glide | | | | | | | | | |
| Discharge | % (relative | 94.9 | 94.4 | 93.9 | 93.3 | 92.8 | 92.3 | 91.7 | 91.1 |
| pressure | to 410A) | | | | | | | | |
| RCL | g/m³ | 46.4 | 45.5 | 44.7 | 43.9 | 43.1 | 42.3 | 41.6 | 40.9 |

TABLE 29

| | | Example | Example | Example | Example | Example | Example | Example | Example |
|---|---|---|---|---|---|---|---|---|---|
| Item | Unit | 186 | 187 | 188 | 189 | 190 | 191 | 192 | 193 |
| HFO-1132(E) | mass % | 30.0 | 32.0 | 34.0 | 36.0 | 38.0 | 40.0 | 42.0 | 44.0 |
| HFO-1123 | mass % | 38.0 | 36.0 | 34.0 | 32.0 | 30.0 | 28.0 | 26.0 | 24.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 96.2 | 96.3 | 96.5 | 96.7 | 96.9 | 97.1 | 97.3 | 97.5 |
| | to 410A) | | | | | | | | |
| Refrigerating | % (relative | 89.6 | 89.5 | 89.3 | 89.1 | 88.9 | 88.7 | 88.4 | 88.2 |
| capacity ratio | to 410A) | | | | | | | | |
| Condensation | ° C. | 3.60 | 3.56 | 3.52 | 3.48 | 3.43 | 3.38 | 3.33 | 3.26 |
| glide | | | | | | | | | |
| Discharge | % (relative | 96.6 | 96.2 | 95.7 | 95.3 | 94.8 | 94.3 | 93.9 | 93.4 |
| pressure | to 410A) | | | | | | | | |
| RCL | g/m³ | 53.4 | 52.3 | 51.2 | 50.1 | 49.1 | 48.1 | 47.2 | 46.3 |

TABLE 30

| | | Example | Example | Example | Example | Example | Example | Example | Example |
|---|---|---|---|---|---|---|---|---|---|
| Item | Unit | 194 | 195 | 196 | 197 | 198 | 199 | 200 | 201 |
| HFO-1132(E) | mass % | 46.0 | 48.0 | 50.0 | 52.0 | 54.0 | 56.0 | 58.0 | 60.0 |
| HFO-1123 | mass % | 22.0 | 20.0 | 18.0 | 16.0 | 14.0 | 12.0 | 10.0 | 8.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 97.7 | 97.9 | 98.1 | 98.3 | 98.5 | 98.7 | 98.9 | 99.2 |
| | to 410A) | | | | | | | | |
| Refrigerating | % (relative | 88.0 | 87.7 | 87.5 | 87.2 | 86.9 | 86.6 | 86.3 | 86.0 |
| capacity ratio | to 410A) | | | | | | | | |
| Condensation | ° C. | 3.20 | 3.12 | 3.04 | 2.96 | 2.87 | 2.77 | 2.66 | 2.55 |
| glide | | | | | | | | | |
| Discharge | % (relative | 92.8 | 92.3 | 91.8 | 91.3 | 90.7 | 90.2 | 89.6 | 89.1 |
| pressure | to 410A) | | | | | | | | |
| RCL | g/m³ | 45.4 | 44.6 | 43.8 | 43.0 | 42.3 | 41.5 | 40.8 | 40.2 |

TABLE 31

| | | Example | Example | Example | Example | Example | Example | Example | Example |
|---|---|---|---|---|---|---|---|---|---|
| Item | Unit | 202 | 203 | 204 | 205 | 206 | 207 | 208 | 209 |
| HFO-1132(E) | mass % | 30.0 | 32.0 | 34.0 | 36.0 | 38.0 | 40.0 | 42.0 | 44.0 |
| HFO-1123 | mass % | 36.0 | 34.0 | 32.0 | 30.0 | 28.0 | 26.0 | 24.0 | 22.0 |
| R1234yf | mass % | 34.0 | 34.0 | 34.0 | 34.0 | 34.0 | 34.0 | 34.0 | 34.0 |
| GWP | — | 2 | 2 | 2 | 2 | 2 | 2 | 2 | 2 |
| COP ratio | % (relative | 96.5 | 96.6 | 96.8 | 97.0 | 97.2 | 97.4 | 97.6 | 97.8 |
| | to 410A) | | | | | | | | |
| Refrigerating | % (relative | 88.4 | 88.2 | 88.0 | 87.8 | 87.6 | 87.4 | 87.2 | 87.0 |
| capacity ratio | to 410A) | | | | | | | | |
| Condensation | ° C. | 3.84 | 3.80 | 3.75 | 3.70 | 3.64 | 3.58 | 3.51 | 3.43 |
| glide | | | | | | | | | |
| Discharge | % (relative | 95.0 | 94.6 | 94.2 | 93.7 | 93.3 | 92.8 | 92.3 | 91.8 |
| pressure | to 410A) | | | | | | | | |
| RCL | g/m³ | 53.3 | 52.2 | 51.1 | 50.0 | 49.0 | 48.0 | 47.1 | 46.2 |

TABLE 32

| | | Example | Example | Example | Example | Example | Example | Example | Example |
|---|---|---|---|---|---|---|---|---|---|
| Item | Unit | 210 | 211 | 212 | 213 | 214 | 215 | 216 | 217 |
| HFO-1132(E) | mass % | 46.0 | 48.0 | 50.0 | 52.0 | 54.0 | 30.0 | 32.0 | 34.0 |
| HFO-1123 | mass % | 20.0 | 18.0 | 16.0 | 14.0 | 12.0 | 34.0 | 32.0 | 30.0 |
| R1234yf | mass % | 34.0 | 34.0 | 34.0 | 34.0 | 34.0 | 36.0 | 36.0 | 36.0 |
| GWP | — | 2 | 2 | 2 | 2 | 2 | 2 | 2 | 2 |
| COP ratio | % (relative | 98.0 | 98.2 | 98.4 | 98.6 | 98.8 | 96.8 | 96.9 | 97.1 |
| | to 410A) | | | | | | | | |
| Refrigerating | % (relative | 86.7 | 86.5 | 86.2 | 85.9 | 85.6 | 87.2 | 87.0 | 86.8 |
| capacity ratio | to 410A) | | | | | | | | |
| Condensation | ° C. | 3.36 | 3.27 | 3.18 | 3.08 | 2.97 | 4.08 | 4.03 | 3.97 |
| glide | | | | | | | | | |
| Discharge | % (relative | 91.3 | 90.8 | 90.3 | 89.7 | 89.2 | 93.4 | 93.0 | 92.6 |
| pressure | to 410A) | | | | | | | | |
| RCL | g/m³ | 45.3 | 44.5 | 43.7 | 42.9 | 42.2 | 53.2 | 52.1 | 51.0 |

TABLE 33

| | | Example | Example | Example | Example | Example | Example | Example | Example |
|---|---|---|---|---|---|---|---|---|---|
| Item | Unit | 218 | 219 | 220 | 221 | 222 | 223 | 224 | 225 |
| HFO-1132(E) | mass % | 36.0 | 38.0 | 40.0 | 42.0 | 44.0 | 46.0 | 30.0 | 32.0 |
| HFO-1123 | mass % | 28.0 | 26.0 | 24.0 | 22.0 | 20.0 | 18.0 | 32.0 | 30.0 |
| R1234yf | mass % | 36.0 | 36.0 | 36.0 | 36.0 | 36.0 | 36.0 | 38.0 | 38.0 |
| GWP | — | 2 | 2 | 2 | 2 | 2 | 2 | 2 | 2 |
| COP ratio | % (relative | 97.3 | 97.5 | 97.7 | 97.9 | 98.1 | 98.3 | 97.1 | 97.2 |
| | to 410A) | | | | | | | | |
| Refrigerating | % (relative | 86.6 | 86.4 | 86.2 | 85.9 | 85.7 | 85.5 | 85.9 | 85.7 |
| capacity ratio | to 410A) | | | | | | | | |
| Condensation | ° C. | 3.91 | 3.84 | 3.76 | 3.68 | 3.60 | 3.50 | 4.32 | 4.25 |
| glide | | | | | | | | | |
| Discharge | % (relative | 92.1 | 91.7 | 91.2 | 90.7 | 90.3 | 89.8 | 91.9 | 91.4 |
| pressure | to 410A) | | | | | | | | |
| RCL | g/m³ | 49.9 | 48.9 | 47.9 | 47.0 | 46.1 | 45.3 | 53.1 | 52.0 |

TABLE 34

| Item | Unit | Example 226 | Example 227 |
|---|---|---|---|
| HFO-1132(E) | mass % | 34.0 | 36.0 |
| HFO-1123 | mass % | 28.0 | 26.0 |
| R1234yf | mass % | 38.0 | 38.0 |
| GWP | — | 2 | 2 |
| COP ratio | % (relative | 97.4 | 97.6 |
| | to 410A) | | |
| Refrigerating | % (relative | 85.6 | 85.3 |
| capacity ratio | to 410A) | | |
| Condensation glide | ° C. | 4.18 | 4.11 |
| Discharge pressure | % (relative | 91.0 | 90.6 |
| | to 410A) | | |
| RCL | g/m³ | 50.9 | 49.8 |

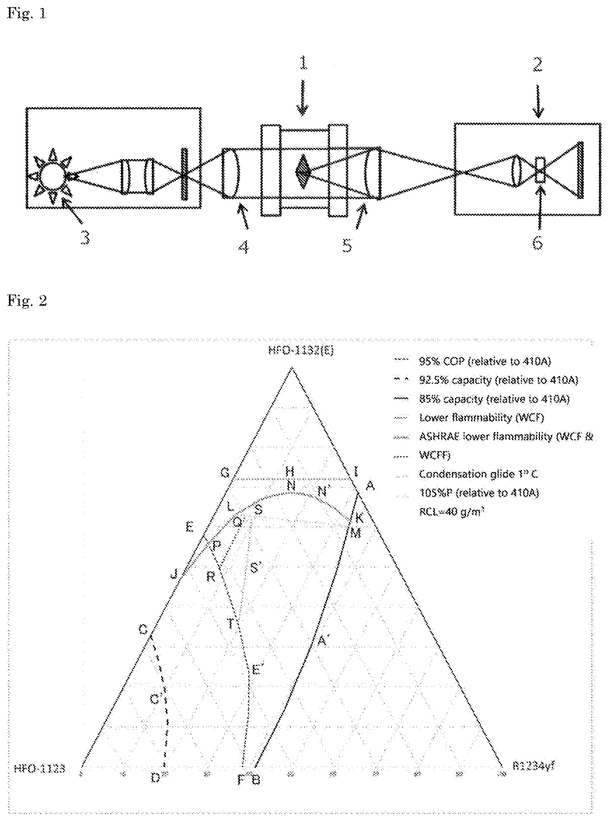

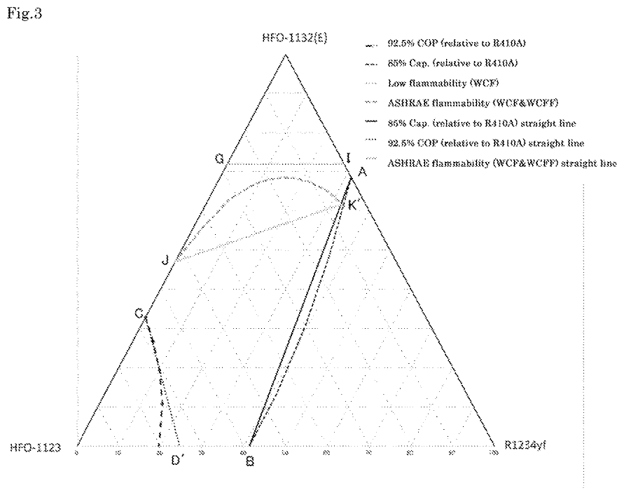

These results indicate that under the condition that the mass % of HFO-1132(E), HFO-1123, and R1234yf based on their sum is respectively represented by x, y, and z, when coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′(30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line segment CO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3,
   the line segment DC′ is represented by coordinates (x, 0.0082x²−0.6671x+80.4, −0.0082x²-0.3329x+19.6),
   the line segment C′C is represented by coordinates (x, 0.0067x²−0.6034x+79.729, −0.0067x²−0.3966x+20.271), and
   the line segments BD, CO, and OA are straight lines,
   the refrigerant has a refrigerating capacity ratio of 85% or more relative to that of R410A,
   and a COP of 92.5% or more relative to that of R410A.
The point on the line segment AA′ was determined by obtaining an approximate curve connecting point A, Example 1, and point A′ by the least square method.
The point on the line segment A′B was determined by obtaining an approximate curve connecting point A′, Example 3, and point B by the least square method.
The point on the line segment DC′ was determined by obtaining an approximate curve connecting point D, Example 6, and point C′ by the least square method.
The point on the line segment C′C was determined by obtaining an approximate curve connecting point C′, Example 4, and point C by the least square method.
Likewise, the results indicate that when coordinates (x,y,z) are within the range of a figure surrounded by line segments AA′, A′B, BF, FT, TE, EO, and OA that connect the following 7 points:
   point A (68.6, 0.0, 31.4),
   point A′ (30.6, 30.0, 39.4),
   point B (0.0, 58.7, 41.3),
   point F (0.0, 61.8, 38.2),
   point T (35.8, 44.9, 19.3),
   point E (58.0, 42.0, 0.0) and
   point O (100.0, 0.0, 0.0),
   or on the above line segments (excluding the points on the line EO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3),
   the line segment FT is represented by coordinates (x, 0.0078x²−0.7501x+61.8, −0.0078x²−0.2499x+38.2), and
   the line segment TE is represented by coordinates (x, 0.0067x²−0.7607x+63.525, −0.0067x²−0.2393x+36.475), and
   the line segments BF, FO, and OA are straight lines,
   the refrigerant has a refrigerating capacity ratio of 85% or more relative to that of R410A,
   and a COP of 95% or more relative to that of R410A.
The point on the line segment FT was determined by obtaining an approximate curve connecting three points, i.e., points T, E′, and F, by the least square method.
The point on the line segment TE was determined by obtaining an approximate curve connecting three points, i.e., points E, R, and T, by the least square method.
The results in Tables 1 to 34 clearly indicate that in a ternary composition diagram of the mixed refrigerant of HFO-1132(E), HFO-1123, and R1234yf in which the sum of these components is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below the line segment LM connecting point L (63.1, 31.9, 5.0) and point M (60.3, 6.2, 33.5), the refrigerant has an RCL of 40 g/m³ or more.
The results in Tables 1 to 34 clearly indicate that in a ternary composition diagram of the mixed refrigerant of HFO-1132(E), HFO-1123 and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment QR connecting point Q (62.8, 29.6, 7.6) and point R (49.8, 42.3, 7.9) or on the left side of the line segment, the refrigerant has a temperature glide of 1° C. or less.
The results in Tables 1 to 34 clearly indicate that in a ternary composition diagram of the mixed refrigerant of HFO-1132(E), HFO-1123, and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment ST connecting point S (62.6, 28.3, 9.1) and point T (35.8, 44.9, 19.3) or on the right side of the line segment, the refrigerant has a discharge pressure of 105% or less relative to that of 410A.
In these compositions, R1234yf contributes to reducing flammability, and suppressing deterioration of polymerization etc. Therefore, the composition preferably contains R1234yf.
Further, the burning velocity of these mixed refrigerants whose mixed formulations were adjusted to WCF concentrations was measured according to the ANSI/ASHRAE Standard 34-2013. Compositions having a burning velocity of 10 cm/s or less were determined to be classified as “Class 2L (lower flammability).”
A burning velocity test was performed using the apparatus shown in FIG. 1 in the following manner. In FIG. 1, reference numeral 901 refers to a sample cell, 902 refers to a high-speed camera, 903 refers to a xenon lamp, 904 refers to a collimating lens, 905 refers to a collimating lens, and 906 refers to a ring filter. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Each WCFF concentration was obtained by using the WCF concentration as the initial concentration and performing a leak simulation using NIST Standard Reference Database REFLEAK Version 4.0.
Tables 35 and 36 show the results.

TABLE 35

| Item | | Unit | G | H | I |
|---|---|---|---|---|---|
| WCF | HFO-1132(E) | mass % | 72.0 | 72.0 | 72.0 |
| | HFO-1123 | mass % | 28.0 | 9.6 | 0.0 |
| | R1234yf | mass % | 0.0 | 18.4 | 28.0 |

| | | | | |
|---|---|---|---|---|
| Burning velocity (WCF) | cm/s | 10 | 10 | 10 |

TABLE 36

| Item | | Unit | J | P | L | N | N′ | K |
|---|---|---|---|---|---|---|---|---|
| WCF | HFO- | mass % | 47.1 | 55.8 | 63.1 | 68.6 | 65.0 | 61.3 |
| | 1132 | | | | | | | |
| | (E) | | | | | | | |
| | HFO- | mass % | 52.9 | 42.0 | 31.9 | 16.3 | 7.7 | 5.4 |
| | 1123 | | | | | | | |
| | R1234yf | mass % | 0.0 | 2.2 | 5.0 | 15.1 | 27.3 | 33.3 |
| Leak condition that results | | | Storage/ | Storage/ | Storage/ | Storage/ | Storage/ | Storage/ |
| in WCFF | | | Shipping | Shipping | Shipping | Shipping | Shipping | Shipping, |
| | | | −40° C., | −40° C., | −40° C., | −40° C., | −40° C., | −40° C., |
| | | | 92% | 90% | 90% | 66% | 12% | 0% |
| | | | release, | release, | release, | release, | release, | release, |
| | | | liquid | liquid | gas | gas | gas | gas |
| | | | phase | phase | phase | phase | phase | phase |
| | | | side | side | side | side | side | side |
| WCFF | HFO- | mass % | 72.0 | 72.0 | 72.0 | 72.0 | 72.0 | 72.0 |
| | 1132 | | | | | | | |
| | (E) | | | | | | | |
| | HFO- | mass % | 28.0 | 17.8 | 17.4 | 13.6 | 12.3 | 9.8 |
| | 1123 | | | | | | | |
| | R1234yf | mass % | 0.0 | 10.2 | 10.6 | 14.4 | 15.7 | 18.2 |

| | | | | | | | |
|---|---|---|---|---|---|---|---|
| Burning | cm/s | 8 or less | 8 or less | 8 or less | 9 | 9 | 8 or less |
| velocity (WCF) | | | | | | | |
| Burning | cm/s | 10 | 10 | 10 | 10 | 10 | 10 |
| velocity (WCFF) | | | | | | | |

The results in Table 35 clearly indicate that when a mixed refrigerant of HFO-1132(E), HFO-1123, and R1234yf contains HFO-1132(E) in a proportion of 72.0 mass % or less based on their sum, the refrigerant can be determined to have a WCF lower flammability.
The results in Tables 36 clearly indicate that in a ternary composition diagram of a mixed refrigerant of HFO-1132(E), HFO-1123, and R1234yf in which their sum is 100 mass %, and a line segment connecting a point (0.0, 100.0, 0.0) and a point (0.0, 0.0, 100.0) is the base, when coordinates (x,y,z) are on or below the line segments JP, PN, and NK connecting the following 6 points:
   point J (47.1, 52.9, 0.0),
   point P (55.8, 42.0, 2.2),
   point L (63.1, 31.9, 5.0)
   point N (68.6, 16.3, 15.1)
   point N′ (65.0, 7.7, 27.3) and
   point K (61.3, 5.4, 33.3),
   the refrigerant can be determined to have a WCF lower flammability, and a WCFF lower flammability.
   In the diagram, the line segment PN is represented by coordinates (x, −0.1135x²+12.112x−280.43, 0.1135x²−13.112x+380.43),
   and the line segment NK is represented by coordinates (x, 0.2421x²−29.955x+931.91, −0.2421x²+28.955x−831.91).
The point on the line segment PN was determined by obtaining an approximate curve connecting three points, i.e., points P, L, and N, by the least square method.
The point on the line segment NK was determined by obtaining an approximate curve connecting three points, i.e., points N, N′, and K, by the least square method.

### (5-2) Refrigerant B

The refrigerant B according to the present disclosure is
a mixed refrigerant comprising trans-1,2-difluoroethylene (HFO-1132(E)) and trifluoroethylene (HFO-1123) in a total amount of 99.5 mass % or more based on the entire refrigerant, and the refrigerant comprising 62.0 mass % to 72.0 mass % or 45.1 mass % to 47.1 mass % of HFO-1132(E) based on the entire refrigerant, or
a mixed refrigerant comprising HFO-1132(E) and HFO-1123 in a total amount of 99.5 mass % or more based on the entire refrigerant, and the refrigerant comprising 45.1 mass % to 47.1 mass % of HFO-1132(E) based on the entire refrigerant.
The refrigerant B according to the present disclosure has various properties that are desirable as an R410A-alternative refrigerant, i.e., (1) a coefficient of performance equivalent to that of R410A, (2) a refrigerating capacity equivalent to that of R410A, (3) a sufficiently low GWP, and (4) a lower flammability (Class 2L) according to the ASHRAE standard.
When the refrigerant B according to the present disclosure is a mixed refrigerant comprising 72.0 mass % or less of HFO-1132(E), it has WCF lower flammability. When the refrigerant B according to the present disclosure is a composition comprising 47.1% or less of HFO-1132(E), it has WCF lower flammability and WCFF lower flammability, and is determined to be “Class 2L,” which is a lower flammable refrigerant according to the ASHRAE standard, and which is further easier to handle.
When the refrigerant B according to the present disclosure comprises 62.0 mass % or more of HFO-1132(E), it becomes superior with a coefficient of performance of 95% or more relative to that of R410A, the polymerization reaction of HFO-1132(E) and/or HFO-1123 is further suppressed, and the stability is further improved. When the refrigerant B according to the present disclosure comprises 45.1 mass % or more of HFO-1132(E), it becomes superior with a coefficient of performance of 93% or more relative to that of R410A, the polymerization reaction of HFO-1132(E) and/or HFO-1123 is further suppressed, and the stability is further improved.
The refrigerant B according to the present disclosure may further comprise other additional refrigerants in addition to HFO-1132(E) and HFO-1123, as long as the above properties and effects are not impaired. In this respect, the refrigerant according to the present disclosure preferably comprises HFO-1132(E) and HFO-1123 in a total amount of 99.75 mass % or more, and more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant B)

The present disclosure is described in more detail below with reference to Examples of refrigerant B. However, the refrigerant B is not limited to the Examples.
Mixed refrigerants were prepared by mixing HFO-1132(E) and HFO-1123 at mass % based on their sum shown in Tables 37 and 38.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
   Evaporating temperature: 5° C.
   Condensation temperature: 45° C.
   Superheating temperature: 5 K
   Subcooling temperature: 5 K
   Compressor efficiency: 70%
The composition of each mixture was defined as WCF. A leak simulation was performed using NIST Standard Reference Data Base Refleak Version 4.0 under the conditions of Equipment, Storage, Shipping, Leak, and Recharge according to the ASHRAE Standard 34-2013. The most flammable fraction was defined as WCFF.
Tables 1 and 2 show GWP, COP, and refrigerating capacity, which were calculated based on these results. The COP and refrigerating capacity are ratios relative to R410A.
The coefficient of performance (COP) was determined by the following formula.

COP=(refrigerating capacity or heating capacity)/power consumption
For the flammability, the burning velocity was measured according to the ANSI/ASHRAE Standard 34-2013. Both WCF and WCFF having a burning velocity of 10 cm/s or less were determined to be “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.

TABLE 37

| | | | Comparative | | | | | | | |
|---|---|---|---|---|---|---|---|---|---|---|
| | | Comparative | Example 2 | | | | | | | |
| | | Example 1 | HFO- | Comparative | Exam- | Exam- | Exam- | Exam- | Exam- | Comparative |
| Item | Unit | R410A | 1132E | Example 3 | ple 1 | ple 2 | ple 3 | ple 4 | ple 5 | Example 4 |
| HFO-1132E | mass % | — | 100 | 80 | 72 | 70 | 68 | 65 | 62 | 60 |
| (WCF) | | | | | | | | | | |
| HFO-1123 | mass % | | 0 | 20 | 28 | 30 | 32 | 35 | 38 | 40 |
| (WCF) | | | | | | | | | | |
| GWP | — | 2088 | 1 | 1 | 1 | 1 | 1 | 1 | 1 | 1 |
| COP ratio | % | 100 | 99.7 | 97.5 | 96.6 | 96.3 | 96.1 | 95.8 | 95.4 | 95.2 |
| | (relative | | | | | | | | | |
| | to R410A) | | | | | | | | | |
| Refrigerating | % | 100 | 98.3 | 101.9 | 103.1 | 103.4 | 103.8 | 104.1 | 104.5 | 104.8 |
| capacity | (relative | | | | | | | | | |
| ratio | to R410A) | | | | | | | | | |
| Discharge | Mpa | 2.73 | 2.71 | 2.89 | 2.96 | 2.98 | 3.00 | 3.02 | 3.04 | 3.06 |
| pressure | | | | | | | | | | |
| Burning | cm/sec | Non- | 20 | 13 | 10 | 9 | 9 | 8 | 80 or | 8 or less |
| velocity | | flammable | | | | | | | less | |
| (WCF) | | | | | | | | | | |

TABLE 38

| | | | | | | | | | | Compara- |
|---|---|---|---|---|---|---|---|---|---|---|
| | | Compara- | Compara- | | | | Compara- | Compara- | Compara- | tive |
| | | tive | tive | Exam- | Exam- | Exam- | tive | tive | tive | Example |
| | | Example | Example | ple | ple | ple | Example | Example | Example | 10 |
| Item | Unit | 5 | 6 | 7 | 8 | 9 | 7 | 8 | 9 | HFO-1123 |
| HFO-1132E | mass % | 50 | 48 | 47.1 | 46.1 | 45.1 | 43 | 40 | 25 | 0 |
| (WCF) | | | | | | | | | | |
| HFO-1123 | mass % | 50 | 52 | 52.9 | 53.9 | 54.9 | 57 | 60 | 75 | 100 |
| (WCF) | | | | | | | | | | |
| GWP | — | 1 | 1 | 1 | 1 | 1 | 1 | 1 | 1 | 1 |
| COP ratio | % | 94.1 | 93.9 | 93.8 | 93.7 | 93.6 | 93.4 | 93.1 | 91.9 | 90.6 |
| | (relative | | | | | | | | | |
| | to | | | | | | | | | |
| | R410A) | | | | | | | | | |
| Refrigerating | % | 105.9 | 106.1 | 106.2 | 106.3 | 106.4 | 106.6 | 106.9 | 107.9 | 108.0 |
| capacity | (relative | | | | | | | | | |
| ratio | to | | | | | | | | | |
| | R410A) | | | | | | | | | |
| Discharge | Mpa | 3.14 | 3.16 | 3.16 | 3.17 | 3.18 | 3.20 | 3.21 | 3.31 | 3.39 |
| pressure | | | | | | | | | | |
| Leakage test | | Storage/ | Storage/ | Storage/ | Storage/ | Storage/ | Storage/ | Storage/ | Storage/ | — |
| conditions (WCFF) | | Shipping | Shipping | Shipping | Shipping | Shipping | Shipping | Shipping | Shipping | |
| | | −40° C., | −40° C., | −40° C., | −40° C., | −40° C., | −40° C., | −40° C., | −40° C., | |
| | | 92% | 92% | 92% | 92% | 92% | 92% | 92% | 90% | |
| | | release, | release, | release, | release, | release, | release, | release, | release, | |
| | | liquid | liquid | liquid | liquid | liquid | liquid | liquid | liquid | |
| | | phase | phase | phase | phase | phase | phase | phase | phase | |
| | | side | side | side | side | side | side | side | side | |
| HFO-1132E | mass % | 74 | 73 | 72 | 71 | 70 | 67 | 63 | 38 | — |
| (WCFF) | | | | | | | | | | |
| HFO-1123 | mass % | 26 | 27 | 28 | 29 | 30 | 33 | 37 | 62 | |
| (WCFF) | | | | | | | | | | |
| Burning | cm/sec | 8 or less | 8 or less | 8 or less | 8 or less | 8 or less | 8 or less | 8 or less | 8 or less | 5 |
| velocity | | | | | | | | | | |
| (WCF) | | | | | | | | | | |
| Burning | cm/sec | 11 | 10.5 | 10.0 | 9.5 | 9.5 | 8.5 | 8 or less | 8 or less | |
| velocity | | | | | | | | | | |
| (WCFF) | | | | | | | | | | |

| | | | | | | | | | |
|---|---|---|---|---|---|---|---|---|---|
| ASHRAE flammability | 2 | 2 | 2L | 2L | 2L | 2L | 2L | 2L | 2L |
| classification | | | | | | | | | |

The compositions each comprising 62.0 mass % to 72.0 mass % of HFO-1132(E) based on the entire composition are stable while having a low GWP (GWP=1), and they ensure WCF lower flammability. Further, surprisingly, they can ensure performance equivalent to that of R410A. Moreover, compositions each comprising 45.1 mass % to 47.1 mass % of HFO-1132(E) based on the entire composition are stable while having a low GWP (GWP=1), and they ensure WCFF lower flammability. Further, surprisingly, they can ensure performance equivalent to that of R410A.

### (5-3) Refrigerant C

The refrigerant C according to the present disclosure is a composition comprising trans-1,2-difluoroethylene (HFO-1132(E)), trifluoroethylene (HFO-1123), 2,3,3,3-tetrafluoro-1-propene (R1234yf), and difluoromethane (R32), and satisfies the following requirements. The refrigerant C according to the present disclosure has various properties that are desirable as an alternative refrigerant for R410A; i.e. it has a coefficient of performance and a refrigerating capacity that are equivalent to those of R410A, and a sufficiently low GWP.

### Requirements

Preferable refrigerant C is as follows:
When the mass % of HFO-1132(E), HFO-1123, R1234yf, and R32 based on their sum is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801) and
   point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682) and
   point W (0.0, 100.0−a, 0.0),
   or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
   point G (0.0111a²−1.3152a+68.986, −0.0111a²+0.3152a+31.014, 0.0),
   point I (0.0111a²−1.3152a+68.986, 0.0, −0.0111a²+0.3152a+31.014),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and
   point W (0.0, 100.0−a, 0.0),
   or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines GI and AB (excluding point G, point I, point A, point B, and point W). When the refrigerant according to the present disclosure satisfies the above requirements, it has a refrigerating capacity ratio of 85% or more relative to that of R410A, and a COP ratio of 92.5% or more relative to that of R410A, and further ensures a WCF lower flammability.
The refrigerant C according to the present disclosure is preferably a refrigerant wherein
when the mass % of HFO-1132(E), HFO-1123, and R1234yf based on their sum is respectively represented by x, y, and z,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636, −0.0105a²+0.8577a+33.177),
   point B (0.0, 0.0075a²−1.5156a+58.199, −0.0075a²+0.5156a+41.801) and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682) and
   point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines JK′, K′A, and AB (excluding point J, point B, and point W). When the refrigerant according to the present disclosure satisfies the above requirements, it has a refrigerating capacity ratio of 85% or more relative to that of R410A, and a COP ratio of 92.5% or more relative to that of R410A. Additionally, the refrigerant has a WCF lower flammability and a WCFF lower flammability, and is classified as “Class 2L,” which is a lower flammable refrigerant according to the ASHRAE standard.
When the refrigerant C according to the present disclosure further contains R32 in addition to HFO-1132 (E), HFO-1123, and R1234yf, the refrigerant may be a refrigerant wherein when the mass % of HFO-1132(E), HFO-1123, R1234yf, and R32 based on their sum is respectively represented by x, y, z, and a,
if 0<a≤10.0, coordinates (x,y,z) in a ternary composition diagram in which the sum of HFO-1132(E), HFO-1123, and R1234yf is (100−a) mass % are within the range of a figure surrounded by straight lines that connect the following 4 points:
   point a (0.02a²−2.46a+93.4, 0, −0.02a²+2.46a+6.6),
   point b′ (−0.008a²−1.38a+56, 0.018a²−0.53a+26.3, −0.01a²+1.91a+17.7),
   point c (−0.016a²+1.02a+77.6, 0.016a²−1.02a+22.4, 0), and
   point o (100.0−a, 0.0, 0.0)
   or on the straight lines oa, ab′, and b′c (excluding point o and point c);
if 10.0<a≤16.5, coordinates (x,y,z) in the ternary composition diagram are within the range of a figure surrounded by straight lines that connect the following 4 points:
   point a (0.0244a²−2.5695a+94.056, 0, −0.0244a²+2.5695a+5.944),
   point b′ (0.1161a²−1.9959a+59.749, 0.014a²−0.3399a+24.8, −0.1301a²+2.3358a+15.451),
   point c (−0.0161a²+1.02a+77.6, 0.0161a²−1.02a+22.4, 0), and
   point o (100.0−a, 0.0, 0.0),
   or on the straight lines oa, ab′, and b′c (excluding point o and point c); or
if 16.5<a≤21.8, coordinates (x,y,z) in the ternary composition diagram are within the range of a figure surrounded by straight lines that connect the following 4 points:
   point a (0.0161a²−2.3535a+92.742, 0, −0.0161a²+2.3535a+7.258),
   point b′ (−0.0435a²−0.0435a+50.406, 0.0304a²+1.8991a−0.0661, 0.0739a²−1.8556a+49.6601),
   point c (−0.0161a²+0.9959a+77.851, 0.0161a²−0.9959a+22.149, 0), and
   point o (100.0−a, 0.0, 0.0),
   or on the straight lines oa, ab′, and b′c (excluding point o and point c). Note that when point b in the ternary composition diagram is defined as a point where a refrigerating capacity ratio of 95% relative to that of R410A and a COP ratio of 95% relative to that of R410A are both achieved, point b′ is the intersection of straight line ab and an approximate line formed by connecting the points where the COP ratio relative to that of R410A is 95%. When the refrigerant according to the present disclosure meets the above requirements, the refrigerant has a refrigerating capacity ratio of 95% or more relative to that of R410A, and a COP ratio of 95% or more relative to that of R410A.
The refrigerant C according to the present disclosure may further comprise other additional refrigerants in addition to HFO-1132(E), HFO-1123, R1234yf, and R32 as long as the above properties and effects are not impaired. In this respect, the refrigerant according to the present disclosure preferably comprises HFO-1132(E), HFO-1123, R1234yf, and R32 in a total amount of 99.5 mass % or more, more preferably 99.75 mass % or more, and still more preferably 99.9 mass % or more, based on the entire refrigerant.
The refrigerant C according to the present disclosure may comprise HFO-1132(E), HFO-1123, R1234yf, and R32 in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### (Examples of Refrigerant C)

The present disclosure is described in more detail below with reference to Examples of refrigerant C. However, the refrigerant C is not limited to the Examples.
Mixed refrigerants were prepared by mixing HFO-1132(E), HFO-1123, R1234yf, and R32 at mass % based on their sum shown in Tables 39 to 96.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
For each of these mixed refrigerants, the COP ratio and the refrigerating capacity ratio relative to those of R410 were obtained. Calculation was conducted under the following conditions.
Evaporating temperature: 5° C.
Condensation temperature: 45° C.
Superheating temperature: 5 K
Subcooling temperature: 5 K
Compressor efficiency: 70%
Tables 39 to 96 show the resulting values together with the GWP of each mixed refrigerant. The COP and refrigerating capacity are ratios relative to R410A.
The coefficient of performance (COP) was determined by the following formula.

COP=(refrigerating capacity or heating capacity)/power consumption

TABLE 39

| | | | Comp. | Comp. | Comp. | Comp. | Comp. | Comp. | Comp. | |
|---|---|---|---|---|---|---|---|---|---|---|
| | | Comp. | Ex. 2 | Ex. 3 | Ex. 4 | Ex. 5 | Ex. 6 | Ex. 7 | Ex. 8 | Ex. 1 |
| Item | Unit | Ex. 1 | A | B | C | D′ | G | I | J | K′ |
| HFO-1132(E) | Mass % | R410A | 68.6 | 0.0 | 32.9 | 0.0 | 72.0 | 72.0 | 47.1 | 61.7 |
| HFO-1123 | Mass % | | 0.0 | 58.7 | 67.1 | 75.4 | 28.0 | 0.0 | 52.9 | 5.9 |
| R1234yf | Mass % | | 31.4 | 41.3 | 0.0 | 24.6 | 0.0 | 28.0 | 0.0 | 32.4 |
| R32 | Mass % | | 0.0 | 0.0 | 0.0 | 0.0 | 0.0 | 0.0 | 0.0 | 0.0 |
| GWP | — | 2088 | 2 | 2 | 1 | 2 | 1 | 2 | 1 | 2 |
| COP ratio | % (relative | 100 | 100.0 | 95.5 | 92.5 | 93.1 | 96.6 | 99.9 | 93.8 | 99.4 |
| | to R410A) | | | | | | | | | |
| Refrigerating | % (relative | 100 | 85.0 | 85.0 | 107.4 | 95.0 | 103.1 | 86.6 | 106.2 | 85.5 |
| capacity ratio | to R410A) | | | | | | | | | |

TABLE 40

| | | Comp. | Comp. | Comp. | Comp. | Comp. | Comp. | Comp. | |
|---|---|---|---|---|---|---|---|---|---|
| | | Ex. 9 | Ex. 10 | Ex. 11 | Ex. 12 | Ex. 13 | Ex. 14 | Ex. 15 | Ex. 2 |
| Item | Unit | A | B | C | D′ | G | I | J | K′ |
| HFO-1132(E) | Mass % | 55.3 | 0.0 | 18.4 | 0.0 | 60.9 | 60.9 | 40.5 | 47.0 |
| HFO-1123 | Mass % | 0.0 | 47.8 | 74.5 | 83.4 | 32.0 | 0.0 | 52.4 | 7.2 |
| R1234yf | Mass % | 37.6 | 45.1 | 0.0 | 9.5 | 0.0 | 32.0 | 0.0 | 38.7 |
| R32 | Mass % | 7.1 | 7.1 | 7.1 | 7.1 | 7.1 | 7.1 | 7.1 | 7.1 |
| GWP | — | 50 | 50 | 49 | 49 | 49 | 50 | 49 | 50 |
| COP ratio | % (relative | 99.8 | 96.9 | 92.5 | 92.5 | 95.9 | 99.6 | 94.0 | 99.2 |
| | to R410A) | | | | | | | | |
| Refrigerating | % (relative | 85.0 | 85.0 | 110.5 | 106.0 | 106.5 | 87.7 | 108.9 | 85.5 |
| capacity ratio | to R410A) | | | | | | | | |

TABLE 41

| | | Comp. | Comp. | Comp. | Comp. | Comp. | Comp. | |
|---|---|---|---|---|---|---|---|---|
| | | Ex. 16 | Ex. 17 | Ex. 18 | Ex. 19 | Ex. 20 | Ex. 21 | Ex. 3 |
| Item | Unit | A | B | C = D′ | G | I | J | K′ |
| HFO-1132(E) | Mass % | 48.4 | 0.0 | 0.0 | 55.8 | 55.8 | 37.0 | 41.0 |
| HFO-1123 | Mass % | 0.0 | 42.3 | 88.9 | 33.1 | 0.0 | 51.9 | 6.5 |
| R1234yf | Mass % | 40.5 | 46.6 | 0.0 | 0.0 | 33.1 | 0.0 | 41.4 |
| R32 | Mass % | 11.1 | 11.1 | 11.1 | 11.1 | 11.1 | 11.1 | 11.1 |
| GWP | — | 77 | 77 | 76 | 76 | 77 | 76 | 77 |
| COP ratio | % (relative | 99.8 | 97.6 | 92.5 | 95.8 | 99.5 | 94.2 | 99.3 |
| | to R410A) | | | | | | | |
| Refrigerating | % (relative | 85.0 | 85.0 | 112.0 | 108.0 | 88.6 | 110.2 | 85.4 |
| capacity ratio | to R410A) | | | | | | | |

TABLE 42

| | | Comp. Ex. | Comp. Ex. | Comp. Ex. | Comp. Ex. | Comp. Ex. | |
|---|---|---|---|---|---|---|---|
| | | 22 | 23 | 24 | 25 | 26 | Ex. 4 |
| Item | Unit | A | B | G | I | J | K′ |
| HFO-1132(E) | Mass % | 42.8 | 0.0 | 52.1 | 52.1 | 34.3 | 36.5 |
| HFO-1123 | Mass % | 0.0 | 37.8 | 33.4 | 0.0 | 51.2 | 5.6 |
| R1234yf | Mass % | 42.7 | 47.7 | 0.0 | 33.4 | 0.0 | 43.4 |
| R32 | Mass % | 14.5 | 14.5 | 14.5 | 14.5 | 14.5 | 14.5 |
| GWP | — | 100 | 100 | 99 | 100 | 99 | 100 |
| COP ratio | % (relative | 99.9 | 98.1 | 95.8 | 99.5 | 94.4 | 99.5 |
| | to R410A) | | | | | | |
| Refrigerating | % (relative | 85.0 | 85.0 | 109.1 | 89.6 | 111.1 | 85.3 |
| capacity ratio | to R410A) | | | | | | |

TABLE 43

| | | Comp. Ex. | Comp. Ex. | Comp. Ex. | Comp. Ex. | Comp. Ex. | |
|---|---|---|---|---|---|---|---|
| | | 27 | 28 | 29 | 30 | 31 | Ex. 5 |
| Item | Unit | A | B | G | I | J | K′ |
| HFO-1132(E) | Mass % | 37.0 | 0.0 | 48.6 | 48.6 | 32.0 | 32.5 |
| HFO-1123 | Mass % | 0.0 | 33.1 | 33.2 | 0.0 | 49.8 | 4.0 |
| R1234yf | Mass % | 44.8 | 48.7 | 0.0 | 33.2 | 0.0 | 45.3 |
| R32 | Mass % | 18.2 | 18.2 | 18.2 | 18.2 | 18.2 | 18.2 |
| GWP | — | 125 | 125 | 124 | 125 | 124 | 125 |
| COP ratio | % (relative | 100.0 | 98.6 | 95.9 | 99.4 | 94.7 | 99.8 |
| | to R410A) | | | | | | |
| Refrigerating | % (relative | 85.0 | 85.0 | 110.1 | 90.8 | 111.9 | 85.2 |
| capacity ratio | to R410A) | | | | | | |

TABLE 44

| | | Comp. Ex. | Comp. Ex. | Comp. Ex. | Comp. Ex. | Comp. Ex. | |
|---|---|---|---|---|---|---|---|
| | | 32 | 33 | 34 | 35 | 36 | Ex. 6 |
| Item | Unit | A | B | G | I | J | K′ |
| HFO-1132(E) | Mass % | 31.5 | 0.0 | 45.4 | 45.4 | 30.3 | 28.8 |
| HFO-1123 | Mass % | 0.0 | 28.5 | 32.7 | 0.0 | 47.8 | 2.4 |
| R1234yf | Mass % | 46.6 | 49.6 | 0.0 | 32.7 | 0.0 | 46.9 |
| R32 | Mass % | 21.9 | 21.9 | 21.9 | 21.9 | 21.9 | 21.9 |
| GWP | — | 150 | 150 | 149 | 150 | 149 | 150 |
| COP ratio | % (relative | 100.2 | 99.1 | 96.0 | 99.4 | 95.1 | 100.0 |
| | to R410A) | | | | | | |
| Refrigerating | % (relative | 85.0 | 85.0 | 111.0 | 92.1 | 112.6 | 85.1 |
| capacity ratio | to R410A) | | | | | | |

TABLE 45

| | | Comp. | Comp. | Comp. | Comp. | Comp. | Comp. |
|---|---|---|---|---|---|---|---|
| | | Ex. 37 | Ex. 38 | Ex. 39 | Ex. 40 | Ex. 41 | Ex. 42 |
| Item | Unit | A | B | G | I | J | K′ |
| HFO-1132(E) | Mass % | 24.8 | 0.0 | 41.8 | 41.8 | 29.1 | 24.8 |
| HFO-1123 | Mass % | 0.0 | 22.9 | 31.5 | 0.0 | 44.2 | 0.0 |
| R1234yf | Mass % | 48.5 | 50.4 | 0.0 | 31.5 | 0.0 | 48.5 |
| R32 | Mass % | 26.7 | 26.7 | 26.7 | 26.7 | 26.7 | 26.7 |
| GWP | — | 182 | 182 | 181 | 182 | 181 | 182 |
| COP ratio | % (relative | 100.4 | 99.8 | 96.3 | 99.4 | 95.6 | 100.4 |
| | to R410A) | | | | | | |
| Refrigerating | % (relative | 85.0 | 85.0 | 111.9 | 93.8 | 113.2 | 85.0 |
| capacity ratio | to R410A) | | | | | | |

TABLE 46

| | | Comp. | Comp. | Comp. | Comp. | Comp. | Comp. |
|---|---|---|---|---|---|---|---|
| | | Ex. 43 | Ex. 44 | Ex. 45 | Ex. 46 | Ex. 47 | Ex. 48 |
| Item | Unit | A | B | G | I | J | K′ |
| HFO-1132(E) | Mass % | 21.3 | 0.0 | 40.0 | 40.0 | 28.8 | 24.3 |
| HFO-1123 | Mass % | 0.0 | 19.9 | 30.7 | 0.0 | 41.9 | 0.0 |
| R1234yf | Mass % | 49.4 | 50.8 | 0.0 | 30.7 | 0.0 | 46.4 |
| R32 | Mass % | 29.3 | 29.3 | 29.3 | 29.3 | 29.3 | 29.3 |
| GWP | — | 200 | 200 | 198 | 199 | 198 | 200 |
| COP ratio | % (relative | 100.6 | 100.1 | 96.6 | 99.5 | 96.1 | 100.4 |
| | to R410A) | | | | | | |
| Refrigerating | % (relative | 85.0 | 85.0 | 112.4 | 94.8 | 113.6 | 86.7 |
| capacity ratio | to R410A) | | | | | | |

TABLE 47

| | | Comp. | Comp. | Comp. | Comp. | Comp. | Comp. |
|---|---|---|---|---|---|---|---|
| | | Ex. 49 | Ex. 50 | Ex. 51 | Ex. 52 | Ex. 53 | Ex. 54 |
| Item | Unit | A | B | G | I | J | K′ |
| HFO-1132(E) | Mass % | 12.1 | 0.0 | 35.7 | 35.7 | 29.3 | 22.5 |
| HFO-1123 | Mass % | 0.0 | 11.7 | 27.6 | 0.0 | 34.0 | 0.0 |
| R1234yf | Mass % | 51.2 | 51.6 | 0.0 | 27.6 | 0.0 | 40.8 |
| R32 | Mass % | 36.7 | 36.7 | 36.7 | 36.7 | 36.7 | 36.7 |
| GWP | — | 250 | 250 | 248 | 249 | 248 | 250 |
| COP ratio | % (relative | 101.2 | 101.0 | 96.4 | 99.6 | 97.0 | 100.4 |
| | to R410A) | | | | | | |
| Refrigerating | % (relative | 85.0 | 85.0 | 113.2 | 97.6 | 113.9 | 90.9 |
| capacity ratio | to R410A) | | | | | | |

TABLE 48

| | | Comp. | Comp. | Comp. | Comp. | Comp. | Comp. |
|---|---|---|---|---|---|---|---|
| | | Ex. 55 | Ex. 56 | Ex. 57 | Ex. 58 | Ex. 59 | Ex. 60 |
| Item | Unit | A | B | G | I | J | K′ |
| HFO-1132(E) | Mass % | 3.8 | 0.0 | 32.0 | 32.0 | 29.4 | 21.1 |
| HFO-1123 | Mass % | 0.0 | 3.9 | 23.9 | 0.0 | 26.5 | 0.0 |
| R1234yf | Mass % | 52.1 | 52.0 | 0.0 | 23.9 | 0.0 | 34.8 |
| R32 | Mass % | 44.1 | 44.1 | 44.1 | 44.1 | 44.1 | 44.1 |
| GWP | — | 300 | 300 | 298 | 299 | 298 | 299 |
| COP ratio | % (relative | 101.8 | 101.8 | 97.9 | 99.8 | 97.8 | 100.5 |
| | to R410A) | | | | | | |
| Refrigerating | % (relative | 85.0 | 85.0 | 113.7 | 100.4 | 113.9 | 94.9 |
| capacity ratio | to R410A) | | | | | | |

TABLE 49

| | | Comp. | Comp. | Comp. | Comp. | Comp. |
|---|---|---|---|---|---|---|
| | | Ex. 61 | Ex. 62 | Ex. 63 | Ex. 64 | Ex. 65 |
| Item | Unit | A = B | G | I | J | K′ |
| HFO-1132(E) | Mass % | 0.0 | 30.4 | 30.4 | 28.9 | 20.4 |
| HFO-1123 | Mass % | 0.0 | 21.8 | 0.0 | 23.3 | 0.0 |
| R1234yf | Mass % | 52.2 | 0.0 | 21.8 | 0.0 | 31.8 |
| R32 | Mass % | 47.8 | 47.8 | 47.8 | 47.8 | 47.8 |
| GWP | — | 325 | 323 | 324 | 323 | 324 |
| COP ratio | % (relative | 102.1 | 98.2 | 100.0 | 98.2 | 100.6 |
| | to R410A) | | | | | |
| Refrigerating | % (relative | 85.0 | 113.8 | 101.8 | 113.9 | 96.8 |
| capacity ratio | to R410A) | | | | | |

TABLE 50

| | | Comp. | | | | | | | |
|---|---|---|---|---|---|---|---|---|---|
| Item | Unit | Ex. 66 | Ex. 7 | Ex. 8 | Ex. 9 | Ex. 10 | Ex. 11 | Ex. 12 | Ex. 13 |
| HFO-1132(E) | Mass % | 5.0 | 10.0 | 15.0 | 20.0 | 25.0 | 30.0 | 35.0 | 40.0 |
| HFO-1123 | Mass % | 82.9 | 77.9 | 72.9 | 67.9 | 62.9 | 57.9 | 52.9 | 47.9 |
| R1234yf | Mass % | 5.0 | 5.0 | 5.0 | 5.0 | 5.0 | 5.0 | 5.0 | 5.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 92.4 | 92.6 | 92.8 | 93.1 | 93.4 | 93.7 | 94.1 | 94.5 |
| | to R410A) | | | | | | | | |
| Refrigerating | % (relative | 108.4 | 108.3 | 108.2 | 107.9 | 107.6 | 107.2 | 106.8 | 106.3 |
| capacity ratio | to R410A) | | | | | | | | |

TABLE 51

| | | | | | | Comp. | | | |
|---|---|---|---|---|---|---|---|---|---|
| Item | Unit | Ex. 14 | Ex. 15 | Ex. 16 | Ex. 17 | Ex. 67 | Ex. 18 | Ex. 19 | Ex. 20 |
| HFO-1132(E) | Mass % | 45.0 | 50.0 | 55.0 | 60.0 | 65.0 | 10.0 | 15.0 | 20.0 |
| HFO-1123 | Mass % | 42.9 | 37.9 | 32.9 | 27.9 | 22.9 | 72.9 | 67.9 | 62.9 |
| R1234yf | Mass % | 5.0 | 5.0 | 5.0 | 5.0 | 5.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 95.0 | 95.4 | 95.9 | 96.4 | 96.9 | 93.0 | 93.3 | 93.6 |
| | to R410A) | | | | | | | | |
| Refrigerating | % (relative | 105.8 | 105.2 | 104.5 | 103.9 | 103.1 | 105.7 | 105.5 | 105.2 |
| capacity ratio | to R410A) | | | | | | | | |

TABLE 52

| Item | Unit | Ex. 21 | Ex. 22 | Ex. 23 | Ex. 24 | Ex. 25 | Ex. 26 | Ex. 27 | Ex. 28 |
|---|---|---|---|---|---|---|---|---|---|
| HFO-1132(E) | Mass % | 25.0 | 30.0 | 35.0 | 40.0 | 45.0 | 50.0 | 55.0 | 60.0 |
| HFO-1123 | Mass % | 57.9 | 52.9 | 47.9 | 42.9 | 37.9 | 32.9 | 27.9 | 22.9 |
| R1234yf | Mass % | 10.0 | 10.0 | 10.0 | 10.0 | 10.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to R410A) | 93.9 | 94.2 | 94.6 | 95.0 | 95.5 | 96.0 | 96.4 | 96.9 |
| Refrigerating capacity ratio | % (relative to R410A) | 104.9 | 104.5 | 104.1 | 103.6 | 103.0 | 102.4 | 101.7 | 101.0 |

TABLE 53

| | | Comp. Ex. | Ex. | Ex. | Ex. | Ex. | Ex. | Ex. | Ex. |
|---|---|---|---|---|---|---|---|---|---|
| Item | Unit | 68 | 29 | 30 | 31 | 32 | 33 | 34 | 35 |
| HFO-1132(E) | Mass % | 65.0 | 10.0 | 15.0 | 20.0 | 25.0 | 30.0 | 35.0 | 40.0 |
| HFO-1123 | Mass % | 17.9 | 67.9 | 62.9 | 57.9 | 52.9 | 47.9 | 42.9 | 37.9 |
| R1234yf | Mass % | 10.0 | 15.0 | 15.0 | 15.0 | 15.0 | 15.0 | 15.0 | 15.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to R410A) | 97.4 | 93.5 | 93.8 | 94.1 | 94.4 | 94.8 | 95.2 | 95.6 |
| Refrigerating | % (relative to R410A) | 100.3 | 102.9 | 102.7 | 102.5 | 102.1 | 101.7 | 101.2 | 100.7 |
| capacity ratio | | | | | | | | | |

TABLE 54

| | | Ex. | Ex. | Ex. | Ex. | Comp. Ex. | Ex. | Ex. | Ex. |
|---|---|---|---|---|---|---|---|---|---|
| Item | Unit | 36 | 37 | 38 | 39 | 69 | 40 | 41 | 42 |
| HFO-1132(E) | Mass % | 45.0 | 50.0 | 55.0 | 60.0 | 65.0 | 10.0 | 15.0 | 20.0 |
| HFO-1123 | Mass % | 32.9 | 27.9 | 22.9 | 17.9 | 12.9 | 62.9 | 57.9 | 52.9 |
| R1234yf | Mass % | 15.0 | 15.0 | 15.0 | 15.0 | 15.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to | 96.0 | 96.5 | 97.0 | 97.5 | 98.0 | 94.0 | 94.3 | 94.6 |
| | R410A) | | | | | | | | |
| Refrigerating | % (relative to | 100.1 | 99.5 | 98.9 | 98.1 | 97.4 | 100.1 | 99.9 | 99.6 |
| capacity ratio | R410A) | | | | | | | | |

TABLE 55

| Item | Unit | Ex. 43 | Ex. 44 | Ex. 45 | Ex. 46 | Ex. 47 | Ex. 48 | Ex. 49 | Ex. 50 |
|---|---|---|---|---|---|---|---|---|---|
| HFO-1132(E) | Mass % | 25.0 | 30.0 | 35.0 | 40.0 | 45.0 | 50.0 | 55.0 | 60.0 |
| HFO-1123 | Mass % | 47.9 | 42.9 | 37.9 | 32.9 | 27.9 | 22.9 | 17.9 | 12.9 |
| R1234yf | Mass % | 20.0 | 20.0 | 20.0 | 20.0 | 20.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to R410A) | 95.0 | 95.3 | 95.7 | 96.2 | 96.6 | 97.1 | 97.6 | 98.1 |
| Refrigerating | % (relative to R410A) | 99.2 | 98.8 | 98.3 | 97.8 | 97.2 | 96.6 | 95.9 | 95.2 |
| capacity ratio | | | | | | | | | |

TABLE 56

| | | Comp. Ex. | Ex. | Ex. | Ex. | Ex. | Ex. | Ex. | Ex. |
|---|---|---|---|---|---|---|---|---|---|
| Item | Unit | 70 | 51 | 52 | 53 | 54 | 55 | 56 | 57 |
| HFO-1132(E) | Mass % | 65.0 | 10.0 | 15.0 | 20.0 | 25.0 | 30.0 | 35.0 | 40.0 |
| HFO-1123 | Mass % | 7.9 | 57.9 | 52.9 | 47.9 | 42.9 | 37.9 | 32.9 | 27.9 |
| R1234yf | Mass % | 20.0 | 25.0 | 25.0 | 25.0 | 25.0 | 25.0 | 25.0 | 25.0 |
| R32 | Mass % | 7.1 | 7.1 | 7.1 | 7.1 | 7.1 | 7.1 | 7.1 | 7.1 |
| GWP | — | 49 | 50 | 50 | 50 | 50 | 50 | 50 | 50 |
| COP ratio | % (relative to R410A) | 98.6 | 94.6 | 94.9 | 95.2 | 95.5 | 95.9 | 96.3 | 96.8 |
| Refrigerating | % (relative to R410A) | 94.4 | 97.1 | 96.9 | 96.7 | 96.3 | 95.9 | 95.4 | 94.8 |
| capacity ratio | | | | | | | | | |

TABLE 57

| | | Ex. | Ex. | Ex. | Ex. | Comp. Ex. | Ex. | Ex. | Ex. |
|---|---|---|---|---|---|---|---|---|---|
| Item | Unit | 58 | 59 | 60 | 61 | 71 | 62 | 63 | 64 |
| HFO-132(E) | Mass % | 45.0 | 50.0 | 55.0 | 60.0 | 65.0 | 10.0 | 15.0 | 20.0 |
| HFO-1123 | Mass % | 7.1 | 7.1 | 7.1 | 7.1 | 7.1 | 7.1 | 7.1 | 7.1 |
| R1234yf | Mass % | 25.0 | 25.0 | 25.0 | 25.0 | 25.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to R410A) | 97.2 | 97.7 | 98.2 | 98.7 | 99.2 | 95.2 | 95.5 | 95.8 |
| Refrigerating | % (relative to R410A) | 94.2 | 93.6 | 92.9 | 92.2 | 91.4 | 94.2 | 93.9 | 93.7 |
| capacity ratio | | | | | | | | | |

TABLE 58

| Item | Unit | Ex. 65 | Ex. 66 | Ex. 67 | Ex. 68 | Ex. 69 | Ex. 70 | Ex. 71 | Ex. 72 |
|---|---|---|---|---|---|---|---|---|---|
| HFO-1132(E) | Mass % | 25.0 | 30.0 | 35.0 | 40.0 | 45.0 | 50.0 | 55.0 | 60.0 |
| HFO-1123 | Mass % | 37.9 | 32.9 | 27.9 | 22.9 | 17.9 | 12.9 | 7.9 | 2.9 |
| R1234yf | Mass % | 30.0 | 30.0 | 30.0 | 30.0 | 30.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to R410A) | 96.2 | 96.6 | 97.0 | 97.4 | 97.9 | 98.3 | 98.8 | 99.3 |
| Refrigerating capacity ratio | % (relative to R410A) | 93.3 | 92.9 | 92.4 | 91.8 | 91.2 | 90.5 | 89.8 | 89.1 |

TABLE 59

| Item | Unit | Ex. 73 | Ex. 74 | Ex. 75 | Ex. 76 | Ex. 77 | Ex. 78 | Ex. 79 | Ex. 80 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 47.9 | 42.9 | 37.9 | 32.9 | 27.9 | 22.9 | 17.9 | 12.9 |
| R1234yf | Mass % | 35.0 | 35.0 | 35.0 | 35.0 | 35.0 | 35.0 | 35.0 | 35.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to R410A) | 95.9 | 96.2 | 96.5 | 96.9 | 97.2 | 97.7 | 98.1 | 98.5 |
| Refrigerating capacity ratio | % (relative to R410A) | 91.1 | 90.9 | 90.6 | 90.2 | 89.8 | 89.3 | 88.7 | 88.1 |

TABLE 60

| Item | Unit | Ex. 81 | Ex. 82 | Ex. 83 | Ex. 84 | Ex. 85 | Ex. 86 | Ex. 87 | Ex. 88 |
|---|---|---|---|---|---|---|---|---|---|
| HFO-1132(E) | Mass % | 50.0 | 55.0 | 10.0 | 15.0 | 20.0 | 25.0 | 30.0 | 35.0 |
| HFO-1123 | Mass % | 7.9 | 2.9 | 42.9 | 37.9 | 32.9 | 27.9 | 22.9 | 17.9 |
| R1234yf | Mass % | 35.0 | 35.0 | 40.0 | 40.0 | 40.0 | 40.0 | 40.0 | 40.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to R410A) | 99.0 | 99.4 | 96.6 | 96.9 | 97.2 | 97.6 | 98.0 | 98.4 |
| Refrigerating capacity ratio | % (relative to R410A) | 87.4 | 86.7 | 88.0 | 87.8 | 87.5 | 87.1 | 86.6 | 86.1 |

TABLE 61

| | | Comp. | Comp. | Comp. | Comp. | Comp. | Comp. | Comp. | Comp. |
|---|---|---|---|---|---|---|---|---|---|
| Item | Unit | Ex. 72 | Ex. 73 | Ex. 74 | Ex. 75 | Ex. 76 | Ex. 77 | Ex. 78 | Ex. 79 |
| HFO-1132(E) | Mass % | 40.0 | 45.0 | 50.0 | 10.0 | 15.0 | 20.0 | 25.0 | 30.0 |
| HFO-1123 | Mass % | 12.9 | 7.9 | 2.9 | 37.9 | 32.9 | 27.9 | 22.9 | 17.9 |
| R1234yf | Mass % | 40.0 | 40.0 | 40.0 | 45.0 | 45.0 | 45.0 | 45.0 | 45.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to | 98.8 | 99.2 | 99.6 | 97.4 | 97.7 | 98.0 | 98.3 | 98.7 |
| | R410A) | | | | | | | | |
| Refrigerating | % (relative to | 85.5 | 84.9 | 84.2 | 84.9 | 84.6 | 84.3 | 83.9 | 83.5 |
| capacity ratio | R410A) | | | | | | | | |

TABLE 62

| Item | Unit | Comp. Ex. 80 | Comp. Ex. 81 | Comp. Ex. 82 |
|---|---|---|---|---|
| HFO-1132(E) | Mass % | 35.0 | 40.0 | 45.0 |
| HFO-1123 | Mass % | 12.9 | 7.9 | 2.9 |
| R1234yf | Mass % | 45.0 | 45.0 | 45.0 |
| R32 | Mass % | 7.1 | 7.1 | 7.1 |
| GWP | — | 50 | 50 | 50 |
| COP ratio | % (relative | 99.1 | 99.5 | 99.9 |
| | to R410A) | | | |
| Refrigerating | % (relative | 82.9 | 82.3 | 81.7 |
| capacity ratio | to R410A) | | | |

TABLE 63

| Item | Unit | Ex. 89 | Ex. 90 | Ex. 91 | Ex. 92 | Ex. 93 | Ex. 94 | Ex. 95 | Ex. 96 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 70.5 | 65.5 | 60.5 | 55.5 | 50.5 | 45.5 | 40.5 | 35.5 |
| R1234yf | Mass % | 5.0 | 5.0 | 5.0 | 5.0 | 5.0 | 5.0 | 5.0 | 5.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to R410A) | 93.7 | 93.9 | 94.1 | 94.4 | 94.7 | 95.0 | 95.4 | 95.8 |
| Refrigerating capacity ratio | % (relative to R410A) | 110.2 | 110.0 | 109.7 | 109.3 | 108.9 | 108.4 | 107.9 | 107.3 |

TABLE 64

| | | Ex. | Comp. Ex. | Ex. | Ex. | Ex. | Ex. | Ex. | Ex. |
|---|---|---|---|---|---|---|---|---|---|
| Item | Unit | 97 | 83 | 98 | 99 | 100 | 101 | 102 | 103 |
| HFO-1132(E) | Mass % | 50.0 | 55.0 | 10.0 | 15.0 | 20.0 | 25.0 | 30.0 | 35.0 |
| HFO-1123 | Mass % | 30.5 | 25.5 | 65.5 | 60.5 | 55.5 | 50.5 | 45.5 | 40.5 |
| R1234yf | Mass % | 5.0 | 5.0 | 10.0 | 10.0 | 10.0 | 10.0 | 10.0 | 10.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to | 96.2 | 96.6 | 94.2 | 94.4 | 94.6 | 94.9 | 95.2 | 95.5 |
| | R410A) | | | | | | | | |
| Refrigerating capacity | % (relative to | 106.6 | 106.0 | 107.5 | 107.3 | 107.0 | 106.6 | 106.1 | 105.6 |
| ratio | R410A) | | | | | | | | |

TABLE 65

| | | Ex. | Ex. | Ex. | Comp. Ex. | Ex. | Ex. | Ex. | Ex. |
|---|---|---|---|---|---|---|---|---|---|
| Item | Unit | 104 | 105 | 106 | 84 | 107 | 108 | 109 | 110 |
| HFO-1132(E) | Mass % | 40.0 | 45.0 | 50.0 | 55.0 | 10.0 | 15.0 | 20.0 | 25.0 |
| HFO-1123 | Mass % | 35.5 | 30.5 | 25.5 | 20.5 | 60.5 | 55.5 | 50.5 | 45.5 |
| R1234yf | Mass % | 10.0 | 10.0 | 10.0 | 10.0 | 15.0 | 15.0 | 15.0 | 15.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to | 95.9 | 96.3 | 96.7 | 97.1 | 94.6 | 94.8 | 95.1 | 95.4 |
| | R410A) | | | | | | | | |
| Refrigerating capacity | % (relative to | 105.1 | 104.5 | 103.8 | 103.1 | 104.7 | 104.5 | 104.1 | 103.7 |
| ratio | R410A) | | | | | | | | |

TABLE 66

| | | Ex. | Ex. | Ex. | Ex. | Ex. | Comp. Ex. | Ex. | Ex. |
|---|---|---|---|---|---|---|---|---|---|
| Item | Unit | 111 | 112 | 113 | 114 | 115 | 85 | 116 | 117 |
| HFO-1132(E) | Mass % | 30.0 | 35.0 | 40.0 | 45.0 | 50.0 | 55.0 | 10.0 | 15.0 |
| HFO-1123 | Mass % | 40.5 | 35.5 | 30.5 | 25.5 | 20.5 | 15.5 | 55.5 | 50.5 |
| R1234yf | Mass % | 15.0 | 15.0 | 15.0 | 15.0 | 15.0 | 15.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to | 95.7 | 96.0 | 96.4 | 96.8 | 97.2 | 97.6 | 95.1 | 95.3 |
| | R410A) | | | | | | | | |
| Refrigerating capacity | % (relative to | 103.3 | 102.8 | 102.2 | 101.6 | 101.0 | 100.3 | 101.8 | 101.6 |
| ratio | R410A) | | | | | | | | |

TABLE 67

| | | Ex. | Ex. | Ex. | Ex. | Ex. | Ex. | Ex. | Comp. Ex. |
|---|---|---|---|---|---|---|---|---|---|
| Item | Unit | 118 | 119 | 120 | 121 | 122 | 123 | 124 | 86 |
| HFO-1132(E) | Mass % | 20.0 | 25.0 | 30.0 | 35.0 | 40.0 | 45.0 | 50.0 | 55.0 |
| HFO-1123 | Mass % | 45.5 | 40.5 | 35.5 | 30.5 | 25.5 | 20.5 | 15.5 | 10.5 |
| R1234yf | Mass % | 20.0 | 20.0 | 20.0 | 20.0 | 20.0 | 20.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to | 95.6 | 95.9 | 96.2 | 96.5 | 96.9 | 97.3 | 97.7 | 98.2 |
| | R410A) | | | | | | | | |
| Refrigerating capacity | % (relative to | 101.2 | 100.8 | 100.4 | 99.9 | 99.3 | 98.7 | 98.0 | 97.3 |
| ratio | R410A) | | | | | | | | |

TABLE 68

| | | Ex. | Ex. | Ex. | Ex. | Ex. | Ex. | Ex. | Ex. |
|---|---|---|---|---|---|---|---|---|---|
| Item | Unit | 125 | 126 | 127 | 128 | 129 | 130 | 131 | 132 |
| HFO- | Mass | 10.0 | 15.0 | 20.0 | 25.0 | 30.0 | 35.0 | 40.0 | 45.0 |
| 1132 | % | | | | | | | | |
| (E) | | | | | | | | | |
| HFO- | Mass | 50.5 | 45.5 | 40.5 | 35.5 | 30.5 | 25.5 | 20.5 | 15.5 |
| 1123 | % | | | | | | | | |
| R1234yf | Mass | 25.0 | 25.0 | 25.0 | 25.0 | 25.0 | 25.0 | 25.0 | 25.0 |
| | % | | | | | | | | |
| R32 | Mass | 14.5 | 14.5 | 14.5 | 14.5 | 14.5 | 14.5 | 14.5 | 14.5 |
| | % | | | | | | | | |
| GWP | — | 99 | 99 | 99 | 99 | 99 | 99 | 99 | 99 |
| COP | % | 95.6 | 95.9 | 96.1 | 96.4 | 96.7 | 97.1 | 97.5 | 97.9 |
| ratio | (relative | | | | | | | | |
| | to | | | | | | | | |
| | R410A) | | | | | | | | |
| Refrig- | % | 98.9 | 98.6 | 98.3 | 97.9 | 97.4 | 96.9 | 96.3 | 95.7 |
| erating | (relative | | | | | | | | |
| capacity | to | | | | | | | | |
| ratio | R410A) | | | | | | | | |

TABLE 69

| | | | Comp. | | | | | | |
|---|---|---|---|---|---|---|---|---|---|
| | | Ex. | Ex. | Ex. | Ex. | Ex. | Ex. | Ex. | Ex. |
| Item | Unit | 133 | 87 | 134 | 135 | 136 | 137 | 138 | 139 |
| HFO-1132 (E) | Mass % | 50.0 | 55.0 | 10.0 | 15.0 | 20.0 | 25.0 | 30.0 | 35.0 |
| HFO-1123 | Mass % | 10.5 | 5.5 | 45.5 | 40.5 | 35.5 | 30.5 | 25.5 | 20.5 |
| R1234yf | Mass % | 25.0 | 25.0 | 30.0 | 30.0 | 30.0 | 30.0 | 30.0 | 30.0 |
| R32 | Mass % | 14.5 | 14.5 | 14.5 | 14.5 | 14.5 | 14.5 | 14.5 | 14.5 |
| GWP | — | 99 | 99 | 100 | 100 | 100 | 100 | 100 | 100 |
| COP ratio | % | 98.3 | 98.7 | 96.2 | 96.4 | 96.7 | 97.0 | 97.3 | 97.7 |
| | (relative to | | | | | | | | |
| | R410A) | | | | | | | | |
| Refrigerating | % | 95.0 | 94.3 | 95.8 | 95.6 | 95.2 | 94.8 | 94.4 | 93.8 |
| capacity ratio | (relative to | | | | | | | | |
| | R410A) | | | | | | | | |

TABLE 70

| | | Ex. | Ex. | Ex. | Ex. | Ex. | Ex. | Ex. | Ex. |
|---|---|---|---|---|---|---|---|---|---|
| Item | Unit | 140 | 141 | 142 | 143 | 144 | 145 | 146 | 147 |
| HFO- | Mass | 40.0 | 45.0 | 50.0 | 10.0 | 15.0 | 20.0 | 25.0 | 30.0 |
| 1132 | % | | | | | | | | |
| (E) | | | | | | | | | |
| HFO- | Mass | 15.5 | 10.5 | 5.5 | 40.5 | 35.5 | 30.5 | 25.5 | 20.5 |
| 1123 | % | | | | | | | | |
| R1234yf | Mass | 30.0 | 30.0 | 30.0 | 35.0 | 35.0 | 35.0 | 35.0 | 35.0 |
| | % | | | | | | | | |
| R32 | Mass | 14.5 | 14.5 | 14.5 | 14.5 | 14.5 | 14.5 | 14.5 | 14.5 |
| | % | | | | | | | | |
| GWP | — | 100 | 100 | 100 | 100 | 100 | 100 | 100 | 100 |
| COP | % | 98.1 | 98.5 | 98.9 | 96.8 | 97.0 | 97.3 | 97.6 | 97.9 |
| ratio | (relative | | | | | | | | |
| | to | | | | | | | | |
| | R410A) | | | | | | | | |
| Refrig- | % | 93.3 | 92.6 | 92.0 | 92.8 | 92.5 | 92.2 | 91.8 | 91.3 |
| erating | (relative | | | | | | | | |
| capacity | to | | | | | | | | |
| ratio | R410A) | | | | | | | | |

TABLE 71

| | | Ex. | Ex. | Ex. | Ex. | Ex. | Ex. | Ex. | Ex. |
|---|---|---|---|---|---|---|---|---|---|
| Item | Unit | 148 | 149 | 150 | 151 | 152 | 153 | 154 | 155 |
| HFO- | Mass | 35.0 | 40.0 | 45.0 | 10.0 | 15.0 | 20.0 | 25.0 | 30.0 |
| 1132 | % | | | | | | | | |
| (E) | | | | | | | | | |
| HFO- | Mass | 15.5 | 10.5 | 5.5 | 35.5 | 30.5 | 25.5 | 20.5 | 15.5 |
| 1123 | % | | | | | | | | |
| R1234yf | Mass | 35.0 | 35.0 | 35.0 | 40.0 | 40.0 | 40.0 | 40.0 | 40.0 |
| | % | | | | | | | | |
| R32 | Mass | 14.5 | 14.5 | 14.5 | 14.5 | 14.5 | 14.5 | 14.5 | 14.5 |
| | % | | | | | | | | |
| GWP | — | 100 | 100 | 100 | 100 | 100 | 100 | 100 | 100 |
| COP | % | 98.3 | 98.7 | 99.1 | 97.4 | 97.7 | 98.0 | 98.3 | 98.6 |
| ratio | (relative | | | | | | | | |
| | to | | | | | | | | |
| | R410A) | | | | | | | | |
| Refrig- | % | 90.8 | 90.2 | 89.6 | 89.6 | 89.4 | 89.0 | 88.6 | 88.2 |
| erating | (relative | | | | | | | | |
| capacity | to | | | | | | | | |
| ratio | R410A) | | | | | | | | |

TABLE 72

| | | | | | | | Comp. | Comp. | Comp. |
|---|---|---|---|---|---|---|---|---|---|
| | | Ex. | Ex. | Ex. | Ex. | Ex. | Ex. | Ex. | Ex. |
| Item | Unit | 156 | 157 | 158 | 159 | 160 | 88 | 89 | 90 |
| HFO-1132 | Mass % | 35.0 | 40.0 | 10.0 | 15.0 | 20.0 | 25.0 | 30.0 | 35.0 |
| (E) | | | | | | | | | |
| HFO-1123 | Mass % | 10.5 | 5.5 | 30.5 | 25.5 | 20.5 | 15.5 | 10.5 | 5.5 |
| R1234yf | Mass % | 40.0 | 40.0 | 45.0 | 45.0 | 45.0 | 45.0 | 45.0 | 45.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % | 98.9 | 99.3 | 98.1 | 98.4 | 98.7 | 98.9 | 99.3 | 99.6 |
| | (relative | | | | | | | | |
| | to | | | | | | | | |
| | R410A) | | | | | | | | |
| Refrigerating | % | 87.6 | 87.1 | 86.5 | 86.2 | 85.9 | 85.5 | 85.0 | 84.5 |
| capacity ratio | (relative | | | | | | | | |
| | to | | | | | | | | |
| | R410A) | | | | | | | | |

TABLE 73

| | | Comp. | Comp. | Comp. | Comp. | Comp. |
|---|---|---|---|---|---|---|
| | | Ex. | Ex. | Ex. | Ex. | Ex. |
| Item | Unit | 91 | 92 | 93 | 94 | 95 |
| HFO-1132 | Mass | 10.0 | 15.0 | 20.0 | 25.0 | 30.0 |
| (E) | % | | | | | |
| HFO-1123 | Mass | 25.5 | 20.5 | 15.5 | 10.5 | 5.5 |
| | % | | | | | |
| R1234yf | Mass | 50.0 | 50.0 | 50.0 | 50.0 | 50.0 |
| | % | | | | | |
| R32 | Mass | 14.5 | 14.5 | 14.5 | 14.5 | 14.5 |
| | % | | | | | |
| GWP | — | 100 | 100 | 100 | 100 | 100 |
| COP ratio | % | 98.9 | 99.1 | 99.4 | 99.7 | 100.0 |
| | (relative | | | | | |
| | to | | | | | |
| | R410A) | | | | | |
| Refrig- | % | 83.3 | 83.0 | 82.7 | 82.2 | 81.8 |
| erating | (relative | | | | | |
| capacity | to | | | | | |
| ratio | R410A) | | | | | |

TABLE 74

| | | Ex. | Ex. | Ex. | Ex. | Ex. | Ex. | Ex. | Ex. |
|---|---|---|---|---|---|---|---|---|---|
| Item | Unit | 161 | 162 | 163 | 164 | 165 | 166 | 167 | 168 |
| HFO- | Mass | 10.0 | 15.0 | 20.0 | 25.0 | 30.0 | 35.0 | 40.0 | 45.0 |
| 1132 | % | | | | | | | | |
| (E) | | | | | | | | | |
| HFO- | Mass | 63.1 | 58.1 | 53.1 | 48.1 | 43.1 | 38.1 | 33.1 | 28.1 |
| 1123 | % | | | | | | | | |
| R1234yf | Mass | 5.0 | 5.0 | 5.0 | 5.0 | 5.0 | 5.0 | 5.0 | 5.0 |
| | % | | | | | | | | |
| R32 | Mass | 21.9 | 21.9 | 21.9 | 21.9 | 21.9 | 21.9 | 21.9 | 21.9 |
| | % | | | | | | | | |
| GWP | — | 149 | 149 | 149 | 149 | 149 | 149 | 149 | 149 |
| COP | % | 94.8 | 95.0 | 95.2 | 95.4 | 95.7 | 95.9 | 96.2 | 96.6 |
| ratio | (relative | | | | | | | | |
| | to | | | | | | | | |
| | R410A) | | | | | | | | |
| Refrig- | % | 111.5 | 111.2 | 110.9 | 110.5 | 110.0 | 109.5 | 108.9 | 108.3 |
| erating | (relative | | | | | | | | |
| capacity | to | | | | | | | | |
| ratio | R410A) | | | | | | | | |

TABLE 75

| | | Comp. | | | | | | | |
|---|---|---|---|---|---|---|---|---|---|
| | | Ex. | Ex. | Ex. | Ex. | Ex. | Ex. | Ex. | Ex. |
| Item | Unit | 96 | 169 | 170 | 171 | 172 | 173 | 174 | 175 |
| HFO-1132 (E) | Mass % | 50.0 | 10.0 | 15.0 | 20.0 | 25.0 | 30.0 | 35.0 | 40.0 |
| HFO-1123 | Mass % | 23.1 | 58.1 | 53.1 | 48.1 | 43.1 | 38.1 | 33.1 | 28.1 |
| R1234yf | Mass % | 5.0 | 10.0 | 10.0 | 10.0 | 10.0 | 10.0 | 10.0 | 10.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % | 96.9 | 95.3 | 95.4 | 95.6 | 95.8 | 96.1 | 96.4 | 96.7 |
| | (relative to | | | | | | | | |
| | R410A) | | | | | | | | |
| Refrigerating | % | 107.7 | 108.7 | 108.5 | 108.1 | 107.7 | 107.2 | 106.7 | 106.1 |
| capacity ratio | (relative to | | | | | | | | |
| | R410A) | | | | | | | | |

TABLE 76

| | | | Comp. | | | | | | |
|---|---|---|---|---|---|---|---|---|---|
| | | Ex. | Ex. | Ex. | Ex. | Ex. | Ex. | Ex. | Ex. |
| Item | Unit | 176 | 97 | 177 | 178 | 179 | 180 | 181 | 182 |
| HFO-1132(E) | Mass % | 45.0 | 50.0 | 10.0 | 15.0 | 20.0 | 25.0 | 30.0 | 35.0 |
| HFO-1123 | Mass % | 23.1 | 18.1 | 53.1 | 48.1 | 43.1 | 38.1 | 33.1 | 28.1 |
| R1234yf | Mass % | 10.0 | 10.0 | 15.0 | 15.0 | 15.0 | 15.0 | 15.0 | 15.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative to | 97.0 | 97.4 | 95.7 | 95.9 | 96.1 | 96.3 | 96.6 | 96.9 |
| | R410A) | | | | | | | | |
| Refrigerating | % (relative to | 105.5 | 104.9 | 105.9 | 105.6 | 105.3 | 104.8 | 104.4 | 103.8 |
| capacity ratio | R410A) | | | | | | | | |

TABLE 77

| | | | | Comp. | | | | | |
|---|---|---|---|---|---|---|---|---|---|
| | | Ex. | Ex. | Ex. | Ex. | Ex. | Ex. | Ex. | Ex. |
| Item | Unit | 183 | 184 | 98 | 185 | 186 | 187 | 188 | 189 |
| HFO-1132(E) | Mass % | 40.0 | 45.0 | 50.0 | 10.0 | 15.0 | 20.0 | 25.0 | 30.0 |
| HFO-1123 | Mass % | 23.1 | 18.1 | 13.1 | 48.1 | 43.1 | 38.1 | 33.1 | 28.1 |
| R1234yf | Mass % | 15.0 | 15.0 | 15.0 | 20.0 | 20.0 | 20.0 | 20.0 | 20.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative to | 97.2 | 97.5 | 97.9 | 96.1 | 96.3 | 96.5 | 96.8 | 97.1 |
| | R410A) | | | | | | | | |
| Refrigerating | % (relative to | 103.3 | 102.6 | 102.0 | 103.0 | 102.7 | 102.3 | 101.9 | 101.4 |
| capacity ratio | R410A) | | | | | | | | |

TABLE 78

| | | | | | Comp. | | | | |
|---|---|---|---|---|---|---|---|---|---|
| | | Ex. | Ex. | Ex. | Ex. | Ex. | Ex. | Ex. | Ex. |
| Item | Unit | 190 | 191 | 192 | 99 | 193 | 194 | 195 | 196 |
| HFO-1132(E) | Mass % | 35.0 | 40.0 | 45.0 | 50.0 | 10.0 | 15.0 | 20.0 | 25.0 |
| HFO-1123 | Mass % | 23.1 | 18.1 | 13.1 | 8.1 | 43.1 | 38.1 | 33.1 | 28.1 |
| R1234yf | Mass % | 20.0 | 20.0 | 20.0 | 20.0 | 25.0 | 25.0 | 25.0 | 25.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative to | 97.4 | 97.7 | 98.0 | 98.4 | 96.6 | 96.8 | 97.0 | 97.3 |
| | R410A) | | | | | | | | |
| Refrigerating | % (relative to | 100.9 | 100.3 | 99.7 | 99.1 | 100.0 | 99.7 | 99.4 | 98.9 |
| capacity ratio | R410A) | | | | | | | | |

TABLE 79

| | | | | | | Comp. | | | |
|---|---|---|---|---|---|---|---|---|---|
| | | Ex. | Ex. | Ex. | Ex. | Ex. | Ex. | Ex. | Ex. |
| Item | Unit | 197 | 198 | 199 | 200 | 100 | 201 | 202 | 203 |
| HFO-1132(E) | Mass % | 30.0 | 35.0 | 40.0 | 45.0 | 50.0 | 10.0 | 15.0 | 20.0 |
| HFO-1123 | Mass % | 23.1 | 18.1 | 13.1 | 8.1 | 3.1 | 38.1 | 33.1 | 28.1 |
| R1234yf | Mass % | 25.0 | 25.0 | 25.0 | 25.0 | 25.0 | 30.0 | 30.0 | 30.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 150 | 150 | 150 |
| COP ratio | % (relative to | 97.6 | 97.9 | 98.2 | 98.5 | 98.9 | 97.1 | 97.3 | 97.6 |
| | R410A) | | | | | | | | |
| Refrigerating | % (relative to | 98.5 | 97.9 | 97.4 | 96.8 | 96.1 | 97.0 | 96.7 | 96.3 |
| capacity ratio | R410A) | | | | | | | | |

TABLE 80

| | | Ex. | Ex. | Ex. | Ex. | Ex. | Ex. | Ex. | Ex. |
|---|---|---|---|---|---|---|---|---|---|
| Item | Unit | 204 | 205 | 206 | 207 | 208 | 209 | 210 | 211 |
| HFO- | Mass | 25.0 | 30.0 | 35.0 | 40.0 | 45.0 | 10.0 | 15.0 | 20.0 |
| 1132 | % | | | | | | | | |
| (E) | | | | | | | | | |
| HFO- | Mass | 23.1 | 18.1 | 13.1 | 8.1 | 3.1 | 33.1 | 28.1 | 23.1 |
| 1123 | % | | | | | | | | |
| R1234yf | Mass | 30.0 | 30.0 | 30.0 | 30.0 | 30.0 | 35.0 | 35.0 | 35.0 |
| | % | | | | | | | | |
| R32 | Mass | 21.9 | 21.9 | 21.9 | 21.9 | 21.9 | 21.9 | 21.9 | 21.9 |
| | % | | | | | | | | |
| GWP | — | 150 | 150 | 150 | 150 | 150 | 150 | 150 | 150 |
| COP | % | 97.8 | 98.1 | 98.4 | 98.7 | 99.1 | 97.7 | 97.9 | 98.1 |
| ratio | (relative | | | | | | | | |
| | to | | | | | | | | |
| | R410A) | | | | | | | | |
| Refrig- | % | 95.9 | 95.4 | 94.9 | 94.4 | 93.8 | 93.9 | 93.6 | 93.3 |
| erating | (relative | | | | | | | | |
| capacity | to | | | | | | | | |
| ratio | R410A) | | | | | | | | |

TABLE 81

| | | Ex. | Ex. | Ex. | Ex. | Ex. | Ex. | Ex. | Ex. |
|---|---|---|---|---|---|---|---|---|---|
| Item | Unit | 212 | 213 | 214 | 215 | 216 | 217 | 218 | 219 |
| HFO- | Mass | 25.0 | 30.0 | 35.0 | 40.0 | 10.0 | 15.0 | 20.0 | 25.0 |
| 1132 | % | | | | | | | | |
| (E) | | | | | | | | | |
| HFO- | Mass | 18.1 | 13.1 | 8.1 | 3.1 | 28.1 | 23.1 | 18.1 | 13.1 |
| 1123 | % | | | | | | | | |
| R1234yf | Mass | 35.0 | 35.0 | 35.0 | 35.0 | 40.0 | 40.0 | 40.0 | 40.0 |
| | % | | | | | | | | |
| R32 | Mass | 21.9 | 21.9 | 21.9 | 21.9 | 21.9 | 21.9 | 21.9 | 21.9 |
| | % | | | | | | | | |
| GWP | — | 150 | 150 | 150 | 150 | 150 | 150 | 150 | 150 |
| COP | % | 98.4 | 98.7 | 99.0 | 99.3 | 98.3 | 98.5 | 98.7 | 99.0 |
| ratio | (relative | | | | | | | | |
| | to | | | | | | | | |
| | R410A) | | | | | | | | |
| Refrig- | % | 92.9 | 92.4 | 91.9 | 91.3 | 90.8 | 90.5 | 90.2 | 89.7 |
| erating | (relative | | | | | | | | |
| capacity | to | | | | | | | | |
| ratio | R410A) | | | | | | | | |

TABLE 82

| | | | | | | | | | Comp. |
|---|---|---|---|---|---|---|---|---|---|
| | | Ex. | Ex. | Ex. | Ex. | Ex. | Ex. | Ex. | Ex. |
| Item | Unit | 220 | 221 | 222 | 223 | 224 | 225 | 226 | 101 |
| HFO-1132(E) | Mass % | 30.0 | 35.0 | 10.0 | 15.0 | 20.0 | 25.0 | 30.0 | 10.0 |
| HFO-1123 | Mass % | 8.1 | 3.1 | 23.1 | 18.1 | 13.1 | 8.1 | 3.1 | 18.1 |
| R1234yf | Mass % | 40.0 | 40.0 | 45.0 | 45.0 | 45.0 | 45.0 | 45.0 | 50.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative to | 99.3 | 99.6 | 98.9 | 99.1 | 99.3 | 99.6 | 99.9 | 99.6 |
| | R410A) | | | | | | | | |
| Refrigerating | % (relative to | 89.3 | 88.8 | 87.6 | 87.3 | 87.0 | 86.6 | 86.2 | 84.4 |
| capacity ratio | R410A) | | | | | | | | |

TABLE 83

| | | Comp. | Comp. | Comp. |
|---|---|---|---|---|
| Item | Unit | Ex. 102 | Ex. 103 | Ex. 104 |
| HFO-1132(E) | Mass % | 15.0 | 20.0 | 25.0 |
| HFO-1123 | Mass % | 13.1 | 8.1 | 3.1 |
| R1234yf | Mass % | 50.0 | 50.0 | 50.0 |
| R32 | Mass % | 21.9 | 21.9 | 21.9 |
| GWP | — | 150 | 150 | 150 |
| COP ratio | % (relative | 99.8 | 100.0 | 100.2 |
| | to R410A) | | | |
| Refrigerating | % (relative | 84.1 | 83.8 | 83.4 |
| capacity ratio | to R410A) | | | |

TABLE 84

| | | Ex. | Ex. | Ex. | Ex. | Ex. | Ex. | Ex. | Comp. Ex. |
|---|---|---|---|---|---|---|---|---|---|
| Item | Unit | 227 | 228 | 229 | 230 | 231 | 232 | 233 | 105 |
| HFO-1132(E) | Mass % | 10.0 | 15.0 | 20.0 | 25.0 | 30.0 | 35.0 | 40.0 | 45.0 |
| HFO-1123 | Mass % | 55.7 | 50.7 | 45.7 | 40.7 | 35.7 | 30.7 | 25.7 | 20.7 |
| R1234yf | Mass % | 5.0 | 5.0 | 5.0 | 5.0 | 5.0 | 5.0 | 5.0 | 5.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative to | 95.9 | 96.0 | 96.2 | 96.3 | 96.6 | 96.8 | 97.1 | 97.3 |
| | R410A) | | | | | | | | |
| Refrigerating | % (relative to | 112.2 | 111.9 | 111.6 | 111.2 | 110.7 | 110.2 | 109.6 | 109.0 |
| capacity ratio | R410A) | | | | | | | | |

TABLE 85

| | | Ex. | Ex. | Ex. | Ex. | Ex. | Ex. | Ex. | Comp. Ex. |
|---|---|---|---|---|---|---|---|---|---|
| Item | Unit | 234 | 235 | 236 | 237 | 238 | 239 | 240 | 106 |
| HFO-1132(E) | Mass % | 10.0 | 15.0 | 20.0 | 25.0 | 30.0 | 35.0 | 40.0 | 45.0 |
| HFO-1123 | Mass % | 50.7 | 45.7 | 40.7 | 35.7 | 30.7 | 25.7 | 20.7 | 15.7 |
| R1234yf | Mass % | 10.0 | 10.0 | 10.0 | 10.0 | 10.0 | 10.0 | 10.0 | 10.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative to | 96.3 | 96.4 | 96.6 | 96.8 | 97.0 | 97.2 | 97.5 | 97.8 |
| | R410A) | | | | | | | | |
| Refrigerating | % (relative to | 109.4 | 109.2 | 108.8 | 108.4 | 107.9 | 107.4 | 106.8 | 106.2 |
| capacity ratio | R410A) | | | | | | | | |

TABLE 86

| | | Ex. | Ex. | Ex. | Ex. | Ex. | Ex. | Ex. | Comp. Ex. |
|---|---|---|---|---|---|---|---|---|---|
| Item | Unit | 241 | 242 | 243 | 244 | 245 | 246 | 247 | 107 |
| HFO-1132(E) | Mass % | 10.0 | 15.0 | 20.0 | 25.0 | 30.0 | 35.0 | 40.0 | 45.0 |
| HFO-1123 | Mass % | 45.7 | 40.7 | 35.7 | 30.7 | 25.7 | 20.7 | 15.7 | 10.7 |
| R1234yf | Mass % | 15.0 | 15.0 | 15.0 | 15.0 | 15.0 | 15.0 | 15.0 | 15.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative to | 96.7 | 96.8 | 97.0 | 97.2 | 97.4 | 97.7 | 97.9 | 98.2 |
| | R410A) | | | | | | | | |
| Refrigerating | % (relative to | 106.6 | 106.3 | 106.0 | 105.5 | 105.1 | 104.5 | 104.0 | 103.4 |
| capacity ratio | R410A) | | | | | | | | |

TABLE 87

| | | Ex. | Ex. | Ex. | Ex. | Ex. | Ex. | Ex. | Comp. Ex. |
|---|---|---|---|---|---|---|---|---|---|
| Item | Unit | 248 | 249 | 250 | 251 | 252 | 253 | 254 | 108 |
| HFO-1132(E) | Mass % | 10.0 | 15.0 | 20.0 | 25.0 | 30.0 | 35.0 | 40.0 | 45.0 |
| HFO-1123 | Mass % | 40.7 | 35.7 | 30.7 | 25.7 | 20.7 | 15.7 | 10.7 | 5.7 |
| R1234yf | Mass % | 20.0 | 20.0 | 20.0 | 20.0 | 20.0 | 20.0 | 20.0 | 20.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative to | 97.1 | 97.3 | 97.5 | 97.7 | 97.9 | 98.1 | 98.4 | 98.7 |
| | R410A) | | | | | | | | |
| Refrigerating | % (relative to | 103.7 | 103.4 | 103.0 | 102.6 | 102.2 | 101.6 | 101.1 | 100.5 |
| capacity ratio | R410A) | | | | | | | | |

TABLE 88

| Item | Unit | Ex. 255 | Ex. 256 | Ex. 257 | Ex. 258 | Ex. 259 | Ex. 260 | Ex. 261 | Ex. 262 |
|---|---|---|---|---|---|---|---|---|---|
| HFO-1132(E) | Mass % | 10.0 | 15.0 | 20.0 | 25.0 | 30.0 | 35.0 | 40.0 | 10.0 |
| HFO-1123 | Mass % | 35.7 | 30.7 | 25.7 | 20.7 | 15.7 | 10.7 | 5.7 | 30.7 |
| R1234yf | Mass % | 25.0 | 25.0 | 25.0 | 25.0 | 25.0 | 25.0 | 25.0 | 30.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative to | 97.6 | 97.7 | 97.9 | 98.1 | 98.4 | 98.6 | 98.9 | 98.1 |
| | R410A) | | | | | | | | |
| Refrigerating | % (relative to | 100.7 | 100.4 | 100.1 | 99.7 | 99.2 | 98.7 | 98.2 | 97.7 |
| capacity ratio | R410A) | | | | | | | | |

TABLE 89

| Item | Unit | Ex. 263 | Ex. 264 | Ex. 265 | Ex. 266 | Ex. 267 | Ex. 268 | Ex. 269 | Ex. 270 |
|---|---|---|---|---|---|---|---|---|---|
| HFO-1132(E) | Mass % | 15.0 | 20.0 | 25.0 | 30.0 | 35.0 | 10.0 | 15.0 | 20.0 |
| HFO-1123 | Mass % | 25.7 | 20.7 | 15.7 | 10.7 | 5.7 | 25.7 | 20.7 | 15.7 |
| R1234yf | Mass % | 30.0 | 30.0 | 30.0 | 30.0 | 30.0 | 35.0 | 35.0 | 35.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 200 | 200 | 200 |
| COP ratio | % (relative to | 98.2 | 98.4 | 98.6 | 98.9 | 99.1 | 98.6 | 98.7 | 98.9 |
| | R410A) | | | | | | | | |
| Refrigerating | % (relative to | 97.4 | 97.1 | 96.7 | 96.2 | 95.7 | 94.7 | 94.4 | 94.0 |
| capacity ratio | R410A) | | | | | | | | |

TABLE 90

| Item | Unit | Ex. 271 | Ex. 272 | Ex. 273 | Ex. 274 | Ex. 275 | Ex. 276 | Ex. 277 | Ex. 278 |
|---|---|---|---|---|---|---|---|---|---|
| HFO-1132(E) | Mass % | 25.0 | 30.0 | 10.0 | 15.0 | 20.0 | 25.0 | 10.0 | 15.0 |
| HFO-1123 | Mass % | 10.7 | 5.7 | 20.7 | 15.7 | 10.7 | 5.7 | 15.7 | 10.7 |
| R1234yf | Mass % | 35.0 | 35.0 | 40.0 | 40.0 | 40.0 | 40.0 | 45.0 | 45.0 |
| R32 | Mass % | 29.3 | 29.3 | 29.3 | 29.3 | 29.3 | 29.3 | 29.3 | 29.3 |
| GWP | — | 200 | 200 | 200 | 200 | 200 | 200 | 200 | 200 |
| COP ratio | % (relative to | 99.2 | 99.4 | 99.1 | 99.3 | 99.5 | 99.7 | 99.7 | 99.8 |
| | R410A) | | | | | | | | |
| Refrigerating | % (relative to | 93.6 | 93.2 | 91.5 | 91.3 | 90.9 | 90.6 | 88.4 | 88.1 |
| capacity ratio | R410A) | | | | | | | | |

TABLE 91

| | | | | Comp. | Comp. |
|---|---|---|---|---|---|
| Item | Unit | Ex. 279 | Ex. 280 | Ex. 109 | Ex. 110 |
| HFO-1132(E) | Mass % | 20.0 | 10.0 | 15.0 | 10.0 |
| HFO-1123 | Mass % | 5.7 | 10.7 | 5.7 | 5.7 |
| R1234yf | Mass % | 45.0 | 50.0 | 50.0 | 55.0 |
| R32 | Mass % | 29.3 | 29.3 | 29.3 | 29.3 |
| GWP | — | 200 | 200 | 200 | 200 |
| COP ratio | % (relative | 100.0 | 100.3 | 100.4 | 100.9 |
| | to R410A) | | | | |
| Refrigerating | % (relative | 87.8 | 85.2 | 85.0 | 82.0 |
| capacity ratio | to R410A) | | | | |

TABLE 92

| | | Ex. | Ex. | Ex. | Ex. | Ex. | Comp. Ex. | Ex. | Ex. |
|---|---|---|---|---|---|---|---|---|---|
| Item | Unit | 281 | 282 | 283 | 284 | 285 | 111 | 286 | 287 |
| HFO-1132(E) | Mass % | 10.0 | 15.0 | 20.0 | 25.0 | 30.0 | 35.0 | 10.0 | 15.0 |
| HFO-1123 | Mass % | 40.9 | 35.9 | 30.9 | 25.9 | 20.9 | 15.9 | 35.9 | 30.9 |
| R1234yf | Mass % | 5.0 | 5.0 | 5.0 | 5.0 | 5.0 | 5.0 | 10.0 | 10.0 |
| R32 | Mass % | 44.1 | 44.1 | 44.1 | 44.1 | 44.1 | 44.1 | 44.1 | 44.1 |
| GWP | — | 298 | 298 | 298 | 298 | 298 | 298 | 299 | 299 |
| COP ratio | % (relative to | | | | | | | | |
| | R410A) | 97.8 | 97.9 | 97.9 | 98.1 | 98.2 | 98.4 | 98.2 | 98.2 |
| Refrigerating | % (relative to | | | | | | | | |
| capacity ratio | R410A) | 112.5 | 112.3 | 111.9 | 111.6 | 111.2 | 110.7 | 109.8 | 109.5 |

TABLE 93

| | | Ex. | Ex. | Ex. | Comp. Ex. | Ex. | Ex. | Ex. | Ex. |
|---|---|---|---|---|---|---|---|---|---|
| Item | Unit | 288 | 289 | 290 | 112 | 291 | 292 | 293 | 294 |
| HFO-1132(E) | Mass % | 20.0 | 25.0 | 30.0 | 35.0 | 10.0 | 15.0 | 20.0 | 25.0 |
| HFO-1123 | Mass % | 25.9 | 20.9 | 15.9 | 10.9 | 30.9 | 25.9 | 20.9 | 15.9 |
| R1234yf | Mass % | 10.0 | 10.0 | 10.0 | 10.0 | 15.0 | 15.0 | 15.0 | 15.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative to | 98.3 | 98.5 | 98.6 | 98.8 | 98.6 | 98.6 | 98.7 | 98.9 |
| | R410A) | | | | | | | | |
| Refrigerating | % (relative to | 109.2 | 108.8 | 108.4 | 108.0 | 107.0 | 106.7 | 106.4 | 106.0 |
| capacity ratio | R410A) | | | | | | | | |

TABLE 94

| | | Ex. | Comp. Ex. | Ex. | Ex. | Ex. | Ex. | Ex. | Ex. |
|---|---|---|---|---|---|---|---|---|---|
| Item | Unit | 295 | 113 | 296 | 297 | 298 | 299 | 300 | 301 |
| HFO-1132(E) | Mass % | 30.0 | 35.0 | 10.0 | 15.0 | 20.0 | 25.0 | 30.0 | 10.0 |
| HFO-1123 | Mass % | 10.9 | 5.9 | 25.9 | 20.9 | 15.9 | 10.9 | 5.9 | 20.9 |
| R1234yf | Mass % | 15.0 | 15.0 | 20.0 | 20.0 | 20.0 | 20.0 | 20.0 | 25.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative to | 99.0 | 99.2 | 99.0 | 99.0 | 99.2 | 99.3 | 99.4 | 99.4 |
| | R410A) | | | | | | | | |
| Refrigerating | % (relative to | 105.6 | 105.2 | 104.1 | 103.9 | 103.6 | 103.2 | 102.8 | 101.2 |
| capacity ratio | R410A) | | | | | | | | |

TABLE 95

| Item | Unit | Ex. 302 | Ex. 303 | Ex. 304 | Ex. 305 | Ex. 306 | Ex. 307 | Ex. 308 | Ex. 309 |
|---|---|---|---|---|---|---|---|---|---|
| HFO-1132(E) | Mass % | 15.0 | 20.0 | 25.0 | 10.0 | 15.0 | 20.0 | 10.0 | 15.0 |
| HFO-1123 | Mass % | 15.9 | 10.9 | 5.9 | 15.9 | 10.9 | 5.9 | 10.9 | 5.9 |
| R1234yf | Mass % | 25.0 | 25.0 | 25.0 | 30.0 | 30.0 | 30.0 | 35.0 | 35.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative to | 99.5 | 99.6 | 99.7 | 99.8 | 99.9 | 100.0 | 100.3 | 100.4 |
| | R410A) | | | | | | | | |
| Refrigerating | % (relative to | 101.0 | 100.7 | 100.3 | 98.3 | 98.0 | 97.8 | 95.3 | 95.1 |
| capacity ratio | R410A) | | | | | | | | |

TABLE 96

| Item | Unit | Ex. 400 |
|---|---|---|
| HFO-1132(E) | Mass % | 10.0 |
| HFO-1123 | Mass % | 5.9 |
| R1234yf | Mass % | 40.0 |
| R32 | Mass % | 44.1 |
| GWP | — | 299 |
| COP ratio | % (relative | 100.7 |
| | to R410A) | |
| Refrigerating | % (relative | 92.3 |
| capacity ratio | to R410A) | |

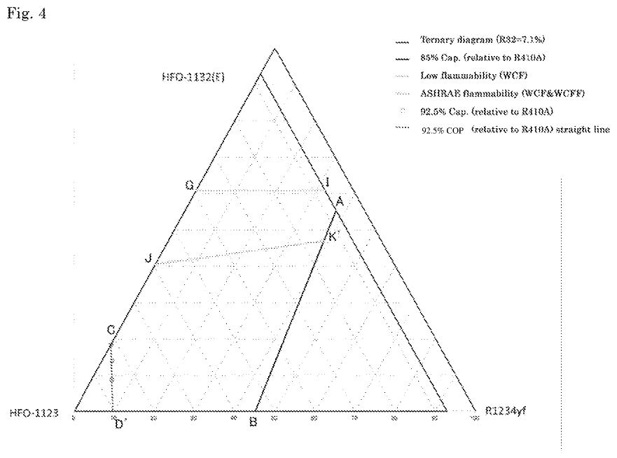

The above results indicate that the refrigerating capacity ratio relative to R410A is 85% or more in the following cases:
When the mass % of HFO-1132(E), HFO-1123, R1234yf, and R32 based on their sum is respectively represented by x, y, z, and a, in a ternary composition diagram in which the sum of HFO-1132(E), HFO-1123, and R1234yf is (100−a) mass %, a straight line connecting a point (0.0, 100.0−a, 0.0) and a point (0.0, 0.0, 100.0−a) is the base, and the point (0.0, 100.0−a, 0.0) is on the left side, if 0<a≤11.1, coordinates (x,y,z) in the ternary composition diagram are on, or on the left side of, a straight line AB that connects point A (0.0134a²−1.9681a+68.6, 0.0, −0.0134a²+0.9681a+31.4) and point B (0.0, 0.0144a²-1.6377a+58.7, −0.0144a²+0.6377a+41.3);
if 11.1<a≤18.2, coordinates (x,y,z) in the ternary composition diagram are on, or on the left side of, a straight line AB that connects point A (0.0112a²−1.9337a+68.484, 0.0, −0.0112a²+0.9337a+31.516) and point B (0.0, 0.0075a²−1.5156a+58.199, −0.0075a²+0.5156a+41.801);
if 18.2a<a≤26.7, coordinates (x,y,z) in the ternary composition diagram are on, or on the left side of, a straight line AB that connects point A (0.0107a²−1.9142a+68.305, 0.0, −0.0107a²+0.9142a+31.695) and point B (0.0, 0.009a²−1.6045a+59.318, −0.009a²+0.6045a+40.682);
if 26.7<a≤36.7, coordinates (x,y,z) in the ternary composition diagram are on, or on the left side of, a straight line AB that connects point A (0.0103a²−1.9225a+68.793, 0.0, −0.0103a²+0.9225a+31.207) and point B (0.0, 0.0046a²−1.41a+57.286, −0.0046a²+0.41a+42.714); and
if 36.7<a≤46.7, coordinates (x,y,z) in the ternary composition diagram are on, or on the left side of, a straight line AB that connects point A (0.0085a²−1.8102a+67.1, 0.0, −0.0085a²+0.8102a+32.9) and point B (0.0, 0.0012a²−1.1659a+52.95, −0.0012a²+0.1659a+47.05).
Actual points having a refrigerating capacity ratio of 85% or more form a curved line that connects point A and point B in FIG. 3, and that extends toward the 1234yf side. Accordingly, when coordinates are on, or on the left side of, the straight line AB, the refrigerating capacity ratio relative to R410A is 85% or more.
Similarly, it was also found that in the ternary composition diagram, if 0<a≤11.1, when coordinates (x,y,z) are on, or on the left side of, a straight line D′C that connects point D′ (0.0, 0.0224a²+0.968a+75.4, −0.0224a²−1.968a+24.6) and point C (−0.2304a²−0.4062a+32.9, 0.2304a²−0.5938a+67.1, 0.0); or if 11.1<a≤46.7, when coordinates are in the entire region, the COP ratio relative to that of R410A is 92.5% or more.
In FIG. 3, the COP ratio of 92.5% or more forms a curved line CD. In FIG. 3, an approximate line formed by connecting three points: point C (32.9, 67.1, 0.0) and points (26.6, 68.4, 5) (19.5, 70.5, 10) where the COP ratio is 92.5% when the concentration of R1234yf is 5 mass % and 10 mass was obtained, and a straight line that connects point C and point D′ (0, 75.4, 24.6), which is the intersection of the approximate line and a point where the concentration of HFO-1132(E) is 0.0 mass % was defined as a line segment D′C. In FIG. 4, point D′(0, 83.4, 9.5) was similarly obtained from an approximate curve formed by connecting point C (18.4, 74.5, 0) and points (13.9, 76.5, 2.5) (8.7, 79.2, 5) where the COP ratio is 92.5%, and a straight line that connects point C and point D′ was defined as the straight line D′C.
The composition of each mixture was defined as WCF. A leak simulation was performed using NIST Standard Reference Database REFLEAK Version 4.0 under the conditions of Equipment, Storage, Shipping, Leak, and Recharge according to the ASHRAE Standard 34-2013. The most flammable fraction was defined as WCFF.
For the flammability, the burning velocity was measured according to the ANSI/ASHRAE Standard 34-2013. Both WCF and WCFF having a burning velocity of 10 cm/s or less were determined to be classified as “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
The results are shown in Tables 97 to 104.

TABLE 97

| | | | Comp. Ex. | Comp. Ex. | Comp. Ex. | Comp. Ex. | Comp. Ex. | Comp. Ex. |
|---|---|---|---|---|---|---|---|---|
| Item | | | 6 | 13 | 19 | 24 | 29 | 34 |
| WCF | HFO-1132(E) | Mass | 72.0 | 60.9 | 55.8 | 52.1 | 48.6 | 45.4 |
| | | % | | | | | | |
| | HFO-1123 | Mass | 28.0 | 32.0 | 33.1 | 33.4 | 33.2 | 32.7 |
| | | % | | | | | | |
| | R1234yf | Mass | 0.0 | 0.0 | 0.0 | 0 | 0 | 0 |
| | | % | | | | | | |
| | R32 | Mass | 0.0 | 7.1 | 11.1 | 14.5 | 18.2 | 21.9 |
| | | % | | | | | | |

| | | | | | | | |
|---|---|---|---|---|---|---|---|
| Burning velocity (WCF) | cm/s | 10 | 10 | 10 | 10 | 10 | 10 |

TABLE 98

| Item | | | Comp. Ex. 39 | Comp. Ex. 45 | Comp. Ex. 51 | Comp. Ex. 57 | Comp. Ex. 62 |
|---|---|---|---|---|---|---|---|
| WCF | HFO-1132(E) | Mass % | 41.8 | 40 | 35.7 | 32 | 30.4 |
| | HFO-1123 | Mass % | 31.5 | 30.7 | 23.6 | 23.9 | 21.8 |
| | R1234yf | Mass % | 0 | 0 | 0 | 0 | 0 |
| | R32 | Mass % | 26.7 | 29.3 | 36.7 | 44.1 | 47.8 |

| | | | | | | |
|---|---|---|---|---|---|---|
| Burning velocity (WCF) | cm/s | 10 | 10 | 10 | 10 | 10 |

TABLE 99

| | | | Comp. Ex. | Comp. Ex. | Comp. Ex. | Comp. Ex. | Comp. Ex. | Comp. Ex. |
|---|---|---|---|---|---|---|---|---|
| Item | | | 7 | 14 | 20 | 25 | 30 | 35 |
| WCF | HFO-1132(E) | Mass | 72.0 | 60.9 | 55.8 | 52.1 | 48.6 | 45.4 |
| | | % | | | | | | |
| | HFO-1123 | Mass | 0.0 | 0.0 | 0.0 | 0 | 0 | 0 |
| | | % | | | | | | |
| | R1234yf | Mass | 28.0 | 32.0 | 33.1 | 33.4 | 33.2 | 32.7 |
| | | % | | | | | | |
| | R32 | Mass | 0.0 | 7.1 | 11.1 | 14.5 | 18.2 | 21.9 |
| | | % | | | | | | |

| | | | | | | | |
|---|---|---|---|---|---|---|---|
| Burning velocity (WCF) | cm/s | 10 | 10 | 10 | 10 | 10 | 10 |

TABLE 100

| Item | | | Comp. Ex. 40 | Comp. Ex. 46 | Comp. Ex. 52 | Comp. Ex. 58 | Comp. Ex. 63 |
|---|---|---|---|---|---|---|---|
| WCF | HFO-1132(E) | Mass % | 41.8 | 40 | 35.7 | 32 | 30.4 |
| | HFO-1123 | Mass % | 0 | 0 | 0 | 0 | 0 |
| | R1234yf | Mass % | 31.5 | 30.7 | 23.6 | 23.9 | 21.8 |
| | R32 | Mass % | 26.7 | 29.3 | 36.7 | 44.1 | 47.8 |

| | | | | | | |
|---|---|---|---|---|---|---|
| Burning velocity (WCF) | cm/s | 10 | 10 | 10 | 10 | 10 |

TABLE 101

| | | | Comp. | Comp. | Comp. | Comp. | Comp. | Comp. |
|---|---|---|---|---|---|---|---|---|
| | Item | | Ex. 8 | Ex. 15 | Ex. 21 | Ex. 26 | Ex. 31 | Ex. 36 |
| WCF | HFO-1132 | Mass | 47.1 | 40.5 | 37.0 | 34.3 | 32.0 | 30.3 |
| | (E) | % | | | | | | |
| | HFO-1123 | Mass | 52.9 | 52.4 | 51.9 | 51.2 | 49.8 | 47.8 |
| | | % | | | | | | |
| | R1234yf | Mass | 0.0 | 0.0 | 0.0 | 0.0 | 0.0 | 0.0 |
| | | % | | | | | | |
| | R32 | Mass | 0.0 | 7.1 | 11.1 | 14.5 | 18.2 | 21.9 |
| | | % | | | | | | |
| Leak condition that | | | Storage/ | Storage/ | Storage/ | Storage/ | Storage/ | Storage/ |
| results in WCFF | | | Shipping | Shipping | Shipping | Shipping | Shipping | Shipping |
| | | | −40° C., | −40° C., | −40° C., | −40° C., | −40° C., | −40° C., |
| | | | 92% | 92% | 92% | 92% | 92% | 92% |
| | | | release, | release, | release, | release, | release, | release, |
| | | | liquid | liquid | liquid | liquid | liquid | liquid |
| | | | phase side | phase side | phase side | phase side | phase side | phase side |
| WCFF | HFO-1132 | Mass | 72.0 | 62.4 | 56.2 | 50.6 | 45.1 | 40.0 |
| | (E) | % | | | | | | |
| | HFO-1123 | Mass | 28.0 | 31.6 | 33.0 | 33.4 | 32.5 | 30.5 |
| | | % | | | | | | |
| | R1234yf | Mass | 0.0 | 0.0 | 0.0 | 20.4 | 0.0 | 0.0 |
| | | % | | | | | | |
| | R32 | Mass | 0.0 | 50.9 | 10.8 | 16.0 | 22.4 | 29.5 |
| | | % | | | | | | |

| | | | | | | | |
|---|---|---|---|---|---|---|---|
| Burning velocity | cm/s | 8 or less | 8 or less | 8 or less | 8 or less | 8 or less | 8 or less |
| (WCF) | | | | | | | |
| Burning velocity | cm/s | 10 | 10 | 10 | 10 | 10 | 10 |
| (WCFF) | | | | | | | |

TABLE 102

| | | | Comp. | Comp. | Comp. | Comp. | Comp. |
|---|---|---|---|---|---|---|---|
| Item | | | Ex. 41 | Ex. 47 | Ex. 53 | Ex. 59 | Ex. 64 |
| WCF | HFO- | Mass | 29.1 | 28.8 | 29.3 | 29.4 | 28.9 |
| | 1132 | % | | | | | |
| | (E) | | | | | | |
| | HFO- | Mass | 44.2 | 41.9 | 34.0 | 26.5 | 23.3 |
| | 1123 | % | | | | | |
| | R1234yf | Mass | 0.0 | 0.0 | 0.0 | 0.0 | 0.0 |
| | | % | | | | | |
| | R32 | Mass | 26.7 | 29.3 | 36.7 | 44.1 | 47.8 |
| | | % | | | | | |
| Leak condition that | | | Storage/ | Storage/ | Storage/ | Storage/ | Storage/ |
| results in WCFF | | | Ship- | Ship- | Ship- | Ship- | Ship- |
| | | | ping | ping | ping | ping | ping |
| | | | −40° C., | −40° C., | −40° C., | −40° C., | −40° C., |
| | | | 92% | 92% | 92% | 90% | 86% |
| | | | release, | release, | release, | release, | release, |
| | | | liquid | liquid | liquid | gas | gas |
| | | | phase | phase | phase | phase | phase |
| | | | side | side | side | side | side |
| WCFF | HFO- | Mass | 34.6 | 32.2 | 27.7 | 28.3 | 27.5 |
| | 1132 | % | | | | | |
| | (E) | | | | | | |
| | HFO- | Mass | 26.5 | 23.9 | 17.5 | 18.2 | 16.7 |
| | 1123 | % | | | | | |
| | R1234yf | Mass | 0.0 | 0.0 | 0.0 | 0.0 | 0.0 |
| | | % | | | | | |
| | R32 | Mass | 38.9 | 43.9 | 54.8 | 53.5 | 55.8 |
| | | % | | | | | |

| | | | | | | |
|---|---|---|---|---|---|---|
| Burning velocity | cm/s | 8 or less | 8 or less | 8.3 | 9.3 | 9.6 |
| (WCF) | | | | | | |
| Burning velocity | cm/s | 10 | 10 | 10 | 10 | 10 |
| (WCFF) | | | | | | |

TABLE 103

| | | | Comp. | Comp. | Comp. | Comp. | Comp. | Comp. |
|---|---|---|---|---|---|---|---|---|
| Item | | | Ex. 9 | Ex. 16 | Ex. 22 | Ex. 27 | Ex. 32 | Ex. 37 |
| WCF | HFO-1132 | Mass | 61.7 | 47.0 | 41.0 | 36.5 | 32.5 | 28.8 |
| | (E) | % | | | | | | |
| | HFO-1123 | Mass | 5.9 | 7.2 | 6.5 | 5.6 | 4.0 | 2.4 |
| | | % | | | | | | |
| | R1234yf | Mass | 32.4 | 38.7 | 41.4 | 43.4 | 45.3 | 46.9 |
| | | % | | | | | | |
| | R32 | Mass | 0.0 | 7.1 | 11.1 | 14.5 | 18.2 | 21.9 |
| | | % | | | | | | |
| Leak condition that | | | Storage/ | Storage/ | Storage/ | Storage/ | Storage/ | Storage/ |
| results in WCFF | | | Shipping | Shipping | Shipping | Shipping | Shipping | Shipping |
| | | | −40° C., | −40° C., | −40° C., | −40° C., | −40° C., | −40° C., |
| | | | 0% | 0% | 0% | 92% | 0% | 0% |
| | | | release, | release, | release, | release, | release, | release, |
| | | | gas phase | gas phase | gas phase | liquid | gas phase | gas phase |
| | | | side | side | side | phase side | side | side |
| WCFF | HFO-1132 | Mass | 72.0 | 56.2 | 50.4 | 46.0 | 42.4 | 39.1 |
| | (E) | % | | | | | | |
| | HFO-1123 | Mass | 10.5 | 12.6 | 11.4 | 10.1 | 7.4 | 4.4 |
| | | % | | | | | | |
| | R1234yf | Mass | 17.5 | 20.4 | 21.8 | 22.9 | 24.3 | 25.7 |
| | | % | | | | | | |
| | R32 | Mass | 0.0 | 10.8 | 16.3 | 21.0 | 25.9 | 30.8 |
| | | % | | | | | | |

| | | | | | | | |
|---|---|---|---|---|---|---|---|
| Burning velocity | cm/s | 8 or less | 8 or less | 8 or less | 8 or less | 8 or less | 8 or less |
| (WCF) | | | | | | | |
| Burning velocity | cm/s | 10 | 10 | 10 | 10 | 10 | 10 |
| (WCFF) | | | | | | | |

TABLE 104

| | | | Comp. | Comp. | Comp. | Comp. | Comp. |
|---|---|---|---|---|---|---|---|
| Item | | | Ex. 42 | Ex. 48 | Ex. 54 | Ex. 60 | Ex. 65 |
| WCF | HFO- | Mass | 24.8 | 24.3 | 22.5 | 21.1 | 20.4 |
| | 1132 | % | | | | | |
| | (E) | | | | | | |
| | HFO- | Mass | 0.0 | 0.0 | 0.0 | 0.0 | 0.0 |
| | 1123 | % | | | | | |
| | R1234yf | Mass | 48.5 | 46.4 | 40.8 | 34.8 | 31.8 |
| | | % | | | | | |
| | R32 | Mass | 26.7 | 29.3 | 36.7 | 44.1 | 47.8 |
| | | % | | | | | |
| Leak condition that | | | Storage/ | Storage/ | Storage/ | Storage/ | Storage/ |
| results in WCFF | | | Ship- | Ship- | Ship- | Ship- | Ship- |
| | | | ping | ping | ping | ping | ping |
| | | | −40° C., | −40° C., | −40° C., | −40° C., | −40° C., |
| | | | 0% | 0% | 0% | 0% | 0% |
| | | | release, | release, | release, | release, | release, |
| | | | gas | gas | gas | gas | gas |
| | | | phase | phase | phase | phase | phase |
| | | | side | side | side | side | side |
| WCFF | HFO- | Mass | 35.3 | 34.3 | 31.3 | 29.1 | 28.1 |
| | 1132 | % | | | | | |
| | (E) | | | | | | |
| | HFO- | Mass | 0.0 | 0.0 | 0.0 | 0.0 | 0.0 |
| | 1123 | % | | | | | |
| | R1234yf | Mass | 27.4 | 26.2 | 23.1 | 19.8 | 18.2 |
| | | % | | | | | |
| | R32 | Mass | 37.3 | 39.6 | 45.6 | 51.1 | 53.7 |
| | | % | | | | | |

| | | | | | | |
|---|---|---|---|---|---|---|
| Burning velocity | cm/s | 8 or less | 8 or less | 8 or less | 8 or less | 8 or less |
| (WCF) | | | | | | |
| Burning velocity | cm/s | 10 | 10 | 10 | 10 | 10 |
| (WCFF) | | | | | | |

The results in Tables 97 to 100 indicate that the refrigerant has a WCF lower flammability in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, coordinates (x,y,z) in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line GI that connects point G (0.026a²−1.7478a+72.0, −0.026a²+0.7478a+28.0, 0.0) and point I (0.026a²−1.7478a+72.0, 0.0, −0.026a²+0.7478a+28.0);
   if 11.1<a≤18.2, coordinates (x,y,z) in the ternary composition diagram are on or below a straight line GI that connects point G (0.02a²−1.6013a+71.105, −0.02a²+0.6013a+28.895, 0.0) and point I (0.02a²−1.6013a+71.105, 0.0, −0.02a²+0.6013a+28.895); if 18.2<a≤26.7, coordinates (x,y,z) in the ternary composition diagram are on or below a straight line GI that connects point G (0.0135a²−1.4068a+69.727, −0.0135a²+0.4068a+30.273, 0.0) and point I (0.0135a²−1.4068a+69.727, 0.0, −0.0135a²+0.4068a+30.273); if 26.7<a≤36.7, coordinates (x,y,z) in the ternary composition diagram are on or below a straight line GI that connects point G (0.0111a²−1.3152a+68.986, −0.0111a²+0.3152a+31.014, 0.0) and point I (0.0111a²-1.3152a+68.986, 0.0, −0.0111a²+0.3152a+31.014); and if 36.7<a≤46.7, coordinates (x,y,z) in the ternary composition diagram are on or below a straight line GI that connects point G (0.0061a²−0.9918a+63.902, −0.0061a²−0.0082a+36.098, 0.0) and point I (0.0061a²-0.9918a+63.902, 0.0, −0.0061a²−0.0082a+36.098).
Three points corresponding to point G (Table 105) and point I (Table 106) were individually obtained in each of the following five ranges by calculation, and their approximate expressions were obtained.

TABLE 105

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 28.0 | 32.0 | 33.1 | 33.1 | 33.4 | 33.2 | 33.2 | 32.7 | 31.5 |
| R1234yf | 0 | 0 | 0 | 0 | 0 | 0 | 0 | 0 | 0 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | −0.026a² + 0..7478a + 28.0 | −0.02a² + 0..6013a + 28.895 | −0.0135a² − 0.4068a + 30.273 |
| Approximate | | | |
| expression | | | |
| R1234yf | 0 | 0 | 0 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 31.5 | 30.7 | 27.6 | 27.6 | 23.9 | 21.8 |
| R1234yf | 0 | 0 | 0 | 0 | 0 | 0 |

| | | |
|---|---|---|
| R32 | a | a |
| HFO-1132(E) | 0.0111a² − 1.3152a + 68.986 | 0.0061a² − 0.9918a + 63.902 |
| Approximate | | |
| expression | | |
| HFO-1123 | −0.0111a2 + 0.3152a + 31.014 | −0.0061a² − 0.0082a + 36.098 |
| Approximate | | |
| expression | | |
| R1234yf | 0 | 0 |
| Approximate | | |
| expression | | |

TABLE 106

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 0 | 0 | 0 | 0 | 0 | 0 | 0 | 0 | 0 |
| R1234yf | 28.0 | 32.0 | 33.1 | 33.1 | 33.4 | 33.2 | 33.2 | 32.7 | 31.5 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | 0 | 0 | 0 |
| Approximate | | | |
| expression | | | |
| R1234yf | −0.026a² + 0.7478a + 28.0 | −0.02a² + 0.6013a + 28.895 | −0.0135a² + 0.4068a + 30.273 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 0 | 0 | 0 | 0 | 0 | 0 |
| R1234yf | 31.5 | 30.7 | 23.6 | 23.6 | 23.5 | 21.8 |

| | | |
|---|---|---|
| R32 | x | x |
| HFO-1132(E) | 0.0111a² − 1.3152a + 68.986 | 0.0061a² − 0.9918a + 63.902 |
| Approximate | | |
| expression | | |
| HFO-1123 | 0 | 0 |
| Approximate | | |
| expression | | |
| R1234yf | −0.0111a² + 0.3152a + 31.014 | −0.0061a² − 0.0082a + 36.098 |
| Approximate | | |
| expression | | |

The results in Tables 101 to 104 indicate that the refrigerant is determined to have a WCFF lower flammability, and the flammability classification according to the ASHRAE Standard is “2L (flammability)” in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line JK′ that connects point J (0.0049a²−0.9645a+47.1, −0.0049a²−0.0355a+52.9, 0.0) and point K′(0.0514a²-2.4353a+61.7, −0.0323a²+0.4122a+5.9, −0.0191a²+1.0231a+32.4); if 11.1<a≤18.2, coordinates are on a straight line JK′ that connects point J (0.0243a²−1.4161a+49.725, −0.0243a²+0.4161a+50.275, 0.0) and point K′(0.0341a²−2.1977a+61.187, −0.0236a²+0.34a+5.636, −0.0105a²+0.8577a+33.177); if 18.2<a≤26.7, coordinates are on or below a straight line JK′ that connects point J (0.0246a²−1.4476a+50.184, −0.0246a²+0.4476a+49.816, 0.0) and point K′ (0.0196a²−1.7863a+58.515, −0.0079a²-0.1136a+8.702, −0.0117a²+0.8999a+32.783); if 26.7<a≤36.7, coordinates are on or below a straight line JK′ that connects point J (0.0183a²−1.1399a+46.493, −0.0183a²+0.1399a+53.507, 0.0) and point K′ (−0.0051a²+0.0929a+25.95, 0.0, 0.0051a²−1.0929a+74.05); and if 36.7<a≤46.7, coordinates are on or below a straight line JK′ that connects point J (−0.0134a²+1.0956a+7.13, 0.0134a²−2.0956a+92.87, 0.0) and point K′(−1.892a+29.443, 0.0, 0.892a+70.557).
Actual points having a WCFF lower flammability form a curved line that connects point J and point K′ (on the straight line AB) in FIG. 3 and extends toward the HFO-1132(E) side. Accordingly, when coordinates are on or below the straight line JK′, WCFF lower flammability is achieved.
Three points corresponding to point J (Table 107) and point K′ (Table 108) were individually obtained in each of the following five ranges by calculation, and their approximate expressions were obtained.

TABLE 107

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 47.1 | 40.5 | 37 | 37.0 | 34.3 | 32.0 | 32.0 | 30.3 | 29.1 |
| HFO-1123 | 52.9 | 52.4 | 51.9 | 51.9 | 51.2 | 49.8 | 49.8 | 47.8 | 44.2 |
| R1234yf | 0 | 0 | 0 | 0 | 0 | 0 | 0 | 0 | 0 |

| | | | |
|---|---|---|---|
| R32 | a | a | a |
| HFO-1132(E) | 0.0049a² − 0.9645a + 47.1 | 0.0243a² − 1.4161a + 49.725 | 0.0246a² − 1.4476a + 50.184 |
| Approximate | | | |
| expression | | | |
| HFO-1123 | −0.0049a² − 0.0355a + 52.9 | −0.0243a² + 0.4161a + 50.275 | −0.0246a ² + 0.4476a + 49.816 |
| Approximate | | | |
| expression | | | |
| R1234yf | 0 | 0 | 0 |
| Approximate | | | |
| expression | | | |

| Item | 36.7 ≥ R32 ≥ 26.7 | | | 47.8 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 29.1 | 28.8 | 29.3 | 29.3 | 29.4 | 28.9 |
| HFO-1123 | 44.2 | 41.9 | 34.0 | 34.0 | 26.5 | 23.3 |
| R1234yf | 0 | 0 | 0 | 0 | 0 | 0 |

| | | |
|---|---|---|
| R32 | a | a |
| HFO-1132(E) | 0.0183a² − 1.1399a + 46.493 | −0.0134a² + 1.0956a + 7.13 |
| Approximate | | |
| expression | | |
| HFO-1123 | −0.0183a² + 0.1399a + 53.507 | 0.0134a² − 2.0956a + 92.87 |
| Approximate | | |
| expression | | |
| R1234yf | 0 | 0 |
| Approximate | | |
| expression | | |

TABLE 108

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 61.7 | 47.0 | 41.0 | 41.0 | 36.5 | 32.5 | 32.5 | 28.8 | 24.8 |
| HFO-1123 | 5.9 | 7.2 | 6.5 | 6.5 | 5.6 | 4.0 | 4.0 | 2.4 | 0 |
| R1234yf | 32.4 | 38.7 | 41.4 | 41.4 | 43.4 | 45.3 | 45.3 | 46.9 | 48.5 |

| | | | |
|---|---|---|---|
| R32 | x | x | x |
| HFO-1132(E) | 0.0514a² − 2.4353a + 61.7 | 0.0341a² − 2.1977a + 61.187 | 0.0196a² − 1.7863a + 58.515 |
| Approximate | | | |
| expression | | | |
| HFO-1123 | −0.0323a² + 0.4122a + 5.9 | −0.0236a² + 0.34a + 5.636 | −0.0079a² − 0.1136a + 8.702 |
| Approximate | | | |
| expression | | | |
| R1234yf | −0.0191a² + 1.0231a + 32.4 | −0.0105a² + 0.8577a + 33.177 | −0.0117a² + 0.8999a + 32.783 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 24.3 | 22.5 | 22.5 | 21.1 | 20.4 |
| HFO-1123 | 0 | 0 | 0 | 0 | 0 | 0 |
| R1234yf | 48.5 | 46.4 | 40.8 | 40.8 | 34.8 | 31.8 |

| | | |
|---|---|---|
| R32 | x | x |
| HFO-1132(E) | −0.0051a² + 0.0929a + 25.95 | −1.892a + 29.443 |
| Approximate | | |
| expression | | |
| HFO-1123 | 0 | 0 |
| Approximate | | |
| expression | | |
| R1234yf | 0.0051a² − 1.0929a + 74.05 | 0.892a + 70.557 |
| Approximate | | |
| expression | | |

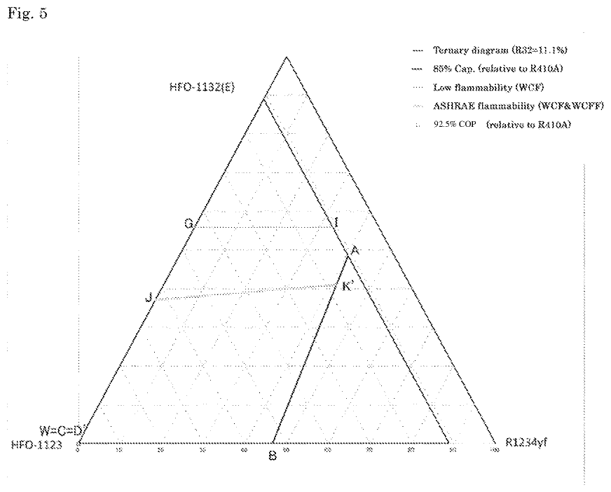

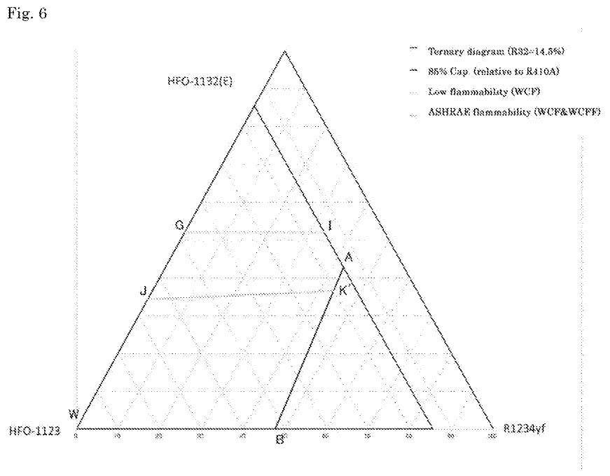

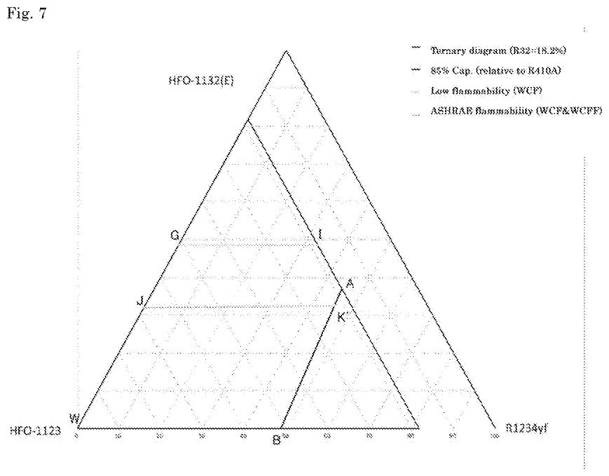

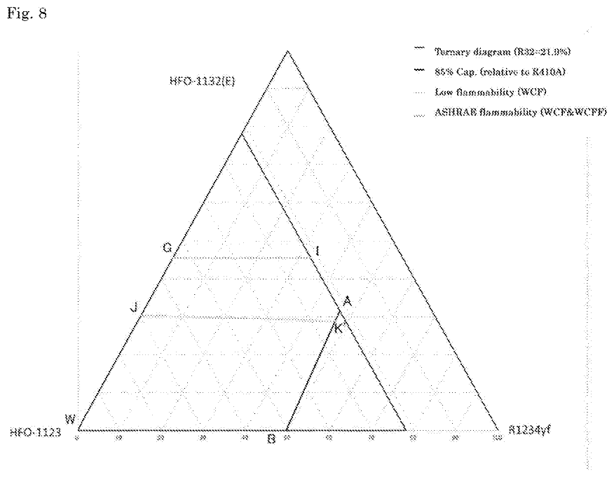

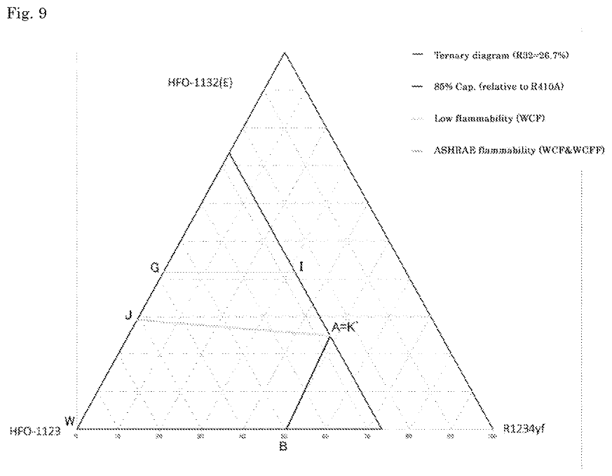

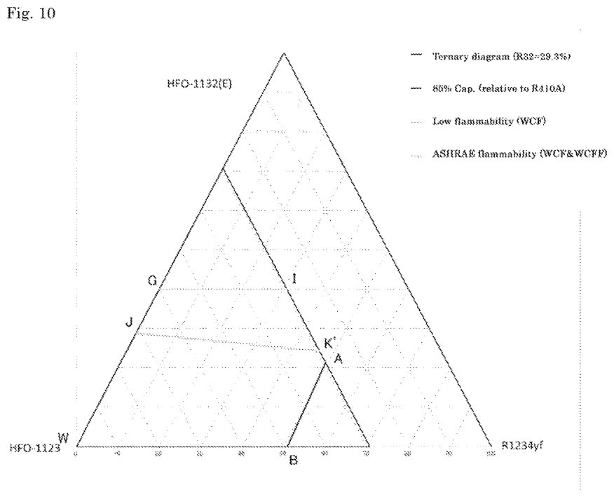

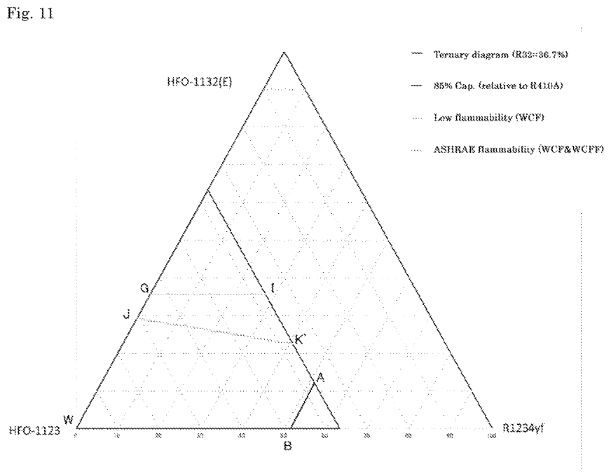

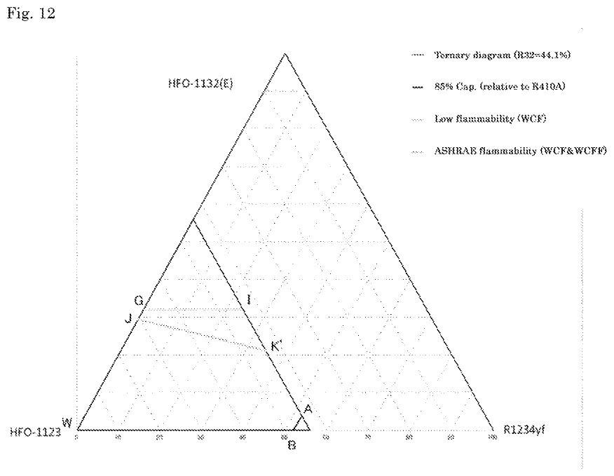

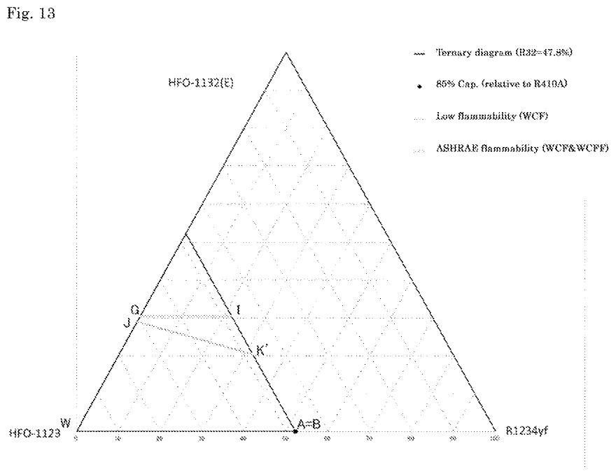

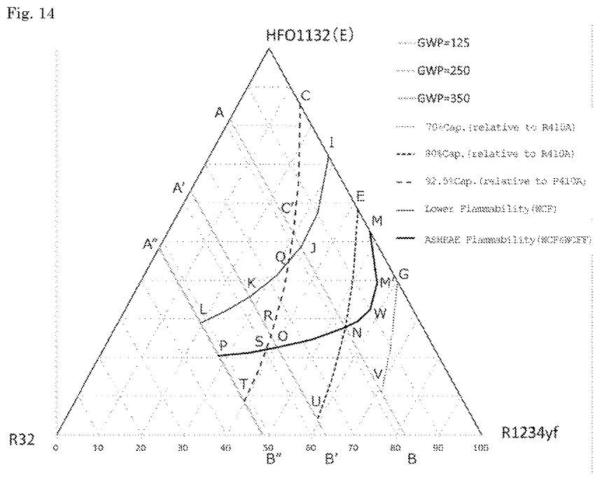

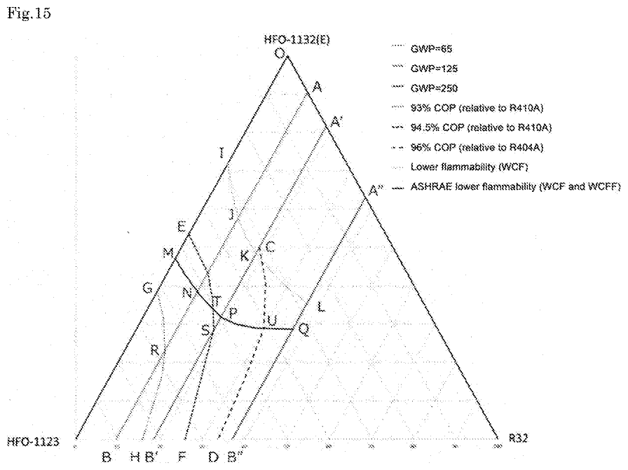

FIGS. 3 to 13 show compositions whose R32 content a (mass %) is 0 mass %, 7.1 mass %, 11.1 mass %, 14.5 mass %, 18.2 mass %, 21.9 mass %, 26.7 mass %, 29.3 mass %, 36.7 mass %, 44.1 mass %, and 47.8 mass %, respectively.
Points A, B, C, and D′ were obtained in the following manner according to approximate calculation.
Point A is a point where the content of HFO-1123 is 0 mass %, and a refrigerating capacity ratio of 85% relative to that of R410A is achieved. Three points corresponding to point A were obtained in each of the following five ranges by calculation, and their approximate expressions were obtained (Table 109).

TABLE 109

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 68.6 | 55.3 | 48.4 | 48.4 | 42.8 | 37 | 37 | 31.5 | 24.8 |
| HFO-1123 | 0 | 0 | 0 | 0 | 0 | 0 | 0 | 0 | 0 |
| R1234yf | 31.4 | 37.6 | 40.5 | 40.5 | 42.7 | 44.8 | 44.8 | 46.6 | 48.5 |

| | | | |
|---|---|---|---|
| R32 | a | a | a |
| HFO-1132(E) | 0.0134a² − 1.9681 a + 68.6 | 0.0112a² − 1.9337a + 68.484 | 0.0107a² − 1.9142a + 68.305 |
| Approximate | | | |
| expression | | | |
| HFO-1123 | 0 | 0 | 0 |
| Approximate | | | |
| expression | | | |
| R1234yf | −0.0134a² + 0.9681a + 31.4 | −0.0112a² + 0.9337a + 31.516 | −0.0107a² + 0.9142a + 31.695 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 21.3 | 12.1 | 12.1 | 3.8 | 0 |
| HFO-1123 | 0 | 0 | 0 | 0 | 0 | 0 |
| R1234yf | 48.5 | 49.4 | 51.2 | 51.2 | 52.1 | 52.2 |

| | | |
|---|---|---|
| R32 | a | a |
| HFO-1132(E) | 0.0103a² − 1.9225a + 68.793 | 0.0085a² − 1.8102a + 67.1 |
| Approximate | | |
| expression | | |
| HFO-1123 | 0 | 0 |
| Approximate | | |
| expression | | |
| R1234yf | −0.0103a² + 0.9225a + 31..207 | −0.0085a² + 0.8102a + 32.9 |
| Approximate | | |
| expression | | |

Point B is a point where the content of HFO-1132(E) is 0 mass %, and a refrigerating capacity ratio of 85% relative to that of R410A is achieved.
Three points corresponding to point B were obtained in each of the following five ranges by calculation, and their approximate expressions were obtained (Table 110).

TABLE 110

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 0 | 0 | 0 | 0 | 0 | 0 | 0 | 0 | 0 |
| HFO-1123 | 58.7 | 47.8 | 42.3 | 42.3 | 37.8 | 33.1 | 33.1 | 28.5 | 22.9 |
| R1234yf | 41.3 | 45.1 | 46.6 | 46.6 | 47.7 | 48.7 | 48.7 | 49.6 | 50.4 |

| | | | |
|---|---|---|---|
| R32 | a | a | a |
| HFO-1132(E) | 0 | 0 | 0 |
| Approximate | | | |
| expression | | | |
| HFO-1123 | 0.0144a² − 1.6377a + 58.7 | 0.0075a² − 1.5156a + 58.199 | 0.009a²−1.6045a + 59.318 |
| Approximate | | | |
| expression | | | |
| R1234yf | −0.0144a² + 0.6377a + 41.3 | −0.0075a² + 0.5156a + 41.801 | -0.009a² + 0.6045a + 40.682 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 0 | 0 | 0 | 0 | 0 | 0 |
| HFO-1123 | 22.9 | 19.9 | 11.7 | 11.8 | 3.9 | 0 |
| R1234yf | 50.4 | 50.8 | 51.6 | 51.5 | 52.0 | 52.2 |

| | | |
|---|---|---|
| R32 | a | a |
| HFO-1132(E) | 0 | 0 |
| Approximate | | |
| expression | | |
| HFO-1123 | 0.0046a² − 1.41a + 57.286 | 0.0012a² − 1.1659a + 52.95 |
| Approximate | | |
| expression | | |
| R1234yf | −0.0046a² + 0.41a + 42.714 | −0.0012a² + 0.1659a + 47.05 |
| Approximate | | |
| expression | | |

Point D′ is a point where the content of HFO-1132(E) is 0 mass %, and a COP ratio of 95.5% relative to that of R410A is achieved.
Three points corresponding to point D′ were obtained in each of the following by calculation, and their approximate expressions were obtained (Table 111).

TABLE 111

| Item | 11.1 ≥ R32 > 0 | | |
|---|---|---|---|
| R32 | 0 | 7.1 | 11.1 |
| HFO-1132(E) | 0 | 0 | 0 |
| HFO-1123 | 75.4 | 83.4 | 88.9 |
| R1234yf | 24.6 | 9.5 | 0 |

| | |
|---|---|
| R32 | a |
| HFO-1132(E) | 0 |
| Approximate expression | |
| HFO-1123 | 0.0224a² + 0.968a + 75.4 |
| Approximate expression | |
| R1234yf | −0.0224a² − 1.968a + 24.6 |
| Approximate expression | |

Point C is a point where the content of R1234yf is 0 mass %, and a COP ratio of 95.5% relative to that of R410A is achieved.
Three points corresponding to point C were obtained in each of the following by calculation, and their approximate expressions were obtained (Table 112).

TABLE 112

| Item | 11.1 ≥ R32 > 0 | | |
|---|---|---|---|
| R32 | 0 | 7.1 | 11.1 |
| HFO-1132(E) | 32.9 | 18.4 | 0 |
| HFO-1123 | 67.1 | 74.5 | 88.9 |
| R1234yf | 0 | 0 | 0 |

| | |
|---|---|
| R32 | a |
| HFO-1132(E) | −0.2304a² − 0.4062a + 32.9 |
| Approximate expression | |
| HFO-1123 | 0.2304a² − 0.5938a + 67.1 |
| Approximate expression | |
| R1234yf | 0 |
| Approximate expression | |

### (5-4) Refrigerant D

The refrigerant D according to the present disclosure is a mixed refrigerant comprising trans-1,2-difluoroethylene (HFO-1132(E)), difluoromethane (R32), and 2,3,3,3-tetrafluoro-1-propene (R1234yf).
The refrigerant D according to the present disclosure has various properties that are desirable as an R410A-alternative refrigerant; i.e., a refrigerating capacity equivalent to that of R410A, a sufficiently low GWP, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI);
the line segment U is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines. When the requirements above are satisfied, the refrigerant according to the present disclosure has a refrigerating capacity ratio of 80% or more relative to R410A, a GWP of 125 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines. When the requirements above are satisfied, the refrigerant according to the present disclosure has a refrigerating capacity ratio of 70% or more relative to R410A, a GWP of 125 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line. When the requirements above are satisfied, the refrigerant according to the present disclosure has a refrigerating capacity ratio of 80% or more relative to R410A, a GWP of 250 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line. When the requirements above are satisfied, the refrigerant according to the present disclosure has a refrigerating capacity ratio of 92.5% or more relative to R410A, a GWP of 350 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line. When the requirements above are satisfied, the refrigerant according to the present disclosure has a refrigerating capacity ratio of 92.5% or more relative to R410A, a GWP of 350 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ac, cf, fd, and da that connect the following 4 points:
   point a (71.1, 0.0, 28.9),
   point c (36.5, 18.2, 45.3),
   point f (47.6, 18.3, 34.1), and
   point d (72.0, 0.0, 28.0),
   or on these line segments;
the line segment ac is represented by coordinates (0.0181y²−2.2288y+71.096, y, −0.0181y²+1.2288y+28.904);
the line segment fd is represented by coordinates (0.02y²−1.7y+72, y, −0.02y²+0.7y+28); and
the line segments cf and da are straight lines. When the requirements above are satisfied, the refrigerant according to the present disclosure has a refrigerating capacity ratio of 85% or more relative to R410A, a GWP of 125 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ab, be, ed, and da that connect the following 4 points:
   point a (71.1, 0.0, 28.9),
   point b (42.6, 14.5, 42.9),
   point e (51.4, 14.6, 34.0), and
   point d (72.0, 0.0, 28.0),
   or on these line segments;
the line segment ab is represented by coordinates (0.0181y²−2.2288y+71.096, y, −0.0181y²+1.2288y+28.904);
the line segment ed is represented by coordinates (0.02y²−1.7y+72, y, −0.02y²+0.7y+28); and
the line segments be and da are straight lines. When the requirements above are satisfied, the refrigerant according to the present disclosure has a refrigerating capacity ratio of 85% or more relative to R410A, a GWP of 100 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gi, ij, and jg that connect the following 3 points:
   point g (77.5, 6.9, 15.6),
   point i (55.1, 18.3, 26.6), and
   point j (77.5. 18.4, 4.1),
   or on these line segments;
the line segment gi is represented by coordinates (0.02y²−2.4583y+93.396, y, −0.02y²+1.4583y+6.604); and
the line segments ij and jg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gh, hk, and kg that connect the following 3 points:
   point g (77.5, 6.9, 15.6),
   point h (61.8, 14.6, 23.6), and
   point k (77.5, 14.6, 7.9),
   or on these line segments;
the line segment gh is represented by coordinates (0.02y²−2.4583y+93.396, y, −0.02y²+1.4583y+6.604); and
the line segments hk and kg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure may further comprise other additional refrigerants in addition to HFO-1132(E), R32, and R1234yf, as long as the above properties and effects are not impaired. In this respect, the refrigerant according to the present disclosure preferably comprises HFO-1132(E), R32, and R1234yf in a total amount of 99.5 mass % or more, more preferably 99.75 mass % or more, and still more preferably 99.9 mass % or more based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant D)

The present disclosure is described in more detail below with reference to Examples of refrigerant D. However, the refrigerant D is not limited to the Examples.
The composition of each mixed refrigerant of HFO-1132(E), R32, and R1234yf was defined as WCF. A leak simulation was performed using the NIST Standard Reference Database REFLEAK Version 4.0 under the conditions of Equipment, Storage, Shipping, Leak, and Recharge according to the ASHRAE Standard 34-2013. The most flammable fraction was defined as WCFF.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC. Tables 113 to 115 show the results.

TABLE 113

| | | | Comparative | | Example | | Example | | Example |
|---|---|---|---|---|---|---|---|---|---|
| | | | Example 13 | Example | 12 | Example | 14 | Example | 16 |
| Item | | Unit | I | 11 | J | 13 | K | 15 | L |
| WCF | HFO-1132 | Mass | 72 | 57.2 | 48.5 | 41.2 | 35.6 | 32 | 28.9 |
| | (E) | % | | | | | | | |
| | R32 | Mass | 0 | 10 | 18.3 | 27.6 | 36.8 | 44.2 | 51.7 |
| | | % | | | | | | | |
| | R1234yf | Mass | 28 | 32.8 | 33.2 | 31.2 | 27.6 | 23.8 | 19.4 |
| | | % | | | | | | | |

| | | | | | | | | |
|---|---|---|---|---|---|---|---|---|
| Burning Velocity | cm/s | 10 | 10 | 10 | 10 | 10 | 10 | 10 |
| (WCF) | | | | | | | | |

TABLE 114

| | | | Comparative | | Example | | Example | |
|---|---|---|---|---|---|---|---|---|
| | | | Example 14 | Example | 19 | Example | 21 | Example |
| Item | | Unit | M | 18 | W | 20 | N | 22 |
| WCF | HFO-1132 | Mass | 52.6 | 39.2 | 32.4 | 29.3 | 27.7 | 24.6 |
| | (E) | % | | | | | | |
| | R32 | Mass | 0.0 | 5.0 | 10.0 | 14.5 | 18.2 | 27.6 |
| | | % | | | | | | |
| | R1234yf | Mass | 47.4 | 55.8 | 57.6 | 56.2 | 54.1 | 47.8 |
| | | % | | | | | | |
| Leak condition that | | | Storage/ | Storage/ | Storage/ | Storage/ | Storage/ | Storage/ |
| results in WCFF | | | Shipping | Shipping | Shipping | Shipping | Shipping | Shipping |
| | | | −40° C., | −40° C., | −40° C., | −40° C., | −40° C., | −40° C., |
| | | | 0% | 0% | 0% | 0% | 0% | 0% |
| | | | release, | release, | release, | release, | release, | release, |
| | | | gas | gas | gas | gas | gas | gas |
| | | | phase | phase | phase | phase | phase | phase |
| | | | side | side | side | side | side | side |
| WCF | HF01132 | Mass | 72.0 | 57.8 | 48.7 | 43.6 | 40.6 | 34.9 |
| | (E) | % | | | | | | |
| | R32 | Mass | 0.0 | 9.5 | 17.9 | 24.2 | 28.7 | 38.1 |
| | | % | | | | | | |
| | R1234yf | Mass | 28.0 | 32.7 | 33.4 | 32.2 | 30.7 | 27.0 |
| | | % | | | | | | |

| | | | | | | | |
|---|---|---|---|---|---|---|---|
| Burning velocity | cm/s | 8 or less | 8 or less | 8 or less | 8 or less | 8 or less | 8 or less |
| (WCF) | | | | | | | |
| Burning velocity | cm/s | 10 | 10 | 10 | 10 | 10 | 10 |
| (WCFF) | | | | | | | |

TABLE 115

| | | | Example 23 | | Example 25 |
|---|---|---|---|---|---|
| Item | | Unit | O | Example 24 | P |
| WCF | HFO-1132 (E) | Mass % | 22.6 | 21.2 | 20.5 |
| | HFO-1123 | Mass % | 36.8 | 44.2 | 51.7 |
| | R1234yf | Mass % | 40.6 | 34.6 | 27.8 |
| Leak condition that results in WCFF | | | Storage, | Storage, | Storage, |
| | | | Shipping, −40° C., | Shipping, −40° C., | Shipping, −40° C., |
| | | | 0% release, on | 0% release, on | 0% release, on |
| | | | the gas phase side | the gas phase side | the gas phase side |
| WCFF | HFO-1132 (E) | Mass % | 31.4 | 29.2 | 27.1 |
| | HFO-1123 | Mass % | 45.7 | 51.1 | 56.4 |
| | R1234yf | Mass % | 23.0 | 19.7 | 16.5 |

| | | | | |
|---|---|---|---|---|
| Burning Velocity (WCF) | cm/s | 8 or less | 8 or less | 8 or less |
| Burning Velocity (WCFF) | cm/s | 10 | 10 | 10 |

The results indicate that under the condition that the mass % of HFO-1132(E), R32, and R1234yf based on their sum is respectively represented by x, y, and z, when coordinates (x,y,z) in the ternary composition diagram shown in FIG. 14 in which the sum of HFO-1132(E), R32, and R1234yf is 100 mass % are on the line segment that connects point I, point J, point K, and point L, or below these line segments, the refrigerant has a WCF lower flammability.
The results also indicate that when coordinates (x,y,z) in the ternary composition diagram shown in FIG. 14 are on the line segments that connect point M, point M′, point W, point J, point N, and point P, or below these line segments, the refrigerant has an ASHRAE lower flammability.
Mixed refrigerants were prepared by mixing HFO-1132(E), R32, and R1234yf in amounts (mass %) shown in Tables 116 to 144 based on the sum of HFO-1132(E), R32, and R1234yf. The coefficient of performance (COP) ratio and the refrigerating capacity ratio relative to R410 of the mixed refrigerants shown in Tables 116 to 144 were determined. The conditions for calculation were as described below.
Evaporating temperature: 5° C.
Condensation temperature: 45° C.
Degree of superheating: 5 K
Degree of subcooling: 5 K
Compressor efficiency: 70%
Tables 116 to 144 show these values together with the GWP of each mixed refrigerant.

TABLE 116

| | | | Comparative | Comparative | Comparative | Comparative | Comparative | Comparative |
|---|---|---|---|---|---|---|---|---|
| | | Comparative | Example 2 | Example 3 | Example 4 | Example 5 | Example 6 | Example 7 |
| Item | Unit | Example 1 | A | B | A′ | B′ | A″ | B″ |
| HFO-1132 | Mass | R410A | 81.6 | 0.0 | 63.1 | 0.0 | 48.2 | 0.0 |
| (E) | % | | | | | | | |
| R32 | Mass | | 18.4 | 18.1 | 36.9 | 36.7 | 51.8 | 51.5 |
| | % | | | | | | | |
| R1234yf | Mass | | 0.0 | 81.9 | 0.0 | 63.3 | 0.0 | 48.5 |
| | % | | | | | | | |
| GWP | — | 2088 | 125 | 125 | 250 | 250 | 350 | 350 |
| COP Ratio | % | 100 | 98.7 | 103.6 | 98.7 | 102.3 | 99.2 | 102.2 |
| | (relative | | | | | | | |
| | to | | | | | | | |
| | R410A) | | | | | | | |
| Refrigerating | % | 100 | 105.3 | 62.5 | 109.9 | 77.5 | 112.1 | 87.3 |
| Capacity Ratio | (relative | | | | | | | |
| | to | | | | | | | |
| | R410A) | | | | | | | |

TABLE 117

| | | Comparative | | Comparative | | Example | | Example |
|---|---|---|---|---|---|---|---|---|
| | | Example 8 | Comparative | Example 10 | Example | 2 | Example | 4 |
| Item | Unit | C | Example 9 | C′ | 1 | R | 3 | T |
| HFO-1132(E) | Mass | 85.5 | 66.1 | 52.1 | 37.8 | 25.5 | 16.6 | 8.6 |
| | % | | | | | | | |
| R32 | Mass | 0.0 | 10.0 | 18.2 | 27.6 | 36.8 | 44.2 | 51.6 |
| | % | | | | | | | |
| R1234yf | Mass | 14.5 | 23.9 | 29.7 | 34.6 | 37.7 | 39.2 | 39.8 |
| | % | | | | | | | |
| GWP | — | 1 | 69 | 125 | 188 | 250 | 300 | 350 |
| COP Ratio | % | 99.8 | 99.3 | 99.3 | 99.6 | 100.2 | 100.8 | 101.4 |
| | (relative | | | | | | | |
| | to | | | | | | | |
| | R410A) | | | | | | | |
| Refrigerating | % | 92.5 | 92.5 | 92.5 | 92.5 | 92.5 | 92.5 | 92.5 |
| Capacity Ratio | (relative | | | | | | | |
| | to | | | | | | | |
| | R410A) | | | | | | | |

TABLE 118

| | | Comparative | | Example | | Example | Comparative | | Example |
|---|---|---|---|---|---|---|---|---|---|
| | | Example 11 | Example | 6 | Example | 8 | Example 12 | Example | 10 |
| Item | Unit | E | 5 | N | 7 | U | G | 9 | V |
| HFO-1132(E) | Mass | 58.3 | 40.5 | 27.7 | 14.9 | 3.9 | 39.6 | 22.8 | 11.0 |
| | % | | | | | | | | |
| R32 | Mass | 0.0 | 10.0 | 18.2 | 27.6 | 36.7 | 0.0 | 10.0 | 18.1 |
| | % | | | | | | | | |
| R1234yf | Mass | 41.7 | 49.5 | 54.1 | 57.5 | 59.4 | 60.4 | 67.2 | 70.9 |
| | % | | | | | | | | |
| GWP | — | 2 | 70 | 125 | 189 | 250 | 3 | 70 | 125 |
| COP Ratio | % | 100.3 | 100.3 | 100.7 | 101.2 | 101.9 | 101.4 | 101.8 | 102.3 |
| | (relative | | | | | | | | |
| | to | | | | | | | | |
| | R410A) | | | | | | | | |
| Refrigerating | % | 80.0 | 80.0 | 80.0 | 80.0 | 80.0 | 70.0 | 70.0 | 70.0 |
| Capacity Ratio | (relative | | | | | | | | |
| | to | | | | | | | | |
| | R410A) | | | | | | | | |

TABLE 119

| | | Comparative | | | | | | | |
|---|---|---|---|---|---|---|---|---|---|
| | | Example 13 | | Example 12 | | Example 14 | | Example 16 | Example 17 |
| Item | Unit | I | Example 11 | J | Example 13 | K | Example 15 | L | Q |
| HFO-1132 (E) | Mass % | 72.0 | 57.2 | 48.5 | 41.2 | 35.6 | 32.0 | 28.9 | 44.6 |
| R32 | Mass % | 0.0 | 10.0 | 18.3 | 27.6 | 36.8 | 44.2 | 51.7 | 23.0 |
| R1234yf | Mass % | 28.0 | 32.8 | 33.2 | 31.2 | 27.6 | 23.8 | 19.4 | 32.4 |
| GWP | — | 2 | 69 | 125 | 188 | 250 | 300 | 350 | 157 |
| COP Ratio | % (relative to | 99.9 | 99.5 | 99.4 | 99.5 | 99.6 | 99.8 | 100.1 | 99.4 |
| | R410A) | | | | | | | | |
| Refrigerating | % (relative to | 86.6 | 88.4 | 90.9 | 94.2 | 97.7 | 100.5 | 103.3 | 92.5 |
| Capacity | R410A) | | | | | | | | |
| Ratio | | | | | | | | | |

TABLE 120

| | | Comparative | | | | | |
|---|---|---|---|---|---|---|---|
| | | Example 14 | | Example 19 | | Example 21 | |
| Item | Unit | M | Example 18 | W | Example 20 | N | Example 22 |
| HFO-1132 (E) | Mass % | 52.6 | 39.2 | 32.4 | 29.3 | 27.7 | 24.5 |
| R32 | Mass % | 0.0 | 5.0 | 10.0 | 14.5 | 18.2 | 27.6 |
| R1234yf | Mass % | 47.4 | 55.8 | 57.6 | 56.2 | 54.1 | 47.9 |
| GWP | — | 2 | 36 | 70 | 100 | 125 | 188 |
| COP Ratio | % (relative to | 100.5 | 100.9 | 100.9 | 100.8 | 100.7 | 100.4 |
| | R410A) | | | | | | |
| Refrigerating Capacity | % (relative to | 77.1 | 74.8 | 75.6 | 77.8 | 80.0 | 85.5 |
| Ratio | R410A) | | | | | | |

TABLE 121

| | | Exam- | | Exam- | Exam- |
|---|---|---|---|---|---|
| | | ple 23 | Exam- | ple 25 | ple 26 |
| Item | Unit | O | ple 24 | P | S |
| HFO-1132(E) | Mass % | 22.6 | 21.2 | 20.5 | 21.9 |
| R32 | Mass % | 36.8 | 44.2 | 51.7 | 39.7 |
| R1234yf | Mass % | 40.6 | 34.6 | 27.8 | 38.4 |
| GWP | — | 250 | 300 | 350 | 270 |
| COP Ratio | % (relative | 100.4 | 100.5 | 100.6 | 100.4 |
| | to R410A) | | | | |
| Refrigerating | % (relative | 91.0 | 95.0 | 99.1 | 92.5 |
| Capacity Ratio | to R410A) | | | | |

TABLE 122

| | | Comparative | Comparative | Comparative | Comparative | | | Comparative | Comparative |
|---|---|---|---|---|---|---|---|---|---|
| Item | Unit | Example 15 | Example 16 | Example 17 | Example 18 | Example 27 | Example 28 | Example 19 | Example 20 |
| HFO-1132 (E) | Mass % | 10.0 | 20.0 | 30.0 | 40.0 | 50.0 | 60.0 | 70.0 | 80.0 |
| R32 | Mass % | 5.0 | 5.0 | 5.0 | 5.0 | 5.0 | 5.0 | 5.0 | 5.0 |
| R1234yf | Mass % | 85.0 | 75.0 | 65.0 | 55.0 | 45.0 | 35.0 | 25.0 | 15.0 |
| GWP | — | 37 | 37 | 37 | 36 | 36 | 36 | 35 | 35 |
| COP Ratio | % (relative to | 103.4 | 102.6 | 101.6 | 100.8 | 100.2 | 99.8 | 99.6 | 99.4 |
| | R410A) | | | | | | | | |
| Refrigerating | % (relative to | 56.4 | 63.3 | 69.5 | 75.2 | 80.5 | 85.4 | 90.1 | 94.4 |
| Capacity | R410A) | | | | | | | | |
| Ratio | | | | | | | | | |

TABLE 123

| | | Comparative | Comparative | | Comparative | | Comparative | Comparative | Comparative |
|---|---|---|---|---|---|---|---|---|---|
| | | Example 21 | Example 22 | Example 29 | Example 23 | Example 30 | Example 24 | Example 25 | Example 26 |
| HFO-1132 (E) | Mass % | 10.0 | 20.0 | 30.0 | 40.0 | 50.0 | 60.0 | 70.0 | 80.0 |
| R32 | Mass % | 10.0 | 10.0 | 10.0 | 10.0 | 10.0 | 10.0 | 10.0 | 10.0 |
| R1234yf | Mass % | 80.0 | 70.0 | 60.0 | 50.0 | 40.0 | 30.0 | 20.0 | 10.0 |
| GWP | — | 71 | 71 | 70 | 70 | 70 | 69 | 69 | 69 |
| COP Ratio | % (relative to | 103.1 | 102.1 | 101.1 | 100.4 | 99.8 | 99.5 | 99.2 | 99.1 |
| | R410A) | | | | | | | | |
| Refrigerating | % (relative to | 61.8 | 68.3 | 74.3 | 79.7 | 84.9 | 89.7 | 94.2 | 98.4 |
| Capacity | R410A) | | | | | | | | |
| Ratio | | | | | | | | | |

TABLE 124

| | | Comparative | | Comparative | | | Comparative | Comparative | Comparative |
|---|---|---|---|---|---|---|---|---|---|
| Item | Unit | Example 27 | Example 31 | Example 28 | Example 32 | Example 33 | Example 29 | Example 30 | Example 31 |
| HFO-1132 (E) | Mass % | 10.0 | 20.0 | 30.0 | 40.0 | 50.0 | 60.0 | 70.0 | 80.0 |
| R32 | Mass % | 15.0 | 15.0 | 15.0 | 15.0 | 15.0 | 15.0 | 15.0 | 15.0 |
| R1234yf | Mass % | 75.0 | 65.0 | 55.0 | 45.0 | 35.0 | 25.0 | 15.0 | 5.0 |
| GWP | — | 104 | 104 | 104 | 103 | 103 | 103 | 103 | 102 |
| COP Ratio | % (relative to | 102.7 | 101.6 | 100.7 | 100.0 | 99.5 | 99.2 | 99.0 | 98.9 |
| | R410A) | | | | | | | | |
| Refrigerating | % (relative to | 66.6 | 72.9 | 78.6 | 84.0 | 89.0 | 93.7 | 98.1 | 102.2 |
| Capacity | R410A) | | | | | | | | |
| Ratio | | | | | | | | | |

TABLE 125

| | | Comparative | Comparative | Comparative | Comparative | Comparative | Comparative | Comparative | Comparative |
|---|---|---|---|---|---|---|---|---|---|
| Item | Unit | Example 32 | Example 33 | Example 34 | Example 35 | Example 36 | Example 37 | Example 38 | Example 39 |
| HFO-1132 (E) | Mass % | 10.0 | 20.0 | 30.0 | 40.0 | 50.0 | 60.0 | 70.0 | 10.0 |
| R32 | Mass % | 20.0 | 20.0 | 20.0 | 20.0 | 20.0 | 20.0 | 20.0 | 25.0 |
| R1234yf | Mass % | 70.0 | 60.0 | 50.0 | 40.0 | 30.0 | 20.0 | 10.0 | 65.0 |
| GWP | — | 138 | 138 | 137 | 137 | 137 | 136 | 136 | 171 |
| COP Ratio | % (relative to | 102.3 | 101.2 | 100.4 | 99.7 | 99.3 | 99.0 | 98.8 | 101.9 |
| | R410A) | | | | | | | | |
| Refrigerating | % (relative to | 71.0 | 77.1 | 82.7 | 88.0 | 92.9 | 97.5 | 101.7 | 75.0 |
| Capacity | R410A) | | | | | | | | |
| Ratio | | | | | | | | | |

TABLE 126

| | | | Comparative | Comparative | Comparative | Comparative | Comparative | Comparative | |
|---|---|---|---|---|---|---|---|---|---|
| Item | Unit | Example 34 | Example 40 | Example 41 | Example 42 | Example 43 | Example 44 | Example 45 | Example 35 |
| HFO-1132 (E) | Mass % | 20.0 | 30.0 | 40.0 | 50.0 | 60.0 | 70.0 | 10.0 | 20.0 |
| R32 | Mass % | 25.0 | 25.0 | 25.0 | 25.0 | 25.0 | 25.0 | 30.0 | 30.0 |
| R1234yf | Mass % | 55.0 | 45.0 | 35.0 | 25.0 | 15.0 | 5.0 | 60.0 | 50.0 |
| GWP | — | 171 | 171 | 171 | 170 | 170 | 170 | 205 | 205 |
| COP Ratio | % (relative to | 100.9 | 100.1 | 99.6 | 99.2 | 98.9 | 98.7 | 101.6 | 100.7 |
| | R410A) | | | | | | | | |
| Refrigerating | % (relative to | 81.0 | 86.6 | 91.7 | 96.5 | 101.0 | 105.2 | 78.9 | 84.8 |
| Capacity | R410A) | | | | | | | | |
| Ratio | | | | | | | | | |

TABLE 127

| | | Comparative | Comparative | Comparative | Comparative | | | | Comparative |
|---|---|---|---|---|---|---|---|---|---|
| Item | Unit | Example 46 | Example 47 | Example 48 | Example 49 | Example 36 | Example 37 | Example 38 | Example 50 |
| HFO-1132 (E) | Mass % | 30.0 | 40.0 | 50.0 | 60.0 | 10.0 | 20.0 | 30.0 | 40.0 |
| R32 | Mass % | 30.0 | 30.0 | 30.0 | 30.0 | 35.0 | 35.0 | 35.0 | 35.0 |
| R1234yf | Mass % | 40.0 | 30.0 | 20.0 | 10.0 | 55.0 | 45.0 | 35.0 | 25.0 |
| GWP | — | 204 | 204 | 204 | 204 | 239 | 238 | 238 | 238 |
| COP Ratio | % (relative to | 100.0 | 99.5 | 99.1 | 98.8 | 101.4 | 100.6 | 99.9 | 99.4 |
| | R410A) | | | | | | | | |
| Refrigerating | % (relative to | 90.2 | 95.3 | 100.0 | 104.4 | 82.5 | 88.3 | 93.7 | 98.6 |
| Capacity | R410A) | | | | | | | | |
| Ratio | | | | | | | | | |

TABLE 128

| | | Comparative | Comparative | Comparative | Comparative | | Comparative | Comparative | Comparative |
|---|---|---|---|---|---|---|---|---|---|
| Item | Unit | Example 51 | Example 52 | Example 53 | Example 54 | Example 39 | Example 55 | Example 56 | Example 57 |
| HFO-1132 (E) | Mass % | 50.0 | 60.0 | 10.0 | 20.0 | 30.0 | 40.0 | 50.0 | 10.0 |
| R32 | Mass % | 35.0 | 35.0 | 40.0 | 40.0 | 40.0 | 40.0 | 40.0 | 45.0 |
| R1234yf | Mass % | 15.0 | 5.0 | 50.0 | 40.0 | 30.0 | 20.0 | 10.0 | 45.0 |
| GWP | — | 237 | 237 | 272 | 272 | 272 | 271 | 271 | 306 |
| COP Ratio | % (relative to | 99.0 | 98.8 | 101.3 | 100.6 | 99.9 | 99.4 | 99.0 | 101.3 |
| | R410A) | | | | | | | | |
| Refrigerating | % (relative to | 103.2 | 107.5 | 86.0 | 91.7 | 96.9 | 101.8 | 106.3 | 89.3 |
| Capacity | R410A) | | | | | | | | |
| Ratio | | | | | | | | | |

TABLE 129

| | | | | Comparative | Comparative | Comparative | | Comparative | Comparative |
|---|---|---|---|---|---|---|---|---|---|
| Item | Unit | Example 40 | Example 41 | Example 58 | Example 59 | Example 60 | Example 42 | Example 61 | Example 62 |
| HFO-1132 (E) | Mass % | 20.0 | 30.0 | 40.0 | 50.0 | 10.0 | 20.0 | 30.0 | 40.0 |
| R32 | Mass % | 45.0 | 45.0 | 45.0 | 45.0 | 50.0 | 50.0 | 50.0 | 50.0 |
| R1234yf | Mass % | 35.0 | 25.0 | 15.0 | 5.0 | 40.0 | 30.0 | 20.0 | 10.0 |
| GWP | — | 305 | 305 | 305 | 304 | 339 | 339 | 339 | 338 |
| COP Ratio | % (relative to | 100.6 | 100.0 | 99.5 | 99.1 | 101.3 | 100.6 | 100.0 | 99.5 |
| | R410A) | | | | | | | | |
| Refrigerating | % (relative to | 94.9 | 100.0 | 104.7 | 109.2 | 92.4 | 97.8 | 102.9 | 107.5 |
| Capacity | R410A) | | | | | | | | |
| Ratio | | | | | | | | | |

TABLE 130

| | | Comparative | Comparative | Comparative | Comparative | | | | |
|---|---|---|---|---|---|---|---|---|---|
| Item | Unit | Example 63 | Example 64 | Example 65 | Example 66 | Example 43 | Example 44 | Example 45 | Example 46 |
| HFO-1132 (E) | Mass % | 10.0 | 20.0 | 30.0 | 40.0 | 56.0 | 59.0 | 62.0 | 65.0 |
| R32 | Mass % | 55.0 | 55.0 | 55.0 | 55.0 | 3.0 | 3.0 | 3.0 | 3.0 |
| R1234yf | Mass % | 35.0 | 25.0 | 15.0 | 5.0 | 41.0 | 38.0 | 35.0 | 32.0 |
| GWP | — | 373 | 372 | 372 | 372 | 22 | 22 | 22 | 22 |
| COP Ratio | % (relative to | 101.4 | 100.7 | 100.1 | 99.6 | 100.1 | 100.0 | 99.9 | 99.8 |
| | R410A) | | | | | | | | |
| Refrigerating | % (relative to | 95.3 | 100.6 | 105.6 | 110.2 | 81.7 | 83.2 | 84.6 | 86.0 |
| Capacity | R410A) | | | | | | | | |
| Ratio | | | | | | | | | |

TABLE 131

| Item | Unit | Example 47 | Example 48 | Example 49 | Example 50 | Example 51 | Example 52 | Example 53 | Example 54 |
|---|---|---|---|---|---|---|---|---|---|
| HFO-1132 (E) | Mass % | 49.0 | 52.0 | 55.0 | 58.0 | 61.0 | 43.0 | 46.0 | 49.0 |
| R32 | Mass % | 6.0 | 6.0 | 6.0 | 6.0 | 6.0 | 9.0 | 9.0 | 9.0 |
| R1234yf | Mass % | 45.0 | 42.0 | 39.0 | 36.0 | 33.0 | 48.0 | 45.0 | 42.0 |
| GWP | — | 43 | 43 | 43 | 43 | 42 | 63 | 63 | 63 |
| COP Ratio | % (relative to | 100.2 | 100.0 | 99.9 | 99.8 | 99.7 | 100.3 | 100.1 | 99.9 |
| | R410A) | | | | | | | | |
| Refrigerating | % (relative to | 80.9 | 82.4 | 83.9 | 85.4 | 86.8 | 80.4 | 82.0 | 83.5 |
| Capacity | R410A) | | | | | | | | |
| Ratio | | | | | | | | | |

TABLE 132

| Item | Unit | Example 55 | Example 56 | Example 57 | Example 58 | Example 59 | Example 60 | Example 61 | Example 62 |
|---|---|---|---|---|---|---|---|---|---|
| HFO-1132 (E) | Mass % | 52.0 | 55.0 | 58.0 | 38.0 | 41.0 | 44.0 | 47.0 | 50.0 |
| R32 | Mass % | 9.0 | 9.0 | 9.0 | 12.0 | 12.0 | 12.0 | 12.0 | 12.0 |
| R1234yf | Mass % | 39.0 | 36.0 | 33.0 | 50.0 | 47.0 | 44.0 | 41.0 | 38.0 |
| GWP | — | 63 | 63 | 63 | 83 | 83 | 83 | 83 | 83 |
| COP Ratio | % (relative to | 99.8 | 99.7 | 99.6 | 100.3 | 100.1 | 100.0 | 99.8 | 99.7 |
| | R410A) | | | | | | | | |
| Refrigerating | % (relative to | 85.0 | 86.5 | 87.9 | 80.4 | 82.0 | 83.5 | 85.1 | 86.6 |
| Capacity | R410A) | | | | | | | | |
| Ratio | | | | | | | | | |

TABLE 133

| Item | Unit | Example 63 | Example 64 | Example 65 | Example 66 | Example 67 | Example 68 | Example 69 | Example 70 |
|---|---|---|---|---|---|---|---|---|---|
| HFO-1132 (E) | Mass % | 53.0 | 33.0 | 36.0 | 39.0 | 42.0 | 45.0 | 48.0 | 51.0 |
| R32 | Mass % | 12.0 | 15.0 | 15.0 | 15.0 | 15.0 | 15.0 | 15.0 | 15.0 |
| R1234yf | Mass % | 35.0 | 52.0 | 49.0 | 46.0 | 43.0 | 40.0 | 37.0 | 34.0 |
| GWP | — | 83 | 104 | 104 | 103 | 103 | 103 | 103 | 103 |
| COP Ratio | % (relative to | 99.6 | 100.5 | 100.3 | 100.1 | 99.9 | 99.7 | 99.6 | 99.5 |
| | R410A) | | | | | | | | |
| Refrigerating | % (relative to | 88.0 | 80.3 | 81.9 | 83.5 | 85.0 | 86.5 | 88.0 | 89.5 |
| Capacity | R410A) | | | | | | | | |
| Ratio | | | | | | | | | |

TABLE 134

| Item | Unit | Example 71 | Example 72 | Example 73 | Example 74 | Example 75 | Example 76 | Example 77 | Example 78 |
|---|---|---|---|---|---|---|---|---|---|
| HFO-1132 (E) | Mass % | 29.0 | 32.0 | 35.0 | 38.0 | 41.0 | 44.0 | 47.0 | 36.0 |
| R32 | Mass % | 18.0 | 18.0 | 18.0 | 18.0 | 18.0 | 18.0 | 18.0 | 3.0 |
| R1234yf | Mass % | 53.0 | 50.0 | 47.0 | 44.0 | 41.0 | 38.0 | 35.0 | 61.0 |
| GWP | — | 124 | 124 | 124 | 124 | 124 | 123 | 123 | 23 |
| COP Ratio | % (relative to | 100.6 | 100.3 | 100.1 | 99.9 | 99.8 | 99.6 | 99.5 | 101.3 |
| | R410A) | | | | | | | | |
| Refrigerating | % (relative to | 80.6 | 82.2 | 83.8 | 85.4 | 86.9 | 88.4 | 89.9 | 71.0 |
| Capacity | R410A) | | | | | | | | |
| Ratio | | | | | | | | | |

TABLE 135

| | | Example | Example | Example | Example | Example | Example | Example | Example |
|---|---|---|---|---|---|---|---|---|---|
| Item | Unit | 79 | 80 | 81 | 82 | 83 | 84 | 85 | 86 |
| HFO-1132(E) | Mass % | 39.0 | 42.0 | 30.0 | 33.0 | 36.0 | 26.0 | 29.0 | 32.0 |
| R32 | Mass % | 3.0 | 3.0 | 6.0 | 6.0 | 6.0 | 9.0 | 9.0 | 9.0 |
| R1234yf | Mass % | 58.0 | 55.0 | 64.0 | 61.0 | 58.0 | 65.0 | 62.0 | 59.0 |
| GWP | — | 23 | 23 | 43 | 43 | 43 | 64 | 64 | 63 |
| COP Ratio | % (relative to | 101.1 | 100.9 | 101.5 | 101.3 | 101.0 | 101.6 | 101.3 | 101.1 |
| | R410A) | | | | | | | | |
| Refrigerating | % (relative to | 72.7 | 74.4 | 70.5 | 72.2 | 73.9 | 71.0 | 72.8 | 74.5 |
| Capacity Ratio | R410A) | | | | | | | | |

TABLE 136

| | | Example | Example | Example | Example | Example | Example | Example | Example |
|---|---|---|---|---|---|---|---|---|---|
| Item | Unit | 87 | 88 | 89 | 90 | 91 | 92 | 93 | 94 |
| HFO-1132(E) | Mass % | 21.0 | 24.0 | 27.0 | 30.0 | 16.0 | 19.0 | 22.0 | 25.0 |
| R32 | Mass % | 12.0 | 12.0 | 12.0 | 12.0 | 15.0 | 15.0 | 15.0 | 15.0 |
| R1234yf | Mass % | 67.0 | 64.0 | 61.0 | 58.0 | 69.0 | 66.0 | 63.0 | 60.0 |
| GWP | — | 84 | 84 | 84 | 84 | 104 | 104 | 104 | 104 |
| COP Ratio | % (relative to | 101.8 | 101.5 | 101.2 | 101.0 | 102.1 | 101.8 | 101.4 | 101.2 |
| | R410A) | | | | | | | | |
| Refrigerating | % (relative to | 70.8 | 72.6 | 74.3 | 76.0 | 70.4 | 72.3 | 74.0 | 75.8 |
| Capacity Ratio | R410A) | | | | | | | | |

TABLE 137

| | | Example | Example | Example | Example | Example | Example | Example | Example |
|---|---|---|---|---|---|---|---|---|---|
| Item | Unit | 95 | 96 | 97 | 98 | 99 | 100 | 101 | 102 |
| HFO-1132 (E) | Mass % | 28.0 | 12.0 | 15.0 | 18.0 | 21.0 | 24.0 | 27.0 | 25.0 |
| R32 | Mass % | 15.0 | 18.0 | 18.0 | 18.0 | 18.0 | 18.0 | 18.0 | 21.0 |
| R1234yf | Mass % | 57.0 | 70.0 | 67.0 | 64.0 | 61.0 | 58.0 | 55.0 | 54.0 |
| GWP | — | 104 | 124 | 124 | 124 | 124 | 124 | 124 | 144 |
| COP Ratio | % (relative to | 100.9 | 102.2 | 101.9 | 101.6 | 101.3 | 101.0 | 100.7 | 100.7 |
| | R410A) | | | | | | | | |
| Refrigerating | % (relative to | 77.5 | 70.5 | 72.4 | 74.2 | 76.0 | 77.7 | 79.4 | 80.7 |
| Capacity Ratio | R410A) | | | | | | | | |

TABLE 138

| | | Example | Example | Example | Example | Example | Example | Example | Example |
|---|---|---|---|---|---|---|---|---|---|
| Item | Unit | 103 | 104 | 105 | 106 | 107 | 108 | 109 | 110 |
| HFO-1132 (E) | Mass % | 21.0 | 24.0 | 17.0 | 20.0 | 23.0 | 13.0 | 16.0 | 19.0 |
| R32 | Mass % | 24.0 | 24.0 | 27.0 | 27.0 | 27.0 | 30.0 | 30.0 | 30.0 |
| R1234yf | Mass % | 55.0 | 52.0 | 56.0 | 53.0 | 50.0 | 57.0 | 54.0 | 51.0 |
| GWP | — | 164 | 164 | 185 | 185 | 184 | 205 | 205 | 205 |
| COP Ratio | % (relative to | 100.9 | 100.6 | 101.1 | 100.8 | 100.6 | 101.3 | 101.0 | 100.8 |
| | R410A) | | | | | | | | |
| Refrigerating | % (relative to | 80.8 | 82.5 | 80.8 | 82.5 | 84.2 | 80.7 | 82.5 | 84.2 |
| Capacity Ratio | R410A) | | | | | | | | |

TABLE 139

| | | Example | Example | Example | Example | Example | Example | Example | Example |
|---|---|---|---|---|---|---|---|---|---|
| Item | Unit | 111 | 112 | 113 | 114 | 115 | 116 | 117 | 118 |
| HFO-1132(E) | Mass % | 22.0 | 9.0 | 12.0 | 15.0 | 18.0 | 21.0 | 8.0 | 12.0 |
| R32 | Mass % | 30.0 | 33.0 | 33.0 | 33.0 | 33.0 | 33.0 | 36.0 | 36.0 |
| R1234yf | Mass % | 48.0 | 58.0 | 55.0 | 52.0 | 49.0 | 46.0 | 56.0 | 52.0 |
| GWP | — | 205 | 225 | 225 | 225 | 225 | 225 | 245 | 245 |
| COP Ratio | % (relative to | 100.5 | 101.6 | 101.3 | 101.0 | 100.8 | 100.5 | 101.6 | 101.2 |
| | R410A) | | | | | | | | |
| Refrigerating | % (relative to | 85.9 | 80.5 | 82.3 | 84.1 | 85.8 | 87.5 | 82.0 | 84.4 |
| Capacity Ratio | R410A) | | | | | | | | |

TABLE 140

| | | Example | Example | Example | Example | Example | Example | Example | Example |
|---|---|---|---|---|---|---|---|---|---|
| Item | Unit | 119 | 120 | 121 | 122 | 123 | 124 | 125 | 126 |
| HFO-1132(E) | Mass % | 15.0 | 18.0 | 21.0 | 42.0 | 39.0 | 34.0 | 37.0 | 30.0 |
| R32 | Mass % | 36.0 | 36.0 | 36.0 | 25.0 | 28.0 | 31.0 | 31.0 | 34.0 |
| R1234yf | Mass % | 49.0 | 46.0 | 43.0 | 33.0 | 33.0 | 35.0 | 32.0 | 36.0 |
| GWP | — | 245 | 245 | 245 | 170 | 191 | 211 | 211 | 231 |
| COP Ratio | % (relative to | 101.0 | 100.7 | 100.5 | 99.5 | 99.5 | 99.8 | 99.6 | 99.9 |
| | R410A) | | | | | | | | |
| Refrigerating | % (relative to | 86.2 | 87.9 | 89.6 | 92.7 | 93.4 | 93.0 | 94.5 | 93.0 |
| Capacity Ratio | R410A) | | | | | | | | |

TABLE 141

| | | Example | Example | Example | Example | Example | Example | Example | Example |
|---|---|---|---|---|---|---|---|---|---|
| Item | Unit | 127 | 128 | 129 | 130 | 131 | 132 | 133 | 134 |
| HFO-1132(E) | Mass % | 33.0 | 36.0 | 24.0 | 27.0 | 30.0 | 33.0 | 23.0 | 26.0 |
| R32 | Mass % | 34.0 | 34.0 | 37.0 | 37.0 | 37.0 | 37.0 | 40.0 | 40.0 |
| R1234yf | Mass % | 33.0 | 30.0 | 39.0 | 36.0 | 33.0 | 30.0 | 37.0 | 34.0 |
| GWP | — | 231 | 231 | 252 | 251 | 251 | 251 | 272 | 272 |
| COP Ratio | % (relative to | 99.8 | 99.6 | 100.3 | 100.1 | 99.9 | 99.8 | 100.4 | 100.2 |
| | R410A) | | | | | | | | |
| Refrigerating | % (relative to | 94.5 | 96.0 | 91.9 | 93.4 | 95.0 | 96.5 | 93.3 | 94.9 |
| RatioCapacity | R410A) | | | | | | | | |

TABLE 142

| | | Example | Example | Example | Example | Example | Example | Example | Example |
|---|---|---|---|---|---|---|---|---|---|
| Item | Unit | 135 | 136 | 137 | 138 | 139 | 140 | 141 | 142 |
| HFO-1132(E) | Mass % | 29.0 | 32.0 | 19.0 | 22.0 | 25.0 | 28.0 | 31.0 | 18.0 |
| R32 | Mass % | 40.0 | 40.0 | 43.0 | 43.0 | 43.0 | 43.0 | 43.0 | 46.0 |
| R1234yf | Mass % | 31.0 | 28.0 | 38.0 | 35.0 | 32.0 | 29.0 | 26.0 | 36.0 |
| GWP | — | 272 | 271 | 292 | 292 | 292 | 292 | 292 | 312 |
| COP Ratio | % (relative to | 100.0 | 99.8 | 100.6 | 100.4 | 100.2 | 100.1 | 99.9 | 100.7 |
| | R410A) | | | | | | | | |
| Refrigerating | % (relative to | 96.4 | 97.9 | 93.1 | 94.7 | 96.2 | 97.8 | 99.3 | 94.4 |
| Capacity Ratio | R410A) | | | | | | | | |

TABLE 143

| | | Example | Example | Example | Example | Example | Example | Example | Example |
|---|---|---|---|---|---|---|---|---|---|
| Item | Unit | 143 | 144 | 145 | 146 | 147 | 148 | 149 | 150 |
| HFO-1132(E) | Mass % | 21.0 | 23.0 | 26.0 | 29.0 | 13.0 | 16.0 | 19.0 | 22.0 |
| R32 | Mass % | 46.0 | 46.0 | 46.0 | 46.0 | 49.0 | 49.0 | 49.0 | 49.0 |
| R1234yf | Mass % | 33.0 | 31.0 | 28.0 | 25.0 | 38.0 | 35.0 | 32.0 | 29.0 |
| GWP | — | 312 | 312 | 312 | 312 | 332 | 332 | 332 | 332 |
| COP Ratio | % (relative to | 100.5 | 100.4 | 100.2 | 100.0 | 101.1 | 100.9 | 100.7 | 100.5 |
| | R410A) | | | | | | | | |
| Refrigerating | % (relative to | 96.0 | 97.0 | 98.6 | 100.1 | 93.5 | 95.1 | 96.7 | 98.3 |
| Capacity Ratio | R410A) | | | | | | | | |

TABLE 144

| Item | Unit | Example 151 | Example 152 |
|---|---|---|---|
| HFO-1132(E) | Mass % | 25.0 | 28.0 |
| R32 | Mass % | 49.0 | 49.0 |
| R1234yf | Mass % | 26.0 | 23.0 |
| GWP | — | 332 | 332 |
| COP Ratio | % (relative | 100.3 | 100.1 |
| | to R410A) | | |
| Refrigerating | % (relative | 99.8 | 101.3 |
| Capacity Ratio | to R410A) | | |

The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI),
the line segment U is represented by coordinates (0.0236y²−1.7616y+72.0, y, −0.0236y²+0.7616y+28.0),
the line segment NE is represented by coordinates (0.012y²−1.9003y+58.3, y, −0.012y²+0.9003y+41.7), and
the line segments JN and EI are straight lines, the refrigerant D has a refrigerating capacity ratio of 80% or more relative to R410A, a GWP of 125 or less, and a WCF lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM),
the line segment MM′ is represented by coordinates (0.132y²−3.34y+52.6, y, −0.132y²+2.34y+47.4),
the line segment M′N is represented by coordinates (0.0596y²−2.2541y+48.98, y, −0.0596y²+1.2541y+51.02),
the line segment VG is represented by coordinates (0.0123y²−1.8033y+39.6, y, −0.0123y²+0.8033y+60.4), and
the line segments NV and GM are straight lines, the refrigerant D according to the present disclosure has a refrigerating capacity ratio of 70% or more relative to R410A, a GWP of 125 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments,
the line segment ON is represented by coordinates (0.0072y²−0.6701y+37.512, y, −0.0072y²−0.3299y+62.488),
the line segment NU is represented by coordinates (0.0083y²−1.7403y+56.635, y, −0.0083y²+0.7403y+43.365), and
the line segment UO is a straight line, the refrigerant D according to the present disclosure has a refrigerating capacity ratio of 80% or more relative to R410A, a GWP of 250 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments,
the line segment QR is represented by coordinates (0.0099y²−1.975y+84.765, y, −0.0099y²+0.975y+15.235),
the line segment RT is represented by coordinates (0.0082y²−1.8683y+83.126, y, −0.0082y²+0.8683y+16.874),
the line segment LK is represented by coordinates (0.0049y²−0.8842y+61.488, y, −0.0049y²−0.1158y+38.512),
the line segment KQ is represented by coordinates (0.0095y²−1.2222y+67.676, y, −0.0095y²+0.2222y+32.324), and
the line segment TL is a straight line, the refrigerant D according to the present disclosure has a refrigerating capacity ratio of 92.5% or more relative to R410A, a GWP of 350 or less, and a WCF lower flammability.
The results further indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments,
the line segment PS is represented by coordinates (0.0064y²−0.7103y+40.1, y, −0.0064y²−0.2897y+59.9),
the line segment ST is represented by coordinates (0.0082y²−1.8683y+83.126, y, −0.0082y²+0.8683y+16.874), and
the line segment TP is a straight line, the refrigerant D according to the present disclosure has a refrigerating capacity ratio of 92.5% or more relative to R410A, a GWP of 350 or less, and an ASHRAE lower flammability.

### (5-5) Refrigerant E

The refrigerant E according to the present disclosure is a mixed refrigerant comprising trans-1,2-difluoroethylene (HFO-1132(E)), trifluoroethylene (HFO-1123), and difluoromethane (R32).
The refrigerant E according to the present disclosure has various properties that are desirable as an R410A-alternative refrigerant, i.e., a coefficient of performance equivalent to that of R410A and a sufficiently low GWP.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment U is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines. When the requirements above are satisfied, the refrigerant according to the present disclosure has ASHRAE lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z),
the line segments NR and GM are straight lines. When the requirements above are satisfied, the refrigerant according to the present disclosure has ASHRAE lower flammability, a COP ratio of 93% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line. When the requirements above are satisfied, the refrigerant according to the present disclosure has ASHRAE lower flammability, a COP ratio of 94.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines. When the requirements above are satisfied, the refrigerant according to the present disclosure has ASHRAE lower flammability, a COP ratio of 96% or more relative to that of R410A, and a GWP of 250 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′e′, e′a′, and a′O that connect the following 5 points:
   point O (100.0, 0.0, 0.0),
   point c′ (56.7, 43.3, 0.0),
   point d′ (52.2, 38.3, 9.5),
   point e′ (41.8, 39.8, 18.4), and
   point a′ (81.6, 0.0, 18.4),
   or on the line segments c′d′, d′e′, and e′a′ (excluding the points c′ and a′);
the line segment c′d′ is represented by coordinates (−0.0297z²−0.1915z+56.7, 0.0297z²+1.1915z+43.3, z),
the line segment d′e′ is represented by coordinates (−0.0535z²+0.3229z+53.957, 0.0535z²+0.6771z+46.043, z), and
the line segments Oc′, e′a′, and a′O are straight lines. When the requirements above are satisfied, the refrigerant according to the present disclosure has a COP ratio of 92.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, de, ea′, and a′O that connect the following 5 points:
   point O (100.0, 0.0, 0.0),
   point c (77.7, 22.3, 0.0),
   point d (76.3, 14.2, 9.5),
   point e (72.2, 9.4, 18.4), and
   point a′ (81.6, 0.0, 18.4),
   or on the line segments cd, de, and ea′ (excluding the points c and a′);
the line segment cde is represented by coordinates (−0.017z²+0.0148z+77.684, 0.017z²+0.9852z+22.316, z), and
the line segments Oc, ea′, and a′O are straight lines. When the requirements above are satisfied, the refrigerant according to the present disclosure has a COP ratio of 95% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′a, and aO that connect the following 5 points:
   point O (100.0, 0.0, 0.0),
   point c′ (56.7, 43.3, 0.0),
   point d′ (52.2, 38.3, 9.5), and
   point a (90.5, 0.0, 9.5),
   or on the line segments c′d′ and d′a (excluding the points c′ and a);
the line segment c′d′ is represented by coordinates (−0.0297z²−0.1915z+56.7, 0.0297z²+1.1915z+43.3, z), and
the line segments Oc′, d′a, and aO are straight lines. When the requirements above are satisfied, the refrigerant according to the present disclosure has a COP ratio of 93.5% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, da, and aO that connect the following 4 points:
   point O (100.0, 0.0, 0.0),
   point c (77.7, 22.3, 0.0),
   point d (76.3, 14.2, 9.5), and
   point a (90.5, 0.0, 9.5),
   or on the line segments cd and da (excluding the points c and a);
the line segment cd is represented by coordinates (−0.017z²+0.0148z+77.684, 0.017z²+0.9852z+22.316, z), and
the line segments Oc, da, and aO are straight lines. When the requirements above are satisfied, the refrigerant according to the present disclosure has a COP ratio of 95% or more relative to that of R410A, and a GWP of 65 or less.
The refrigerant E according to the present disclosure may further comprise other additional refrigerants in addition to HFO-1132(E), HFO-1123, and R32, as long as the above properties and effects are not impaired. In this respect, the refrigerant according to the present disclosure preferably comprises HFO-1132(E), HFO-1123, and R32 in a total amount of 99.5 mass % or more, more preferably 99.75 mass % or more, and even more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant E)

The present disclosure is described in more detail below with reference to Examples of refrigerant E. However, the refrigerant E is not limited to the Examples.
Mixed refrigerants were prepared by mixing HFO-1132(E), HFO-1123, and R32 at mass % based on their sum shown in Tables 145 and 146.
The composition of each mixture was defined as WCF. A leak simulation was performed using National Institute of Science and Technology (NIST) Standard Reference Data Base Refleak Version 4.0 under the conditions for equipment, storage, shipping, leak, and recharge according to the ASHRAE Standard 34-2013. The most flammable fraction was defined as WCFF.
For each mixed refrigerant, the burning velocity was measured according to the ANSI/ASHRAE Standard 34-2013. When the burning velocities of the WCF composition and the WCFF composition are 10 cm/s or less, the flammability of such a refrigerant is classified as Class 2L (lower flammability) in the ASHRAE flammability classification.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Tables 145 and 146 show the results.

TABLE 145

| Item | | Unit | I | J | K | L |
|---|---|---|---|---|---|---|
| WCF | HFO-1132(E) | mass % | 72.0 | 57.7 | 48.4 | 35.5 |
| | HFO-1123 | mass % | 28.0 | 32.8 | 33.2 | 27.5 |
| | R32 | mass % | 0.0 | 9.5 | 18.4 | 37.0 |

| | | | | | |
|---|---|---|---|---|---|
| Burning velocity (WCF) | cm/s | 10 | 10 | 10 | 10 |

TABLE 146

| Item | | Unit | M | N | T | P | U | Q |
|---|---|---|---|---|---|---|---|---|
| WCF | HFO- | mass | 47.1 | 38.5 | 34.8 | 31.8 | 28.7 | 28.6 |
| | 1132(E) | % | | | | | | |
| | HFO-1123 | mass | 52.9 | 52.1 | 51.0 | 49.8 | 41.2 | 34.4 |
| | | % | | | | | | |
| | R32 | mass | 0.0 | 9.5 | 14.2 | 18.4 | 30.1 | 37.0 |
| | | % | | | | | | |
| Leak condition that results in | | | Storage, | Storage, | Storage, | Storage, | Storage, | Storage, |
| WCFF | | | Shipping, | Shipping, | Shipping, | Shipping, | Shipping, | Shipping, |
| | | | −40° C., | −40° C., | −40° C., | −40° C., | −40° C., | −40° C., |
| | | | 92%, | 92%, | 92%, | 92%, | 92%, | 92%, |
| | | | release, | release, | release, | release, | release, | release, |
| | | | on the liquid | on the liquid | on the liquid | on the liquid | on the liquid | on the liquid |
| | | | phase side | phase side | phase side | phase side | phase side | phase side |
| WCFF | HFO- | mass | 72.0 | 58.9 | 51.5 | 44.6 | 31.4 | 27.1 |
| | 1132(E) | % | | | | | | |
| | HFO-1123 | mass | 28.0 | 32.4 | 33.1 | 32.6 | 23.2 | 18.3 |
| | | % | | | | | | |
| | R32 | mass | 0.0 | 8.7 | 15.4 | 22.8 | 45.4 | 54.6 |
| | | % | | | | | | |
| Burning velocity | | cm/s | 8 or less | 8 or less | 8 or less | 8 or less | 8 or less | 8 or less |
| (WCF) | | | | | | | | |
| Burning velocity | | cm/s | 10 | 10 | 10 | 10 | 10 | 10 |
| (WCFF) | | | | | | | | |

The results in Table 1 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments IK and KL that connect the following 3 points:
   point I (72.0, 28.0, 0.0),
   point K (48.4, 33.2, 18.4), and
   point L (35.5, 27.5, 37.0);
   the line segment IK is represented by coordinates
   (0.025z²−1.7429z+72.00, −0.025z²+0.7429z+28.00, z), and
   the line segment KL is represented by coordinates
   (0.0098z²−1.238z+67.852, −0.0098z²+0.238z+32.148, z),
   it can be determined that the refrigerant has WCF lower flammability.
For the points on the line segment IK, an approximate curve (x=0.025z²−1.7429z+72.00) was obtained from three points, i.e., I (72.0, 28.0, 0.0), J (57.7, 32.8, 9.5), and K (48.4, 33.2, 18.4) by using the least-square method to determine coordinates (x=0.025z²−1.7429z+72.00, y=100−z−x=−0.00922z²+0.2114z+32.443, z).
Likewise, for the points on the line segment KL, an approximate curve was determined from three points, i.e., K (48.4, 33.2, 18.4), Example 10 (41.1, 31.2, 27.7), and L (35.5, 27.5, 37.0) by using the least-square method to determine coordinates.
The results in Table 146 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments MP and PQ that connect the following 3 points:
   point M (47.1, 52.9, 0.0),
   point P (31.8, 49.8, 18.4), and
   point Q (28.6, 34.4, 37.0),
   it can be determined that the refrigerant has ASHRAE lower flammability.
In the above, the line segment MP is represented by coordinates (0.0083z²−0.984z+47.1, −0.0083z²−0.016z+52.9, z), and the line segment PQ is represented by coordinates
   (0.0135z²−0.9181z+44.133, −0.0135z²−0.0819z+55.867, z).
For the points on the line segment MP, an approximate curve was obtained from three points, i.e., points M, N, and P, by using the least-square method to determine coordinates. For the points on the line segment PQ, an approximate curve was obtained from three points, i.e., points P, U, and Q, by using the least-square method to determine coordinates.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
The COP ratio and the refrigerating capacity (which may be referred to as “cooling capacity” or “capacity”) ratio relative to those of R410 of the mixed refrigerants were determined. The conditions for calculation were as described below.
   Evaporating temperature: 5° C.
   Condensation temperature: 45° C.
   Degree of superheating: 5K
   Degree of subcooling: 5K
   Compressor efficiency: 70%
Tables 147 to 166 show these values together with the GWP of each mixed refrigerant.

TABLE 147

| | | | Compar- | Compar- | Compar- | Compar- | Compar- | Compar- |
|---|---|---|---|---|---|---|---|---|
| | | Compar- | ative | ative | ative | ative | ative | ative |
| | | ative | Example | Example | Example | Example | Example | Example |
| | | Example | 2 | 3 | 4 | 5 | 6 | 7 |
| Item | Unit | 1 | A | B | A′ | B′ | A″ | B″ |
| HFO-1132(E) | mass % | R410A | 90.5 | 0.0 | 81.6 | 0.0 | 63.0 | 0.0 |
| HFO-1123 | mass % | | 0.0 | 90.5 | 0.0 | 81.6 | 0.0 | 63.0 |
| R32 | mass % | | 9.5 | 9.5 | 18.4 | 18.4 | 37.0 | 37.0 |
| GWP | — | 2088 | 65 | 65 | 125 | 125 | 250 | 250 |
| COP | % | 100 | 99.1 | 92.0 | 98.7 | 93.4 | 98.7 | 96.1 |
| ratio | (relative | | | | | | | |
| | to | | | | | | | |
| | R410A) | | | | | | | |
| Refrigerating | % | 100 | 102.2 | 111.6 | 105.3 | 113.7 | 110.0 | 115.4 |
| capacity | (relative | | | | | | | |
| ratio | to | | | | | | | |
| | R410A) | | | | | | | |

TABLE 148

| | | Compar- | Compar- | Compar- | | | Compar- |
|---|---|---|---|---|---|---|---|
| | | ative | ative | ative | Example | | ative |
| | | Example 8 | Example 9 | Example | 1 | Example | Example 7 |
| Item | Unit | O | C | 10 | U | 2 | D |
| HFO-1132(E) | mass % | 100.0 | 50.0 | 41.1 | 28.7 | 15.2 | 0.0 |
| HFO-1123 | mass % | 0.0 | 31.6 | 34.6 | 41.2 | 52.7 | 67.0 |
| R32 | mass % | 0.0 | 18.4 | 24.3 | 30.1 | 32.1 | 33.0 |
| GWP | — | 1 | 125 | 165 | 204 | 217 | 228 |
| COP | % (relative | 99.7 | 96.0 | 96.0 | 96.0 | 96.0 | 96.0 |
| ratio | to R410A) | | | | | | |
| Refrigerating | % (relative | 98.3 | 109.9 | 111.7 | 113.5 | 114.8 | 115.4 |
| capacity ratio | to R41 OA) | | | | | | |

TABLE 149

| | | Comparative | Com- | Ex- | Ex- | Comparative |
|---|---|---|---|---|---|---|
| | | Example | parative | ample | ample | Example |
| | | 12 | Example | 3 | 4 | 14 |
| Item | Unit | E | 13 | T | S | F |
| HFO-1132(E) | mass % | 53.4 | 43.4 | 34.8 | 25.4 | 0.0 |
| HFO-1123 | mass % | 46.6 | 47.1 | 51.0 | 56.2 | 74.1 |
| R32 | mass % | 0.0 | 9.5 | 14.2 | 18.4 | 25.9 |
| GWP | — | 1 | 65 | 97 | 125 | 176 |
| COP ratio | % (relative to | 94.5 | 94.5 | 94.5 | 94.5 | 94.5 |
| | R410A) | | | | | |
| Refrigerating | % (relative to | 105.6 | 109.2 | 110.8 | 112.3 | 114.8 |
| capacity ratio | R410A) | | | | | |

TABLE 150

| | | Comparative | | | | Comparative |
|---|---|---|---|---|---|---|
| | | Example | | Example | | Example |
| | | 15 | Example | 6 | Example | 16 |
| Item | Unit | G | 5 | R | 7 | H |
| HFO-1132(E) | mass % | 38.5 | 31.5 | 23.1 | 16.9 | 0.0 |
| HFO-1123 | mass % | 61.5 | 63.5 | 67.4 | 71.1 | 84.2 |
| R32 | mass % | 0.0 | 5.0 | 9.5 | 12.0 | 15.8 |
| GWP | — | 1 | 35 | 65 | 82 | 107 |
| COP ratio | % (relative to | 93.0 | 93.0 | 93.0 | 93.0 | 93.0 |
| | R410A) | | | | | |
| Refrigerating | % (relative to | 107.0 | 109.1 | 110.9 | 111.9 | 113.2 |
| capacity ratio | R410A) | | | | | |

TABLE 151

| | | Comparative | Example | Example | | Comparative |
|---|---|---|---|---|---|---|
| | | Example 17 | 8 | 9 | Comparative | Example 19 |
| Item | Unit | I | J | K | Example 18 | L |
| HFO-1132(E) | mass % | 72.0 | 57.7 | 48.4 | 41.1 | 35.5 |
| HFO-1123 | mass % | 28.0 | 32.8 | 33.2 | 31.2 | 27.5 |
| R32 | mass % | 0.0 | 9.5 | 18.4 | 27.7 | 37.0 |
| GWP | — | 1 | 65 | 125 | 188 | 250 |
| COP ratio | % (relative | 96.6 | 95.8 | 95.9 | 96.4 | 97.1 |
| | to R410A) | | | | | |
| Refrigerating | % (relative | 103.1 | 107.4 | 110.1 | 112.1 | 113.2 |
| capacity ratio | to R410A) | | | | | |

TABLE 152

| | | Comparative | Exam- | Exam- | Exam- |
|---|---|---|---|---|---|
| | | Example 20 | ple 10 | ple 11 | ple 12 |
| Item | Unit | M | N | P | Q |
| HFO-1132(E) | mass % | 47.1 | 38.5 | 31.8 | 28.6 |
| HFO-1123 | mass % | 52.9 | 52.1 | 49.8 | 34.4 |
| R32 | mass % | 0.0 | 9.5 | 18.4 | 37.0 |
| GWP | — | 1 | 65 | 125 | 250 |
| COP ratio | % (relative | 93.9 | 94.1 | 94.7 | 96.9 |
| | to R410A) | | | | |
| Refrigerating | % (relative | 106.2 | 109.7 | 112.0 | 114.1 |
| capacity ratio | to R410A) | | | | |

TABLE 153

| | | Comparative | Comparative | Comparative | | | | Comparative | Comparative |
|---|---|---|---|---|---|---|---|---|---|
| | | Example | Example | Example | Example | Example | Example | Example | Example |
| Item | Unit | 22 | 23 | 24 | 14 | 15 | 16 | 25 | 26 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R32 | mass % | 5.0 | 5.0 | 5.0 | 5.0 | 5.0 | 5.0 | 5.0 | 5.0 |
| GWP | — | 35 | 35 | 35 | 35 | 35 | 35 | 35 | 35 |
| COP ratio | % (relative | 91.7 | 92.2 | 92.9 | 93.7 | 94.6 | 95.6 | 96.7 | 97.7 |
| | to R410A) | | | | | | | | |
| Refrigerating | % (relative | 110.1 | 109.8 | 109.2 | 108.4 | 107.4 | 106.1 | 104.7 | 103.1 |
| capacity | to R410A) | | | | | | | | |
| ratio | | | | | | | | | |

TABLE 154

| | | Comparative | Comparative | Comparative | | | | Comparative | Comparative |
|---|---|---|---|---|---|---|---|---|---|
| | | Example | Example | Example | Example | Example | Example | Example | Example |
| Item | Unit | 27 | 28 | 29 | 17 | 18 | 19 | 30 | 31 |
| HFO-1132(E) | mass % | 90.0 | 10.0 | 20.0 | 30.0 | 40.0 | 50.0 | 60.0 | 70.0 |
| HFO-1123 | mass % | 5.0 | 80.0 | 70.0 | 60.0 | 50.0 | 40.0 | 30.0 | 20.0 |
| R32 | mass % | 5.0 | 10.0 | 10.0 | 10.0 | 10.0 | 10.0 | 10.0 | 10.0 |
| GWP | — | 35 | 68 | 68 | 68 | 68 | 68 | 68 | 68 |
| COP ratio | % (relative | 98.8 | 92.4 | 92.9 | 93.5 | 94.3 | 95.1 | 96.1 | 97.0 |
| | to R410A) | | | | | | | | |
| Refrigerating | % (relative | 101.4 | 111.7 | 111.3 | 110.6 | 109.6 | 108.5 | 107.2 | 105.7 |
| capacity | to R410A) | | | | | | | | |
| ratio | | | | | | | | | |

TABLE 155

| | | Comparative | | | | | | Comparative | Comparative |
|---|---|---|---|---|---|---|---|---|---|
| | | Example | Example | Example | Example | Example | Example | Example | Example |
| Item | Unit | 32 | 20 | 21 | 22 | 23 | 24 | 33 | 34 |
| HFO-1132(E) | mass % | 80.0 | 10.0 | 20.0 | 30.0 | 40.0 | 50.0 | 60.0 | 70.0 |
| HFO-1123 | mass % | 10.0 | 75.0 | 65.0 | 55.0 | 45.0 | 35.0 | 25.0 | 15.0 |
| R32 | mass % | 10.0 | 15.0 | 15.0 | 15.0 | 15.0 | 15.0 | 15.0 | 15.0 |
| GWP | — | 68 | 102 | 102 | 102 | 102 | 102 | 102 | 102 |
| COP ratio | % (relative | 98.0 | 93.1 | 93.6 | 94.2 | 94.9 | 95.6 | 96.5 | 97.4 |
| | to R410A) | | | | | | | | |
| Refrigerating | % (relative | 104.1 | 112.9 | 112.4 | 111.6 | 110.6 | 109.4 | 108.1 | 106.6 |
| capacity ratio | to R410A) | | | | | | | | |

TABLE 156

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 35 | 36 | 37 | 38 | 39 | 40 | 41 | 42 |
| HFO-1132(E) | mass % | 80.0 | 10.0 | 20.0 | 30.0 | 40.0 | 50.0 | 60.0 | 70.0 |
| HFO-1123 | mass % | 5.0 | 70.0 | 60.0 | 50.0 | 40.0 | 30.0 | 20.0 | 10.0 |
| R32 | mass % | 15.0 | 20.0 | 20.0 | 20.0 | 20.0 | 20.0 | 20.0 | 20.0 |
| GWP | — | 102 | 136 | 136 | 136 | 136 | 136 | 136 | 136 |
| COP ratio | % (relative | 98.3 | 93.9 | 94.3 | 94.8 | 95.4 | 96.2 | 97.0 | 97.8 |
| | to R410A) | | | | | | | | |
| Refrigerating | % (relative | 105.0 | 113.8 | 113.2 | 112.4 | 111.4 | 110.2 | 108.8 | 107.3 |
| capacity | to R410A) | | | | | | | | |
| ratio | | | | | | | | | |

TABLE 157

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 43 | 44 | 45 | 46 | 47 | 48 | 49 | 50 |
| HFO- | mass % | 10.0 | 20.0 | 30.0 | 40.0 | 50.0 | 60.0 | 70.0 | 10.0 |
| 1132(E) | | | | | | | | | |
| HFO-1123 | mass % | 65.0 | 55.0 | 45.0 | 35.0 | 25.0 | 15.0 | 5.0 | 60.0 |
| R32 | mass % | 25.0 | 25.0 | 25.0 | 25.0 | 25.0 | 25.0 | 25.0 | 30.0 |
| GWP | — | 170 | 170 | 170 | 170 | 170 | 170 | 170 | 203 |
| COP ratio | % (relative | 94.6 | 94.9 | 95.4 | 96.0 | 96.7 | 97.4 | 98.2 | 95.3 |
| | to R410A) | | | | | | | | |
| Refrigerating | % (relative | | | | | | | | |
| capacity | to R410A) | 114.4 | 113.8 | 113.0 | 111.9 | 110.7 | 109.4 | 107.9 | 114.8 |
| ratio | | | | | | | | | |

TABLE 158

| | | Comparative | Comparative | Comparative | Comparative | Comparative | | | Comparative |
|---|---|---|---|---|---|---|---|---|---|
| | | Example | Example | Example | Example | Example | Example | Example | Example |
| Item | Unit | 51 | 52 | 53 | 54 | 55 | 25 | 26 | 56 |
| HFO- | mass % | 20.0 | 30.0 | 40.0 | 50.0 | 60.0 | 10.0 | 20.0 | 30.0 |
| 1132(E) | | | | | | | | | |
| HFO-1123 | mass % | 50.0 | 40.0 | 30.0 | 20.0 | 10.0 | 55.0 | 45.0 | 35.0 |
| R32 | mass % | 30.0 | 30.0 | 30.0 | 30.0 | 30.0 | 35.0 | 35.0 | 35.0 |
| GWP | — | 203 | 203 | 203 | 203 | 203 | 237 | 237 | 237 |
| COP ratio | % (relative | 95.6 | 96.0 | 96.6 | 97.2 | 97.9 | 96.0 | 96.3 | 96.6 |
| | to R410A) | | | | | | | | |
| Refrigerating | % (relative | 114.2 | 113.4 | 112.4 | 111.2 | 109.8 | 115.1 | 114.5 | 113.6 |
| capacity | to R410A) | | | | | | | | |
| ratio | | | | | | | | | |

TABLE 159

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 57 | 58 | 59 | 60 | 61 | 62 | 63 | 64 |
| HFO- | mass % | 40.0 | 50.0 | 60.0 | 10.0 | 20.0 | 30.0 | 40.0 | 50.0 |
| 1132(E) | | | | | | | | | |
| HFO-1123 | mass % | 25.0 | 15.0 | 5.0 | 50.0 | 40.0 | 30.0 | 20.0 | 10.0 |
| R32 | mass % | 35.0 | 35.0 | 35.0 | 40.0 | 40.0 | 40.0 | 40.0 | 40.0 |
| GWP | — | 237 | 237 | 237 | 271 | 271 | 271 | 271 | 271 |
| COP ratio | % (relative | | | | | | | | |
| | to R410A) | 97.1 | 97.7 | 98.3 | 96.6 | 96.9 | 97.2 | 97.7 | 98.2 |
| Refrigerating | % (relative | 112.6 | 111.5 | 110.2 | 115.1 | 114.6 | 113.8 | 112.8 | 111.7 |
| capacity | to R410A) | | | | | | | | |

TABLE 160

| | | Example | Example | Example | Example | Example | Example | Example | Example |
|---|---|---|---|---|---|---|---|---|---|
| Item | Unit | 27 | 28 | 29 | 30 | 31 | 32 | 33 | 34 |
| HFO-1132(E) | mass % | 38.0 | 40.0 | 42.0 | 44.0 | 35.0 | 37.0 | 39.0 | 41.0 |
| HFO-1123 | mass % | 60.0 | 58.0 | 56.0 | 54.0 | 61.0 | 59.0 | 57.0 | 55.0 |
| R32 | mass % | 2.0 | 2.0 | 2.0 | 2.0 | 4.0 | 4.0 | 4.0 | 4.0 |
| GWP | — | 14 | 14 | 14 | 14 | 28 | 28 | 28 | 28 |
| COP ratio | % (relative | | | | | | | | |
| | to R410A) | 93.2 | 93.4 | 93.6 | 93.7 | 93.2 | 93.3 | 93.5 | 93.7 |
| Refrigerating | % (relative | 107.7 | 107.5 | 107.3 | 107.2 | 108.6 | 108.4 | 108.2 | 108.0 |
| capacity ratio | to R410A) | | | | | | | | |

TABLE 161

| | | Example | Example | Example | Example | Example | Example | Example | Example |
|---|---|---|---|---|---|---|---|---|---|
| Item | Unit | 35 | 36 | 37 | 38 | 39 | 40 | 41 | 42 |
| HFO-1132(E) | mass % | 43.0 | 31.0 | 33.0 | 35.0 | 37.0 | 39.0 | 41.0 | 27.0 |
| HFO-1123 | mass % | 53.0 | 63.0 | 61.0 | 59.0 | 57.0 | 55.0 | 53.0 | 65.0 |
| R32 | mass % | 4.0 | 6.0 | 6.0 | 6.0 | 6.0 | 6.0 | 6.0 | 8.0 |
| GWP | — | 28 | 41 | 41 | 41 | 41 | 41 | 41 | 55 |
| COP ratio | % (relative | 93.9 | 93.1 | 93.2 | 93.4 | 93.6 | 93.7 | 93.9 | 93.0 |
| | to R410A) | | | | | | | | |
| Refrigerating | % (relative | 107.8 | 109.5 | 109.3 | 109.1 | 109.0 | 108.8 | 108.6 | 110.3 |
| capacity ratio | to R410A) | | | | | | | | |

TABLE 162

| | | Example | Example | Example | Example | Example | Example | Example | Example |
|---|---|---|---|---|---|---|---|---|---|
| Item | Unit | 43 | 44 | 45 | 46 | 47 | 48 | 49 | 50 |
| HFO-1132(E) | mass % | 29.0 | 31.0 | 33.0 | 35.0 | 37.0 | 39.0 | 32.0 | 32.0 |
| HFO-1123 | mass % | 63.0 | 61.0 | 59.0 | 57.0 | 55.0 | 53.0 | 51.0 | 50.0 |
| R32 | mass % | 8.0 | 8.0 | 8.0 | 8.0 | 8.0 | 8.0 | 17.0 | 18.0 |
| GWP | — | 55 | 55 | 55 | 55 | 55 | 55 | 116 | 122 |
| COP ratio | % (relative | 93.2 | 93.3 | 93.5 | 93.6 | 93.8 | 94.0 | 94.5 | 94.7 |
| | to R410A) | | | | | | | | |
| Refrigerating | % (relative | 110.1 | 110.0 | 109.8 | 109.6 | 109.5 | 109.3 | 111.8 | 111.9 |
| capacity ratio | to R410A) | | | | | | | | |

TABLE 163

| | | Example | Example | Example | Example | Example | Example | Example | Example |
|---|---|---|---|---|---|---|---|---|---|
| Item | Unit | 51 | 52 | 53 | 54 | 55 | 56 | 57 | 58 |
| HFO-1132(E) | mass % | 30.0 | 27.0 | 21.0 | 23.0 | 25.0 | 27.0 | 11.0 | 13.0 |
| HFO-1123 | mass % | 52.0 | 42.0 | 46.0 | 44.0 | 42.0 | 40.0 | 54.0 | 52.0 |
| R32 | mass % | 18.0 | 31.0 | 33.0 | 33.0 | 33.0 | 33.0 | 35.0 | 35.0 |
| GWP | — | 122 | 210 | 223 | 223 | 223 | 223 | 237 | 237 |
| COP ratio | % (relative | 94.5 | 96.0 | 96.0 | 96.1 | 96.2 | 96.3 | 96.0 | 96.0 |
| | to R410A) | | | | | | | | |
| Refrigerating | % (relative | 112.1 | 113.7 | 114.3 | 114.2 | 114.0 | 113.8 | 115.0 | 114.9 |
| capacity ratio | to R410A) | | | | | | | | |

TABLE 164

| | | Example | Example | Example | Example | Example | Example | Example | Example |
|---|---|---|---|---|---|---|---|---|---|
| Item | Unit | 59 | 60 | 61 | 62 | 63 | 64 | 65 | 66 |
| HFO-1132(E) | mass % | 15.0 | 17.0 | 19.0 | 21.0 | 23.0 | 25.0 | 27.0 | 11.0 |
| HFO-1123 | mass % | 50.0 | 48.0 | 46.0 | 44.0 | 42.0 | 40.0 | 38.0 | 52.0 |
| R32 | mass % | 35.0 | 35.0 | 35.0 | 35.0 | 35.0 | 35.0 | 35.0 | 37.0 |
| GWP | — | 237 | 237 | 237 | 237 | 237 | 237 | 237 | 250 |
| COP ratio | % (relative | 96.1 | 96.2 | 96.2 | 96.3 | 96.4 | 96.4 | 96.5 | 96.2 |
| | to R410A) | | | | | | | | |
| Refrigerating | % (relative | 114.8 | 114.7 | 114.5 | 114.4 | 114.2 | 114.1 | 113.9 | 115.1 |
| capacity ratio | to R410A) | | | | | | | | |

TABLE 165

| | | Example | Example | Example | Example | Example | Example | Example | Example |
|---|---|---|---|---|---|---|---|---|---|
| Item | Unit | 67 | 68 | 69 | 70 | 71 | 72 | 73 | 74 |
| HFO-1132(E) | mass % | 13.0 | 15.0 | 17.0 | 15.0 | 17.0 | 19.0 | 21.0 | 23.0 |
| HFO-1123 | mass % | 50.0 | 48.0 | 46.0 | 50.0 | 48.0 | 46.0 | 44.0 | 42.0 |
| R32 | mass % | 37.0 | 37.0 | 37.0 | 0.0 | 0.0 | 0.0 | 0.0 | 0.0 |
| GWP | — | 250 | 250 | 250 | 237 | 237 | 237 | 237 | 237 |
| COP ratio | % (relative | 96.3 | 96.4 | 96.4 | 96.1 | 96.2 | 96.2 | 96.3 | 96.4 |
| | to R410A) | | | | | | | | |
| Refrigerating | % (relative | 115.0 | 114.9 | 114.7 | 114.8 | 114.7 | 114.5 | 114.4 | 114.2 |
| capacity ratio | to R410A) | | | | | | | | |

TABLE 166

| | | Example | Example | Example | Example | Example | Example | Example | Example |
|---|---|---|---|---|---|---|---|---|---|
| Item | Unit | 75 | 76 | 77 | 78 | 79 | 80 | 81 | 82 |
| HFO-1132(E) | mass % | 25.0 | 27.0 | 11.0 | 19.0 | 21.0 | 23.0 | 25.0 | 27.0 |
| HFO-1123 | mass % | 40.0 | 38.0 | 52.0 | 44.0 | 42.0 | 40.0 | 38.0 | 36.0 |
| R32 | mass % | 0.0 | 0.0 | 0.0 | 37.0 | 37.0 | 37.0 | 37.0 | 37.0 |
| GWP | — | 237 | 237 | 250 | 250 | 250 | 250 | 250 | 250 |
| COP ratio | % (relative | 96.4 | 96.5 | 96.2 | 96.5 | 96.5 | 96.6 | 96.7 | 96.8 |
| | to R410A) | | | | | | | | |
| Refrigerating | % (relative | 114.1 | 113.9 | 115.1 | 114.6 | 114.5 | 114.3 | 114.1 | 114.0 |
| capacity ratio | to R410A) | | | | | | | | |

The above results indicate that under the condition that the mass % of HFO-1132(E), HFO-1123, and R32 based on their sum is respectively represented by x, y, and z, when coordinates (x,y,z) in a ternary composition diagram in which the sum of HFO-1132(E), HFO-1123, and R32 is 100 mass %, a line segment connecting a point (0.0, 100.0, 0.0) and a point (0.0, 0.0, 100.0) is the base, and the point (0.0, 100.0, 0.0) is on the left side are within the range of a figure surrounded by line segments that connect the following 4 points:
   point O (100.0, 0.0, 0.0),
   point A″ (63.0, 0.0, 37.0),
   point B″ (0.0, 63.0, 37.0), and
   point (0.0, 100.0, 0.0),
   or on these line segments,
   the refrigerant has a GWP of 250 or less.
The results also indicate that when coordinates (x,y,z) are within the range of a figure surrounded by line segments that connect the following 4 points:
   point O (100.0, 0.0, 0.0),
   point A′ (81.6, 0.0, 18.4),
   point B′ (0.0, 81.6, 18.4), and
   point (0.0, 100.0, 0.0),
   or on these line segments,
   the refrigerant has a GWP of 125 or less.
The results also indicate that when coordinates (x,y,z) are within the range of a figure surrounded by line segments that connect the following 4 points:
   point O (100.0, 0.0, 0.0),
   point A (90.5, 0.0, 9.5),
   point B (0.0, 90.5, 9.5), and
   point (0.0, 100.0, 0.0),
   or on these line segments,
   the refrigerant has a GWP of 65 or less.
The results also indicate that when coordinates (x,y,z) are on the left side of line segments that connect the following 3 points:
   point C (50.0, 31.6, 18.4),
   point U (28.7, 41.2, 30.1), and
   point D (52.2, 38.3, 9.5),
   or on these line segments,
   the refrigerant has a COP ratio of 96% or more relative to that of R410A.
In the above, the line segment CU is represented by coordinates (−0.0538z²+0.7888z+53.701, 0.0538z²−1.7888z+46.299, z), and the line segment UD is represented by coordinates
   (−3.4962z²+210.71z−3146.1, 3.4962z²−211.71z+3246.1, z).
The points on the line segment CU are determined from three points, i.e., point C, Comparative Example 10, and point U, by using the least-square method.
The points on the line segment UD are determined from three points, i.e., point U, Example 2, and point D, by using the least-square method.
The results also indicate that when coordinates (x,y,z) are on the left side of line segments that connect the following 3 points:
   point E (55.2, 44.8, 0.0),
   point T (34.8, 51.0, 14.2), and
   point F (0.0, 76.7, 23.3),
   or on these line segments,
   the refrigerant has a COP ratio of 94.5% or more relative to that of R410A.
In the above, the line segment ET is represented by coordinates (−0.0547z²−0.5327z+53.4, 0.0547z²−0.4673z+46.6, z), and the line segment TF is represented by coordinates
   (−0.0982z²+0.9622z+40.931, 0.0982z²−1.9622z+59.069, z).
The points on the line segment ET are determined from three points, i.e., point E, Example 2, and point T, by using the least-square method.
The points on the line segment TF are determined from three points, i.e., points T, S, and F, by using the least-square method.
The results also indicate that when coordinates (x,y,z) are on the left side of line segments that connect the following 3 points:
   point G (0.0, 76.7, 23.3),
   point R (21.0, 69.5, 9.5), and
   point H (0.0, 85.9, 14.1),
   or on these line segments,
   the refrigerant has a COP ratio of 93% or more relative to that of R410A.
In the above, the line segment GR is represented by coordinates (−0.0491z²−1.1544z+38.5, 0.0491z²+0.1544z+61.5, z), and the line segment RH is represented by coordinates
   (−0.3123z²+4.234z+11.06, 0.3123z²−5.234z+88.94, z).
The points on the line segment GR are determined from three points, i.e., point G, Example 5, and point R, by using the least-square method.
The points on the line segment RH are determined from three points, i.e., point R, Example 7, and point H, by using the least-square method.
In contrast, as shown in, for example, Comparative Examples 8, 9, 13, 15, 17, and 18, when R32 is not contained, the concentrations of HFO-1132(E) and HFO-1123, which have a double bond, become relatively high; this undesirably leads to deterioration, such as decomposition, or polymerization in the refrigerant compound.

### (6) First Embodiment

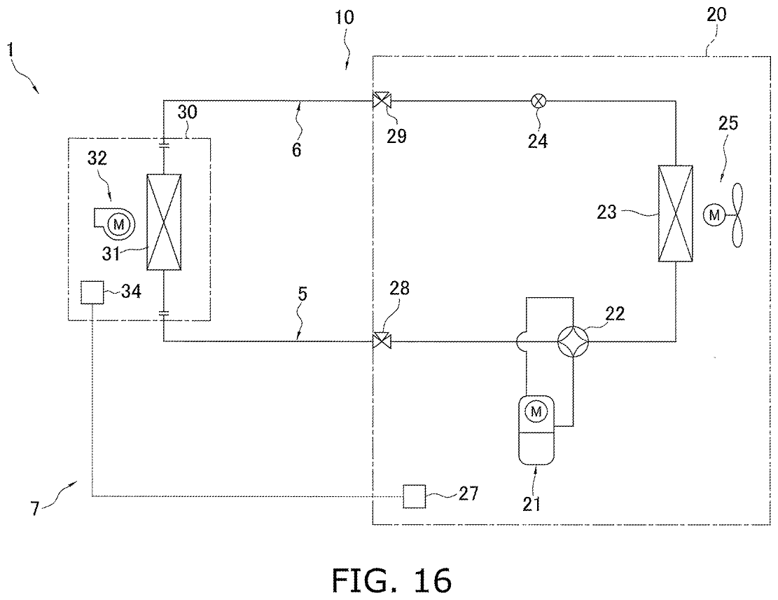

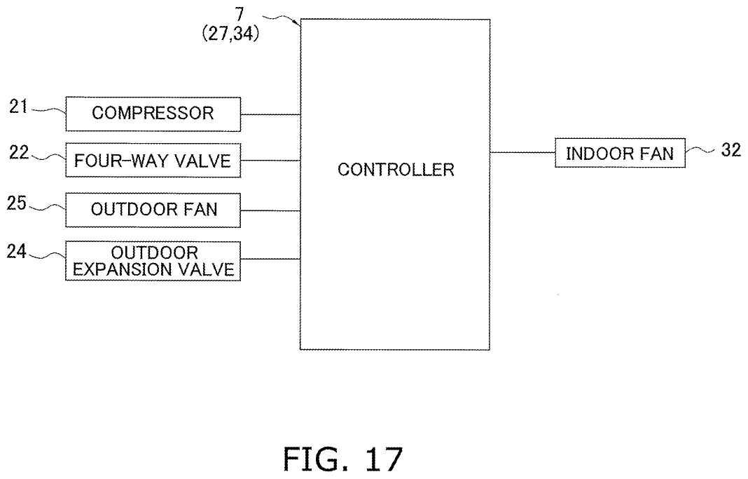

Hereinafter, an air conditioner 1 that serves as a refrigeration cycle apparatus according to a first embodiment will be described with reference to FIG. 16 that is the schematic configuration diagram of a refrigerant circuit and FIG. 17 that is a schematic control block configuration diagram.

The air conditioner 1 is an apparatus that air-conditions a space to be air-conditioned by performing a vapor compression refrigeration cycle.

The air conditioner 1 mainly includes an outdoor unit 20, an indoor unit 30, a liquid-side connection pipe 6 and a gas-side connection pipe 5 connecting the outdoor unit 20 and the indoor unit 30, a remote control unit (not shown) serving as an input device and an output device, and a controller 7 that controls the operation of the air conditioner 1.

In the air conditioner 1, the refrigeration cycle in which refrigerant sealed in a refrigerant circuit 10 is compressed, cooled or condensed, decompressed, heated or evaporated, and then compressed again is performed. In the present embodiment, the refrigerant circuit 10 is filled with refrigerant for performing a vapor compression refrigeration cycle. The refrigerant is a refrigerant containing 1,2-difluoroethylene, and any one of the above-described refrigerants A to E may be used. The refrigerant circuit 10 is filled with refrigerating machine oil together with the refrigerant.

(6-1) Outdoor Unit 20

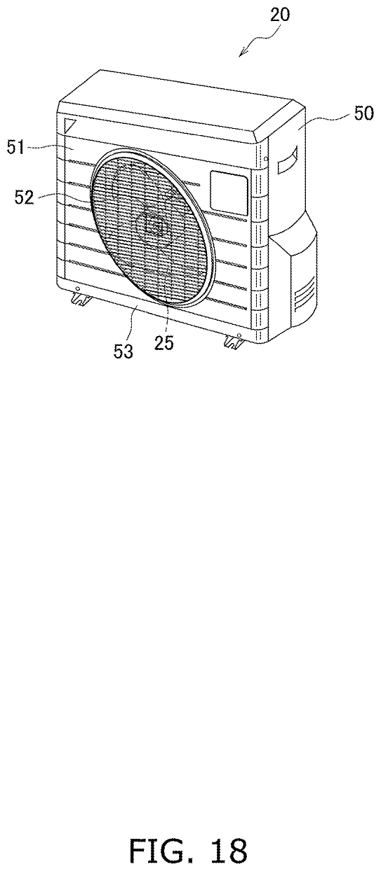

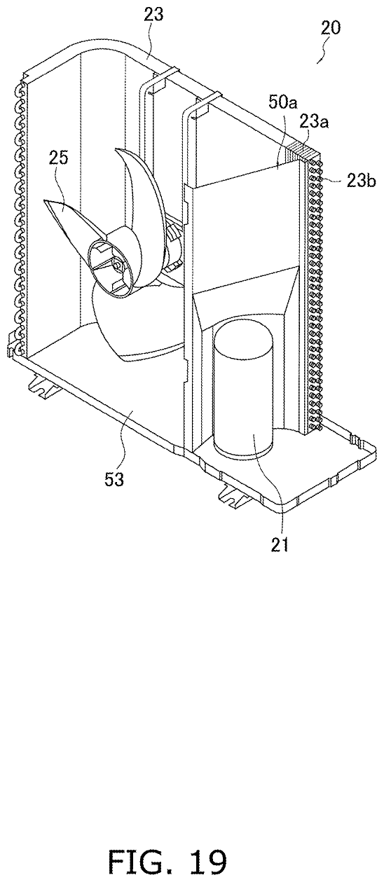

As shown in FIG. 18, the outdoor unit 20 includes an outdoor casing 50 having a substantially rectangular parallelepiped shape in appearance. As shown in FIG. 19, the outdoor unit 20 has a fan chamber and a machine chamber formed when an internal space is divided into right and left spaces by a partition plate 50a.

The outdoor unit 20 is connected to the indoor unit 30 via the liquid-side connection pipe 6 and the gas-side connection pipe 5, and makes up part of the refrigerant circuit 10. The outdoor unit 20 mainly includes a compressor 21, a four-way valve 22, an outdoor heat exchanger 23, an outdoor expansion valve 24, an outdoor fan 25, a liquid-side stop valve 29, and a gas-side stop valve 28.

The compressor 21 is a device that compresses low-pressure refrigerant into high pressure in the refrigeration cycle. Here, the compressor 21 is a hermetically sealed compressor in which a positive-displacement, such as a rotary type and a scroll type, compression element (not shown) is driven for rotation by a compressor motor. The compressor motor is used to change the displacement. The operation frequency of the compressor motor is controllable with an inverter. The compressor 21 is provided with an attached accumulator (not shown) at its suction side. The outdoor unit 20 of the present embodiment does not have a refrigerant container larger than the attached accumulator (a low-pressure receiver disposed at the suction side of the compressor 21, a high-pressure receiver disposed at a liquid side of the outdoor heat exchanger 23, or the like).

The four-way valve 22 is able to switch between a cooling operation connection state and a heating operation connection state by switching the status of connection. In the cooling operation connection state, a discharge side of the compressor 21 and the outdoor heat exchanger 23 are connected, and the suction side of the compressor 21 and the gas-side stop valve 28 are connected. In the heating operation connection state, the discharge side of the compressor 21 and the gas-side stop valve 28 are connected, and the suction side of the compressor 21 and the outdoor heat exchanger 23 are connected.

The outdoor heat exchanger 23 is a heat exchanger that functions as a condenser for high-pressure refrigerant in the refrigeration cycle during cooling operation and that functions as an evaporator for low-pressure refrigerant in the refrigeration cycle during heating operation. The outdoor heat exchanger 23 is a cross-fin type fin-and-tube heat exchanger that includes a plurality of heat transfer fins 23a stacked in a plate thickness direction and a plurality of heat transfer tubes 23b fixedly extending through the plurality of heat transfer fins 23a. The outdoor heat exchanger 23 of the present embodiment is not limited and may have a plurality of refrigerant passages such that refrigerant flows while branching into two or more and 10 or less branches. The plurality of heat transfer tubes 23b of the outdoor heat exchanger 23 of the present embodiment is a cylindrical pipe except for curved portions and has an outer diameter of one selected from the group consisting of 6.35 mm, 7.0 mm, 8.0 mm, and 9.5 mm. The heat transfer tubes 23b having an outer diameter of 6.35 mm have a thickness of 0.25 mm or greater and 0.28 mm or less and preferably have a thickness of 0.266 mm. The heat transfer tubes 23b having an outer diameter of 7.0 mm have a thickness of 0.26 mm or greater and 0.29 mm or less and preferably have a thickness of 0.273 mm. The heat transfer tubes 23b having an outer diameter of 8.0 mm has a thickness of 0.28 mm or greater and 0.31 mm or less and preferably 0.295 mm. The heat transfer tubes 23b having an outer diameter of 9.5 mm have a thickness of 0.32 mm or greater and 0.36 mm or less and preferably have a thickness of 0.340 mm.

The outdoor fan 25 takes outdoor air into the outdoor unit 20, causes the air to exchange heat with refrigerant in the outdoor heat exchanger 23, and then generates air flow for emitting the air to the outside. The outdoor fan 25 is driven for rotation by an outdoor fan motor. In the present embodiment, only one outdoor fan 25 is provided.

The outdoor expansion valve 24 is able to control the valve opening degree, and is provided between a liquid-side end portion of the outdoor heat exchanger 23 and the liquid-side stop valve 29.

The liquid-side stop valve 29 is a manual valve disposed at a connection point at which the outdoor unit 20 is connected to the liquid-side connection pipe 6.

The gas-side stop valve 28 is a manual valve disposed at a connection point at which the outdoor unit 20 is connected to the gas-side connection pipe 5.

The outdoor unit 20 includes an outdoor unit control unit 27 that controls the operations of parts that make up the outdoor unit 20. The outdoor unit control unit 27 includes a microcomputer including a CPU, a memory, and the like. The outdoor unit control unit 27 is connected to an indoor unit control unit 34 of indoor unit 30 via a communication line, and sends or receives control signals, or the like, to or from the indoor unit control unit 34. The outdoor unit control unit 27 is electrically connected to various sensors (not shown), and receives signals from the sensors.

As shown in FIG. 18, the outdoor unit 20 includes the outdoor casing 50 having an air outlet 52. The outdoor casing 50 has a substantially rectangular parallelepiped shape. The outdoor casing 50 is able to take in outdoor air from a rear side and one side (the left side in FIG. 18) and is able to discharge air having passed through the outdoor heat exchanger 23 forward via the air outlet 52 formed in a front 51. A lower end portion of the outdoor casing 50 is covered with a bottom plate 53. As shown in FIG. 19, the outdoor heat exchanger 23 is provided upright on the bottom plate 53 along the rear side and the one side. A top face of the bottom plate 53 can function as a drain pan.

(6-2) Indoor Unit 30

The indoor unit 30 is placed on a wall surface, or the like, in a room that is a space to be air-conditioned. The indoor unit 30 is connected to the outdoor unit 20 via the liquid-side connection pipe 6 and the gas-side connection pipe 5, and makes up part of the refrigerant circuit 10.

The indoor unit 30 includes an indoor heat exchanger 31, an indoor fan 32, an indoor casing 54, and the like.

A liquid side of the indoor heat exchanger 31 is connected to the liquid-side connection pipe 6, and a gas side of the indoor heat exchanger 31 is connected to the gas-side connection pipe 5. The indoor heat exchanger 31 is a heat exchanger that functions as an evaporator for low-pressure refrigerant in the refrigeration cycle during cooling operation and that functions as a condenser for high-pressure refrigerant in the refrigeration cycle during heating operation. The indoor heat exchanger 31 includes a plurality of heat transfer fins 31a stacked in a plate thickness direction and a plurality of heat transfer tubes 31b fixedly extending through the plurality of heat transfer fins 31a. The plurality of heat transfer tubes 31b of the indoor heat exchanger 31 of the present embodiment each has a cylindrical shape and has an outer diameter of one selected from the group consisting of 4.0 mm, 5.0 mm, 6.35 mm, 7.0 mm, and 8.0 mm. The heat transfer tubes 31b having an outer diameter of 4.0 mm have a thickness of 0.24 mm or greater and 0.26 mm or less and preferably have a thickness of 0.251 mm. The heat transfer tubes 31b having an outer diameter of 5.0 mm have a thickness of 0.22 mm or greater and 0.25 mm or less and preferably have a thickness of 0.239 mm. The heat transfer tubes 31b having an outer diameter of 6.35 mm have a thickness of 0.25 mm or greater and 0.28 mm or less and preferably have a thickness of 0.266 mm. The heat transfer tubes 31b having an outer diameter of 7.0 mm have a thickness of 0.26 mm or greater and 0.29 mm or less and preferably have a thickness of 0.273 mm. The heat transfer tubes 31b having an outer diameter of 8.0 mm have a thickness of 0.28 mm or greater and 0.31 mm or less and preferably have a thickness of 0.295 mm.

The indoor fan 32 takes indoor air into the indoor casing 54 of the indoor unit 30, causes the air to exchange heat with refrigerant in the indoor heat exchanger 31, and then generates air flow for emitting the air to the outside. The indoor fan 32 is driven for rotation by an indoor fan motor (not shown).

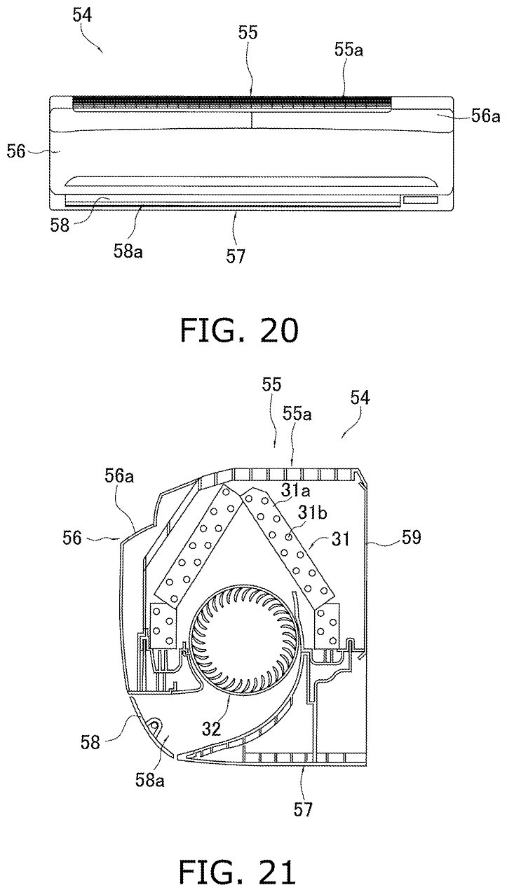

As shown in FIG. 20 and FIG. 21, the indoor casing 54 is a casing having a substantially rectangular parallelepiped shape and accommodates the indoor heat exchanger 31, the indoor fan 32, and an indoor unit control unit 34 inside. The indoor casing 54 includes a top 55 that makes up the upper end portion of the indoor casing 54, a front panel 56 that makes up the front of the indoor casing 54, a bottom 57 that makes up the bottom of the indoor casing 54, an air outlet 58a, a louver 58, a rear 59 facing an indoor wall surface, right and left sides (not shown), and the like. The top 55 has a plurality of top air inlets 55a open in the up-down direction. The front panel 56 is a panel expanding downward from near the front-side end portion of the top 55. The front panel 56 has a front air inlet 56a made up of a transversely narrow long opening at an upper part. Indoor air is taken into an air duct made up of a space in which the indoor heat exchanger 31 and the indoor fan 32 are accommodated inside the indoor casing 54 via these top air inlet 55a and the front air inlet 56a. The bottom 57 expands substantially horizontally below the indoor heat exchanger 31 and the indoor fan 32. The air outlet 58a is open forward and downward at the front lower side of the indoor casing 54, that is, the lower side of the front panel 56 and the front side of the bottom 57.

The indoor unit 30 includes an indoor unit control unit 34 that controls the operations of the parts that make up the indoor unit 30. The indoor unit control unit 34 includes a microcomputer including a CPU, a memory, and the like. The indoor unit control unit 34 is connected to the outdoor unit control unit 27 via a communication line, and sends or receives control signals, or the like, to or from the outdoor unit control unit 27.

The indoor unit control unit 34 is electrically connected to various sensors (not shown) provided inside the indoor unit 30, and receives signals from the sensors.

(6-3) Details of Controller 7

In the air conditioner 1, the outdoor unit control unit 27 and the indoor unit control unit 34 are connected via the communication line to make up the controller 7 that controls the operation of the air conditioner 1.

The controller 7 mainly includes a CPU (central processing unit) and a memory such as a ROM and a RAM. Various processes and controls made by the controller 7 are implemented by various parts included in the outdoor unit control unit 27 and/or the indoor unit control unit 34 functioning together.

(6-4) Operation Mode

Hereinafter, operation modes will be described.

The operation modes include a cooling operation mode and a heating operation mode.

The controller 7 determines whether the operation mode is the cooling operation mode or the heating operation mode and performs the selected operation mode based on an instruction received from the remote control unit, or the like.

(6-4-1) Cooling Operation Mode

In the air conditioner 1, in the cooling operation mode, the status of connection of the four-way valve 22 is set to the cooling operation connection state where the discharge side of the compressor 21 and the outdoor heat exchanger 23 are connected and the suction side of the compressor 21 and the gas-side stop valve 28 are connected, and refrigerant filled in the refrigerant circuit 10 is mainly circulated in order of the compressor 21, the outdoor heat exchanger 23, the outdoor expansion valve 24, and the indoor heat exchanger 31.

More specifically, when the cooling operation mode is started, refrigerant is taken into the compressor 21, compressed, and then discharged in the refrigerant circuit 10.

In the compressor 21, displacement control commensurate with a cooling load that is required from the indoor unit 30 is performed. Gas refrigerant discharged from the compressor 21 passes through the four-way valve 22 and flows into the gas-side end of the outdoor heat exchanger 23.

Gas refrigerant having flowed into the gas-side end of the outdoor heat exchanger 23 exchanges heat in the outdoor heat exchanger 23 with outdoor-side air that is supplied by the outdoor fan 25 to condense into liquid refrigerant and flows out from the liquid-side end of the outdoor heat exchanger 23.

Refrigerant having flowed out from the liquid-side end of the outdoor heat exchanger 23 is decompressed when passing through the outdoor expansion valve 24. The outdoor expansion valve 24 is controlled such that the degree of subcooling of refrigerant that passes through a liquid-side outlet of the outdoor heat exchanger 23 satisfies a predetermined condition.

Refrigerant decompressed in the outdoor expansion valve 24 passes through the liquid-side stop valve 29 and the liquid-side connection pipe 6 and flows into the indoor unit 30.

Refrigerant having flowed into the indoor unit 30 flows into the indoor heat exchanger 31, exchanges heat in the indoor heat exchanger 31 with indoor air that is supplied by the indoor fan 32 to evaporate into gas refrigerant, and flows out from the gas-side end of the indoor heat exchanger 31. Gas refrigerant having flowed out from the gas-side end of the indoor heat exchanger 31 flows to the gas-side connection pipe 5.

Refrigerant having flowed through the gas-side connection pipe 5 passes through the gas-side stop valve 28 and the four-way valve 22, and is taken into the compressor 21 again.

(6-4-2) Heating Operation Mode

In the air conditioner 1, in the heating operation mode, the status of connection of the four-way valve 22 is set to the heating operation connection state where the discharge side of the compressor 21 and the gas-side stop valve 28 are connected and the suction side of the compressor 21 and the outdoor heat exchanger 23 are connected, and refrigerant filled in the refrigerant circuit 10 is mainly circulated in order of the compressor 21, the indoor heat exchanger 31, the outdoor expansion valve 24, and the outdoor heat exchanger 23.

More specifically, when the heating operation mode is started, refrigerant is taken into the compressor 21, compressed, and then discharged in the refrigerant circuit 10.

In the compressor 21, displacement control commensurate with a heating load that is required from the indoor unit 30 is performed. Gas refrigerant discharged from the compressor 21 flows through the four-way valve 22 and the gas-side connection pipe 5 and then flows into the indoor unit 30.

Refrigerant having flowed into the indoor unit 30 flows into the gas-side end of the indoor heat exchanger 31, exchanges heat in the indoor heat exchanger 31 with indoor air that is supplied by the indoor fan 32 to condense into refrigerant in a gas-liquid two-phase state or liquid refrigerant, and flows out from the liquid-side end of the indoor heat exchanger 31. Refrigerant having flowed out from the liquid-side end of the indoor heat exchanger 31 flows into the liquid-side connection pipe 6.

Refrigerant having flowed through the liquid-side connection pipe 6 is decompressed to a low pressure in the refrigeration cycle in the liquid-side stop valve 29 and the outdoor expansion valve 24. The outdoor expansion valve 24 is controlled such that the degree of subcooling of refrigerant that passes through a liquid-side outlet of the indoor heat exchanger 31 satisfies a predetermined condition. Refrigerant decompressed in the outdoor expansion valve 24 flows into the liquid-side end of the outdoor heat exchanger 23.

Refrigerant having flowed in from the liquid-side end of the outdoor heat exchanger 23 exchanges heat in the outdoor heat exchanger 23 with outdoor air that is supplied by the outdoor fan 25 to evaporate into gas refrigerant, and flows out from the gas-side end of the outdoor heat exchanger 23.

Refrigerant having flowed out from the gas-side end of the outdoor heat exchanger 23 passes through the four-way valve 22 and is taken into the compressor 21 again.

(6-5) Characteristics of First Embodiment

In the above-described air conditioner 1, since refrigerant containing 1,2-difluoroethylene is used, a GWP can be sufficiently reduced.

The outdoor heat exchanger 23 of the outdoor unit 20 of the air conditioner 1 uses the heat transfer tubes 23b of which the pipe diameter is greater than or equal to 6.35 mm. Therefore, even when the above-described refrigerant that more easily causes a pressure loss than R32 is used, a pressure loss at the time when the refrigerant passes through the heat transfer tubes 23b can be reduced. Even when a change in the temperature (temperature glide) of refrigerant flowing through the outdoor heat exchanger 23 occurs, the extent of the change can be reduced. In addition, the outdoor heat exchanger 23 uses the heat transfer tubes 23b of which the pipe diameter is less than 10.0 mm. Therefore, the amount of refrigerant held in the outdoor heat exchanger 23 can be reduced.

The indoor heat exchanger 31 of the indoor unit 30 of the air conditioner 1 uses the heat transfer tubes 31b of which the pipe diameter is greater than or equal to 4.0 mm. Therefore, even when the above-described refrigerant that more easily causes a pressure loss than R32 is used, a pressure loss at the time when the refrigerant passes through the heat transfer tubes 31b can be reduced. Even when a change in the temperature (temperature glide) of refrigerant flowing through the indoor heat exchanger 31 occurs, the extent of the change can be reduced. In addition, the indoor heat exchanger 31 also uses the heat transfer tubes 31b of which the pipe diameter is less than 10.0 mm. Therefore, the amount of refrigerant held in the indoor heat exchanger 31 can be reduced.

(6-6) Modification A of First Embodiment

In the above-described first embodiment, the air conditioner including only one indoor unit is described as an example; however, the air conditioner may include a plurality of indoor units (with no indoor expansion valve) connected in parallel with each other.

### (7) Second Embodiment

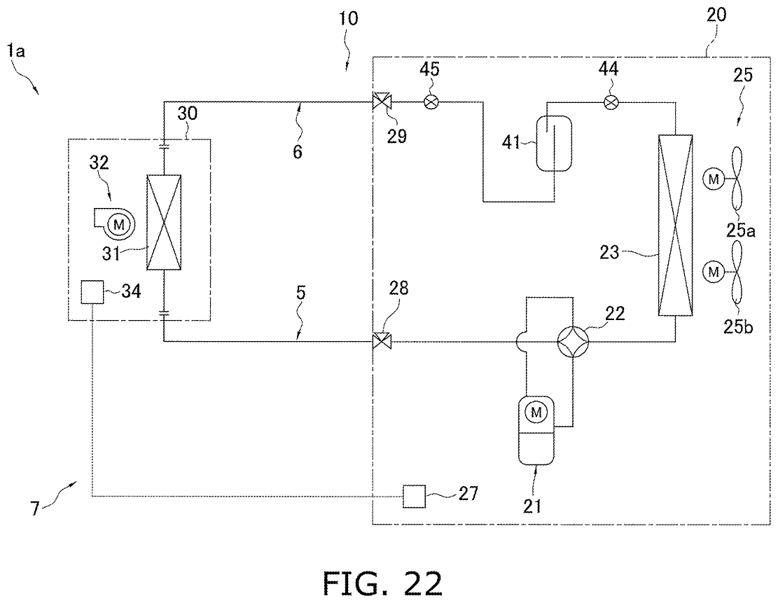

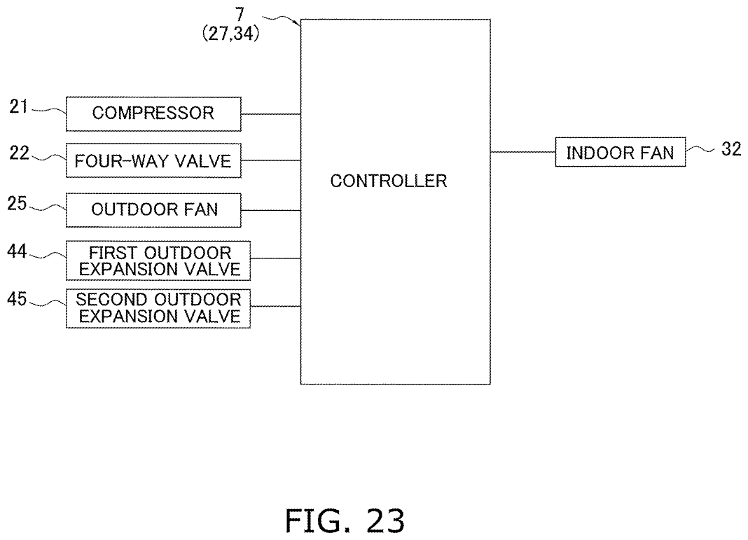

Hereinafter, an air conditioner 1a that serves as a refrigeration cycle apparatus according to a second embodiment will be described with reference to FIG. 22 that is the schematic configuration diagram of a refrigerant circuit and FIG. 23 that is a schematic control block configuration diagram.

Hereinafter, mainly, the air conditioner 1a of the second embodiment will be described with a focus on a portion different from the air conditioner 1 of the first embodiment.

In the air conditioner 1a as well, the refrigerant circuit 10 is filled with a refrigerant mixture that contains 1,2-difluoroethylene and that is any one of the above-described refrigerants A to E as a refrigerant for performing a vapor compression refrigeration cycle. The refrigerant circuit 10 is filled with refrigerating machine oil together with the refrigerant.

(7-1) Outdoor Unit 20

In the outdoor unit 20 of the air conditioner 1a of the second embodiment, a first outdoor fan 25a and a second outdoor fan 25b are provided as the outdoor fans 25. The outdoor heat exchanger 23 of the outdoor unit 20 of the air conditioner 1a has a wide heat exchange area so as to adapt to air flow coming from the first outdoor fan 25a and the second outdoor fan 25b.

In the outdoor unit 20 of the air conditioner 1a, instead of the outdoor expansion valve 24 of the outdoor unit 20 in the above-described first embodiment, a first outdoor expansion valve 44, an intermediate pressure receiver 41, and a second outdoor expansion valve 45 are sequentially provided between the liquid side of the outdoor heat exchanger 23 and the liquid-side stop valve 29. The first outdoor expansion valve 44 and the second outdoor expansion valve 45 each are able to control the valve opening degree. The intermediate pressure receiver 41 is a container that is able to store refrigerant. Both an end portion of a pipe extending from the first outdoor expansion valve 44 side and an end portion of a pipe extending from the second outdoor expansion valve 45 side are located in the internal space of the intermediate pressure receiver 41.

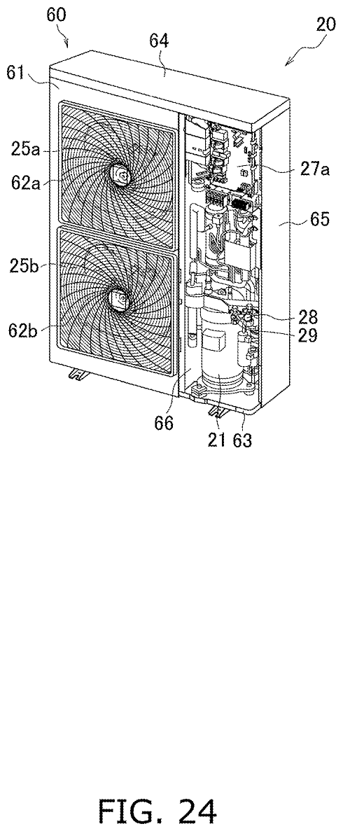

The outdoor unit 20 of the second embodiment has a structure in which a fan chamber and a machine chamber are formed (so-called trunk structure) when the internal space of a casing 60 having a substantially rectangular parallelepiped shape is divided into right and left spaces by a partition plate 66 extending vertically, as shown in FIG. 24.

The outdoor heat exchanger 23, the outdoor fan 25 (a first outdoor fan 25a and a second outdoor fan 25b), and the like, are disposed in the fan chamber inside the casing 60. The compressor 21, the four-way valve 22, a first outdoor expansion valve 44, a second outdoor expansion valve 45, an intermediate pressure receiver 41, the gas-side stop valve 28, the liquid-side stop valve 29, and an electric component unit 27a that makes up the outdoor unit control unit 27, and the like, are disposed in the machine chamber inside the casing 60.

The casing 60 mainly includes a bottom plate 63, a top panel 64, a left front panel 61, a left-side panel (not shown), a right front panel (not shown), a right-side panel 65, the partition plate 66, and the like. The bottom plate 63 makes up a bottom part of the casing 60. The top panel 64 makes up a top part of the outdoor unit 20. The left front panel 61 mainly makes up a left front part of the casing 60, and has a first air outlet 62a and a second air outlet 62b that are open in a front-rear direction and arranged one above the other. Air taken in from the rear side and left side of the casing 60 by the first outdoor fan 25a and having passed through an upper part of the outdoor heat exchanger 23 passes through the first air outlet 62a. Air taken in from the rear side and left side of the casing 60 by the second outdoor fan 25b and having passed through a lower part of the outdoor heat exchanger 23 passes through the second air outlet 62b. A fan grille is provided at each of the first air outlet 62a and the second air outlet 62b. The left-side panel mainly makes up a left side part of the casing 60 and is also able to function as an inlet for air that is taken into the casing 60. The right front panel mainly makes up a right front part and a front-side part of the right side of the casing 60. The right-side panel 65 mainly makes up a rear-side part of the right side and right-side part of the rear of the casing 60. The partition plate 66 is a plate-shaped member extending vertically and disposed on the bottom plate 63, and divides the internal space of the casing 60 into the fan chamber and the machine chamber.

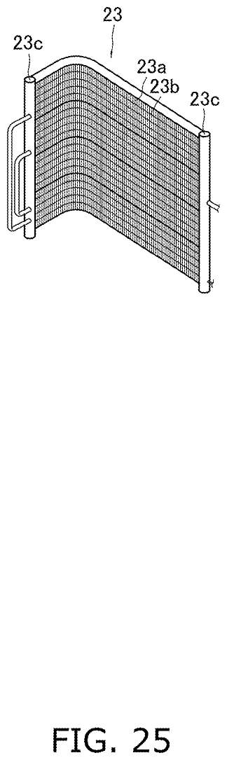

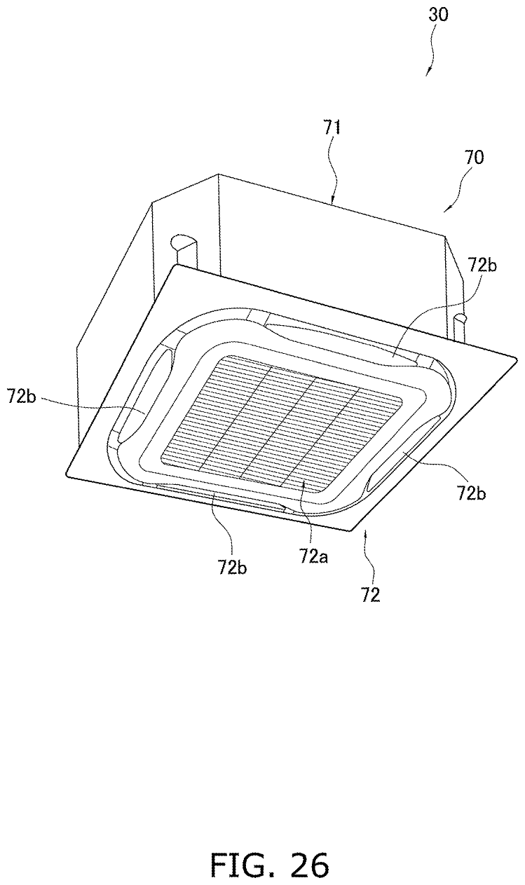

For example, as shown in FIG. 25, the outdoor heat exchanger 23 is a cross-fin type fin-and-tube heat exchanger that includes a plurality of heat transfer fins 23a stacked in a plate thickness direction and a plurality of heat transfer tubes 23b fixedly extending through the plurality of heat transfer fins 23a. The outdoor heat exchanger 23 is disposed in an L-shape in plan view along the left side and rear of the casing 60 inside the fan chamber. The outdoor heat exchanger 23 of the present embodiment is not limited and may have a plurality of refrigerant passages such that refrigerant flows while branching into 10 or more and 20 or less branches. The plurality of heat transfer tubes 23b of the outdoor heat exchanger 23 of the present embodiment is a cylindrical pipe except for curved portions and has an outer diameter of one selected from the group consisting of 6.35 mm, 7.0 mm, 8.0 mm, and 9.5 mm. The relationship between the outer diameter and thickness of each heat transfer tube 23b is similar to that of the above-described first embodiment.

The compressor 21 is mounted on the bottom plate 63 and fixed by bolts in the machine chamber of the casing 60.

The gas-side stop valve 28 and the liquid-side stop valve 29 are disposed near the right front corner at the level near the upper end of the compressor 21 in the machine chamber of the casing 60.

The electric component unit 27a is disposed in a space above both of the gas-side stop valve 28 and the liquid-side stop valve 29 in the machine chamber of the casing 60.

In the above air conditioner 1a, in the cooling operation mode, the first outdoor expansion valve 44 is, for example, controlled such that the degree of subcooling of refrigerant that passes through the liquid-side outlet of the outdoor heat exchanger 23 satisfies a predetermined condition. In the cooling operation mode, the second outdoor expansion valve 45 is, for example, controlled such that the degree of superheating of refrigerant that the compressor 21 takes in satisfies a predetermined condition.

In the heating operation mode, the second outdoor expansion valve 45 is, for example, controlled such that the degree of subcooling of refrigerant that passes through the liquid-side outlet of the indoor heat exchanger 31 satisfies a predetermined condition. In the heating operation mode, the first outdoor expansion valve 44 is, for example, controlled such that the degree of superheating of refrigerant that the compressor 21 takes in satisfies a predetermined condition.

(7-2) Indoor Unit 30

The indoor unit 30 of the second embodiment is placed so as to be suspended in an upper space in a room that is a space to be air-conditioned or placed at a ceiling surface or placed on a wall surface and used. The indoor unit 30 is connected to the outdoor unit 20 via the liquid-side connection pipe 6 and the gas-side connection pipe 5, and makes up part of the refrigerant circuit 10.

The indoor unit 30 includes an indoor heat exchanger 31, an indoor fan 32, an indoor casing 70, and the like.

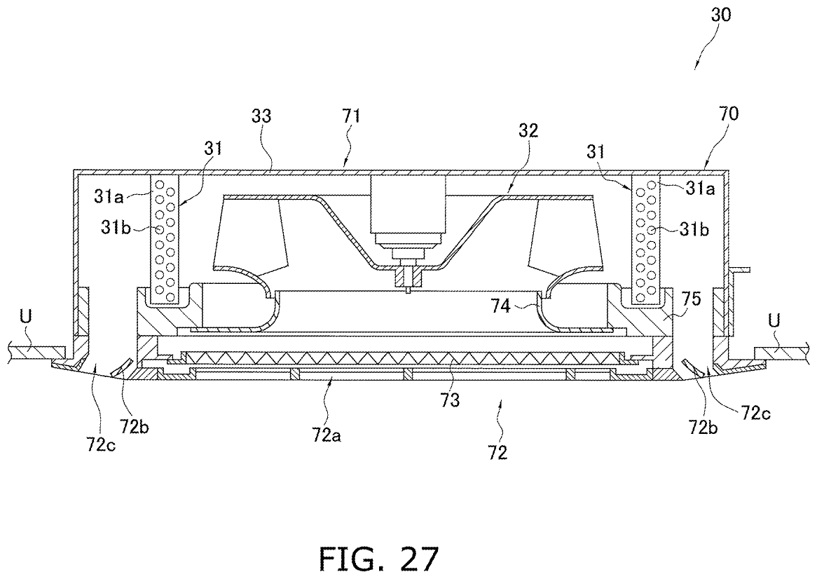

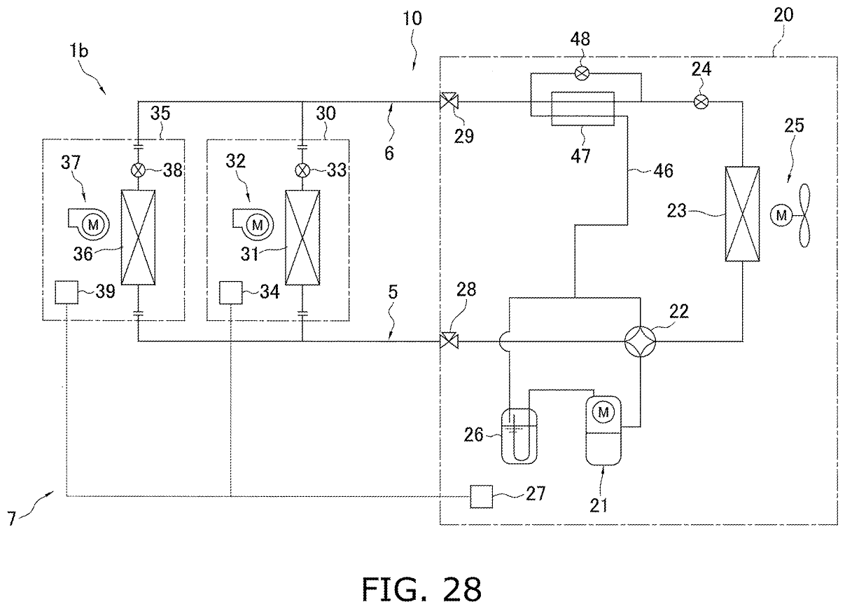

As shown in FIG. 26 and FIG. 27, the indoor casing 70 includes a casing body 71 and a decorative panel 72. The casing body 71 is open at its lower side and accommodates the indoor heat exchanger 31, the indoor fan 32, and the like, inside. The decorative panel 72 covers the underside of the casing body 71 and includes an air inlet 72a, a plurality of flaps 72b, a plurality of air outlets 72c, and the like. Indoor air taken in from the air inlet 72a passes through a filter 73 and is then guided by a bell mouth 74 to a suction side of the indoor fan 32. Air sent from the indoor fan 32 passes through the indoor heat exchanger 31 disposed above a drain pan 75, passes through a passage provided around the drain pan 75, and then discharged from the air outlets 72c into a room.

The indoor heat exchanger 31 of the second embodiment is provided so as to surround the indoor fan 32 in a substantially rectangular shape in plan view. The indoor heat exchanger 31 includes a plurality of heat transfer fins 31a stacked in a plate thickness direction and a plurality of heat transfer tubes 31b fixedly extending through the plurality of heat transfer fins 31a. The plurality of heat transfer tubes 31b of the indoor heat exchanger 31 of the second embodiment each has a cylindrical shape and has an outer diameter of one selected from the group consisting of 4.0 mm, 5.0 mm, 6.35 mm, 7.0 mm, 8.0 mm, and 9.5 mm. The heat transfer tubes 31b having an outer diameter of 9.5 mm have a thickness of 0.32 mm or greater and 0.36 mm or less and preferably have a thickness of 0.340 mm. The other relationship between the outer diameter and thickness of each heat transfer tube 31b is similar to that of the above-described first embodiment.

(7-3) Characteristics of Second Embodiment

In the above-described air conditioner 1a according to the second embodiment as well, as well as the air conditioner 1 according to the first embodiment, since refrigerant containing 1,2-difluoroethylene is used, a GWP can be sufficiently reduced.

For the outdoor heat exchanger 23 of the outdoor unit 20 of the air conditioner 1a as well, a pressure loss at the time when the refrigerant that more easily causes a pressure loss than R32 passes through the heat transfer tubes 23b can be reduced, and, even when a change in the temperature (temperature glide) of refrigerant flowing through the outdoor heat exchanger 23 occurs, the extend of the change can be reduced. In addition, the amount of refrigerant held in the outdoor heat exchanger 23 can be reduced.

For the indoor heat exchanger 31 of the indoor unit 30 of the air conditioner 1a as well, even when the above-described refrigerant that more easily causes a pressure loss than R32 is used, a pressure loss at the time when the refrigerant that more easily causes a pressure loss than R32 passes through the heat transfer tubes 31b can be reduced, and, even when a change in the temperature (temperature glide) of refrigerant flowing through the indoor heat exchanger 31 occurs, the extent of the change can be reduced. In addition, the amount of refrigerant held in the indoor heat exchanger 31 can be reduced.

(7-4) Modification A of Second Embodiment

In the above-described second embodiment, the air conditioner including only one indoor unit is described as an example; however, the air conditioner may include a plurality of indoor units (with no indoor expansion valve) connected in parallel with each other.

### (8) Third Embodiment

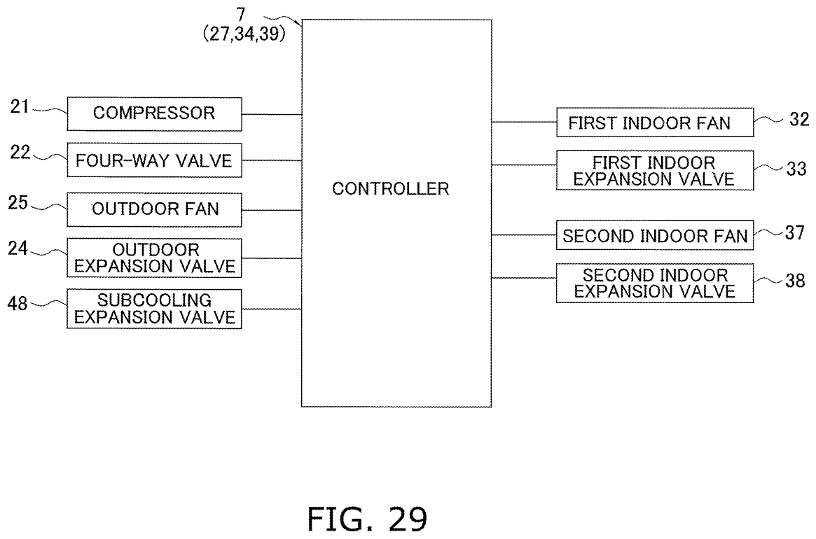

Hereinafter, an air conditioner 1b that serves as a refrigeration cycle apparatus according to a third embodiment will be described with reference to FIG. 28 that is the schematic configuration diagram of a refrigerant circuit and FIG. 29 that is a schematic control block configuration diagram.

Hereinafter, mainly, the air conditioner 1b of the third embodiment will be described with a focus on a portion different from the air conditioner 1 of the first embodiment.

In the air conditioner 1b as well, the refrigerant circuit 10 is filled with a refrigerant mixture that contains 1,2-difluoroethylene and that is any one of the above-described refrigerants A to E as a refrigerant for performing a vapor compression refrigeration cycle. The refrigerant circuit 10 is filled with refrigerating machine oil together with the refrigerant.

(8-1) Outdoor Unit 20

In the outdoor unit 20 of the air conditioner 1b of the third embodiment, a low-pressure receiver 26, a subcooling heat exchanger 47, and a subcooling circuit 46 are provided in the outdoor unit 20 in the above-described first embodiment.

The low-pressure receiver 26 is a container that is provided between one of connection ports of the four-way valve 22 and the suction side of the compressor 21 and that is able to store refrigerant. In the present embodiment, the low-pressure receiver 26 is provided separately from the attached accumulator of the compressor 21.

The subcooling heat exchanger 47 is provided between the outdoor expansion valve 24 and the liquid-side stop valve 29.

The subcooling circuit 46 is a circuit that branches off from a main circuit between the outdoor expansion valve 24 and the subcooling heat exchanger 47 and that merges with a portion halfway from one of the connection ports of the four-way valve 22 to the low-pressure receiver 26. A subcooling expansion valve 48 that decompresses refrigerant passing therethrough is provided halfway in the subcooling circuit 46. Refrigerant flowing through the subcooling circuit 46 and decompressed by the subcooling expansion valve 48 exchanges heat with refrigerant flowing through the main circuit side in the subcooling heat exchanger 47. Thus, refrigerant flowing through the main circuit side is further cooled, and refrigerant flowing through the subcooling circuit 46 evaporates.

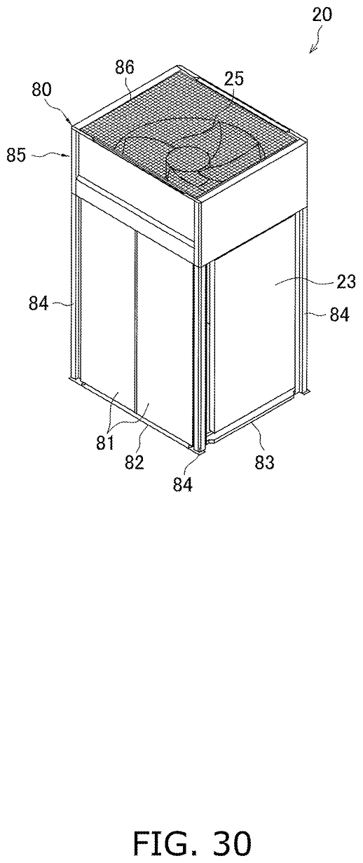

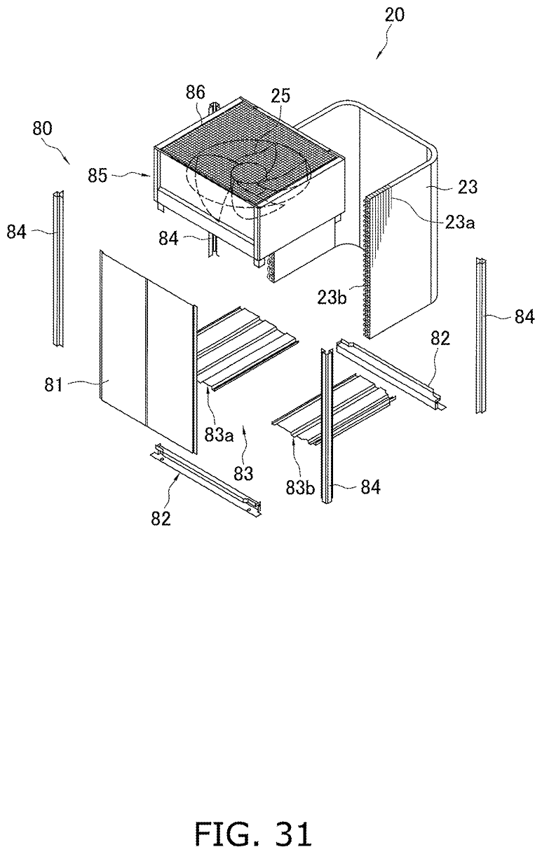

The detailed structure of the outdoor unit 20 of the air conditioner 1b according to the third embodiment will be described below with reference to the appearance perspective view of FIG. 30 and the exploded perspective view of FIG. 31.

The outdoor unit 20 of the air conditioner 1b may have an up-blow structure that takes in air from the lower side into an outdoor casing 80 and discharges air outward of the outdoor casing 80 from the upper side.

The outdoor casing 80 mainly includes a bottom plate 83 bridged on a pair of installation legs 82 extending in a right-left direction, supports 84 extending in a vertical direction from corners of the bottom plate 83, a front panel 81, and a fan module 85. The bottom plate 83 forms the bottom of the outdoor casing 80 and is separated into a left-side first bottom plate 83a and a right-side second bottom plate 83b. The front panel 81 is bridged between the front-side supports 84 below the fan module 85 and makes up the front of the outdoor casing 80. Inside the outdoor casing 80, the compressor 21, the outdoor heat exchanger 23, the low-pressure receiver 26, the four-way valve 22, the outdoor expansion valve 24, the subcooling heat exchanger 47, the subcooling expansion valve 48, the subcooling circuit 46, the gas-side stop valve 28, the liquid-side stop valve 29, the outdoor unit control unit 27, and the like, are disposed in the space below the fan module 85 and above the bottom plate 83. The outdoor heat exchanger 23 has a substantially U-shape in plan view facing the rear and both right and left sides within a part of the casing 80 below the fan module 85 and substantially forms the rear and both right and left sides of the outdoor casing 80. The outdoor heat exchanger 23 is disposed on the bottom plate 83 along the left-side edge portion, rear-side edge portion and right-side edge portion of the bottom plate 83. The outdoor heat exchanger 23 of the third embodiment is a cross-fin type fin-and-tube heat exchanger that includes a plurality of heat transfer fins 23a stacked in a plate thickness direction and a plurality of heat transfer tubes 23b fixedly extending through the plurality of heat transfer fins 23a. The outdoor heat exchanger 23 of the present embodiment is not limited and may have a plurality of refrigerant passages such that refrigerant flows while branching into 20 or more and 40 or less branches. The plurality of heat transfer tubes 23b of the outdoor heat exchanger 23 of the third embodiment is a cylindrical pipe except for curved portions and has an outer diameter of one selected from the group consisting of 7.0 mm, 8.0 mm, and 9.5 mm. The relationship between the outer diameter and thickness of each heat transfer tube 23b is similar to that of the above-described first embodiment.

The fan module 85 is provided above the outdoor heat exchanger 23, and includes the outdoor fan 25, a bell mouth (not shown), and the like. The outdoor fan 25 is disposed in such an orientation that the rotation axis coincides with the vertical direction.

With the above structure, air flow formed by the outdoor fan 25 passes from around the outdoor heat exchanger 23 through the outdoor heat exchanger 23 and flows into the outdoor casing 80, and is discharged upward via an air outlet 86 provided so as to extend through in an up-down direction at the upper end surface of the outdoor casing 80.

(8-2) First Indoor Unit 30 and Second Indoor Unit 35

In the air conditioner 1b according to the third embodiment, instead of the indoor unit 30 in the above-described first embodiment, a first indoor unit 30 and a second indoor unit 35 are provided in parallel with each other.

The first indoor unit 30, as well as the indoor unit 30 in the above-described first embodiment, includes a first indoor heat exchanger 31, a first indoor fan 32, and a first indoor unit control unit 34, and further includes a first indoor expansion valve 33 at the liquid side of the first indoor heat exchanger 31. The first indoor expansion valve 33 is able to control the valve opening degree.

The second indoor unit 35, as well as the first indoor unit 30, includes a second indoor heat exchanger 36, a second indoor fan 37, a second indoor unit control unit 39, and a second indoor expansion valve 38 provided at the liquid side of the second indoor heat exchanger 36. The second indoor expansion valve 38 is able to control the valve opening degree.

The specific structures of the first indoor unit 30 and second indoor unit 35 of the air conditioner 1b according to the third embodiment each have a similar configuration to the indoor unit 30 of the second embodiment except the above-described first indoor expansion valve 33 and second indoor expansion valve 38. The first indoor heat exchanger 31 and the second indoor heat exchanger 36 each have a plurality of heat transfer tubes having a cylindrical shape, and the outer diameter of each heat transfer tube is one selected from the group consisting of 4.0 mm, 5.0 mm, 6.35 mm, 7.0 mm, 8.0 mm, and 9.5 mm. The relationship between the outer diameter and thickness of each heat transfer tube 23b is similar to that of the above-described second embodiment.

The controller 7 of the third embodiment is made up of the outdoor unit control unit 27, the first indoor unit control unit 34, and the second indoor unit control unit 39 communicably connected to one another.

In the above air conditioner 1b, in the cooling operation mode, the outdoor expansion valve 24 is controlled such that the degree of subcooling of refrigerant that passes through the liquid-side outlet of the outdoor heat exchanger 23 satisfies a predetermined condition. In the cooling operation mode, the subcooling expansion valve 48 is controlled such that the degree of superheating of refrigerant that the compressor 21 takes in satisfies a predetermined condition. In the cooling operation mode, the first indoor expansion valve 33 and the second indoor expansion valve 38 are controlled to a fully open state.

In the heating operation mode, the first indoor expansion valve 33 is controlled such that the degree of subcooling of refrigerant that passes through the liquid-side outlet of the first indoor heat exchanger 31 satisfies a predetermined condition. Similarly, the second indoor expansion valve 38 is also controlled such that the degree of subcooling of refrigerant that passes through the liquid-side outlet of the second indoor heat exchanger 36 satisfies a predetermined condition. In the heating operation mode, the outdoor expansion valve 45 is controlled such that the degree of superheating of refrigerant that the compressor 21 takes in satisfies a predetermined condition. In the heating operation mode, the subcooling expansion valve 48 is controlled such that the degree of superheating of refrigerant that the compressor 21 takes in satisfies a predetermined condition.

(8-3) Characteristics of Third Embodiment

In the above-described air conditioner 1b according to the third embodiment as well, as well as the air conditioner 1 according to the first embodiment, since refrigerant containing 1,2-difluoroethylene is used, a GWP can be sufficiently reduced.

For the outdoor heat exchanger 23 of the outdoor unit 20 of the air conditioner 1b as well, a pressure loss at the time when the refrigerant that more easily causes a pressure loss than R32 passes through the heat transfer tubes 23b can be reduced, and, even when a change in the temperature (temperature glide) of refrigerant flowing through the outdoor heat exchanger 23 occurs, the extend of the change can be reduced. In addition, the amount of refrigerant held in the outdoor heat exchanger 23 can be reduced.

For the indoor heat exchanger 31 of the indoor unit 30 of the air conditioner 1b as well, even when the above-described refrigerant that more easily causes a pressure loss than R32 is used, a pressure loss at the time when the refrigerant that more easily causes a pressure loss than R32 passes through the heat transfer tubes 31b can be reduced, and, even when a change in the temperature (temperature glide) of refrigerant flowing through the indoor heat exchanger 31 occurs, the extent of the change can be reduced. In addition, the amount of refrigerant held in the indoor heat exchanger 31 can be reduced.

### (9) Others

An air conditioner or an outdoor unit may be made up of a combination of the above-described first embodiment to third embodiment and modifications as needed.

The embodiments of the present disclosure are described above; however, it is understood that various modifications of modes and details are applicable without departing from the purport or scope of the present disclosure recited in the claims.

### REFERENCE SIGNS LIST

1, 1a, 1b air conditioner (refrigeration cycle apparatus)
10 refrigerant circuit
20 outdoor unit
21 compressor
23 outdoor heat exchanger (heat source-side heat exchanger)
23a fin
23b heat transfer tube
24 outdoor expansion valve (decompression part)
30 indoor unit, first indoor unit
31 indoor heat exchanger, first indoor heat exchanger (service-side heat exchanger)
31a fin
31b heat transfer tube
35 second indoor unit
36 second indoor heat exchanger (service-side heat exchanger)
36a fin
36b heat transfer tube
44 first outdoor expansion valve (decompression part)
45 second outdoor expansion valve (decompression part)

### CITATION LIST

### Patent Literature

PTL 1 International Publication No. 2015/141678
PTL 2 Japanese Unexamined Patent Application Publication No. 2002-054888

1. A refrigeration cycle apparatus comprising:
a refrigerant circuit including a compressor, a heat source-side heat exchanger, a decompression part, and a service-side heat exchanger; and
a refrigerant containing at least 1,2-difluoroethylene and sealed in the refrigerant circuit, wherein
the heat source-side heat exchanger has a heat transfer tube of which a pipe diameter is greater than or equal to 6.35 mm and less than 10.0 mm.

2. The refrigeration cycle apparatus according to claim 1, wherein
the heat source-side heat exchanger has the heat transfer tube of which the pipe diameter is any one of 6.35 mm, 7.0 mm, 8.0 mm, and 9.5 mm.

3. The refrigeration cycle apparatus according to claim 1, wherein
the heat source-side heat exchanger has the heat transfer tube of which the pipe diameter is greater than or equal to 7.0 mm.

4. A refrigeration cycle apparatus comprising:
a refrigerant circuit including a compressor, a heat source-side heat exchanger, a decompression part, and a service-side heat exchanger; and
a refrigerant containing at least 1,2-difluoroethylene and sealed in the refrigerant circuit, wherein
the service-side heat exchanger has a heat transfer tube of which a pipe diameter is greater than or equal to 4.0 mm and less than 10.0 mm.

5. The refrigeration cycle apparatus according to claim 4, wherein
the service-side heat exchanger has the heat transfer tube of which the pipe diameter is less than or equal to 8.0 mm.

6. The refrigeration cycle apparatus according to claim 4, wherein
the service-side heat exchanger has the heat transfer tube of which the pipe diameter is any one of 4.0 mm, 5.0 mm, 6.35 mm, 7.0 mm, and 8.0 mm.

7. The refrigeration cycle apparatus according to claim 1,
wherein
the refrigerant comprises trans-1,2-difluoroethylene (HFO-1132(E)), trifluoroethylene (HFO-1123), and 2,3,3,3-tetrafluoro-1-propene (R1234yf).

8. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0),
point C (32.9, 67.1, 0.0), and
point O (100.0, 0.0, 0.0),
or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.

9. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
point G (72.0, 28.0, 0.0),
point I (72.0, 0.0, 28.0),
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.

10. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
point J (47.1, 52.9, 0.0),
point P (55.8, 42.0, 2.2),
point N (68.6, 16.3, 15.1),
point K (61.3, 5.4, 33.3),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.

11. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
point J (47.1, 52.9, 0.0),
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PL is represented by coordinates (x, −0.1135x²+12.112x−280.43, 0.1135x²−13.112x+380.43)
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

12. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.

13. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
point P (55.8, 42.0, 2.2),
point L (63.1, 31.9, 5.0),
point Q (62.8, 29.6, 7.6), and
point R (49.8, 42.3, 7.9),
or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.

14. The refrigeration cycle apparatus according to claim 7,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
point S (62.6, 28.3, 9.1),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.

15. The refrigeration cycle apparatus according to claim 1,
wherein
the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.

16. The refrigeration cycle apparatus according to claim 1,
wherein
the refrigerant comprises trans-1,2-difluoroethylene (HFO-1132(E)), and trifluoroethylene (HFO-1123) in a total amount of 99.5 mass % or more based on the entire refrigerant, and
the refrigerant comprises 45.1 mass % to 47.1 mass % of HFO-1132(E) based on the entire refrigerant.

17. The refrigeration cycle apparatus according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
point G (0.026a²−1.7478a+72.0, −0.026a²+0.7478a+28.0, 0.0),
point I (0.026a²−1.7478a+72.0, 0.0, −0.026a²+0.7478a+28.0),
point A (0.0134a²−1.9681a+68.6, 0.0, −0.0134a²+0.9681a+31.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
point G (0.02a²−1.6013a+71.105, −0.02a²+0.6013a+28.895, 0.0),
point I (0.02a²−1.6013a+71.105, 0.0, −0.02a²+0.6013a+28.895),
point A (0.0112a²−1.9337a+68.484, 0.0, −0.0112a²+0.9337a+31.516),
point B (0.0, 0.0075a²−1.5156a+58.199, −0.0075a²+0.5156a+41.801), and
point W (0.0, 100.0−a, 0.0),
or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
point G (0.0135a²−1.4068a+69.727, −0.0135a²+0.4068a+30.273, 0.0),
point I (0.0135a²−1.4068a+69.727, 0.0, −0.0135a²+0.4068a+30.273),
point A (0.0107a²−1.9142a+68.305, 0.0, −0.0107a²+0.9142a+31.695),
point B (0.0, 0.009a²−1.6045a+59.318, −0.009a²+0.6045a+40.682), and
point W (0.0, 100.0−a, 0.0),
or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
point G (0.0111a²−1.3152a+68.986, −0.0111a²+0.3152a+31.014, 0.0),
point I (0.0111a²−1.3152a+68.986, 0.0, −0.0111a²+0.3152a+31.014),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
point G (0.0061a²−0.9918a+63.902, −0.0061a²−0.0082a+36.098, 0.0),
point I (0.0061a²−0.9918a+63.902, 0.0, −0.0061a²−0.0082a+36.098),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines GI and AB (excluding point G, point I, point A, point B, and point W).

18. The refrigeration cycle apparatus according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
point J (0.0049a²−0.9645a+47.1, −0.0049a²−0.0355a+52.9, 0.0),
point K′ (0.0514a²−2.4353a+61.7, −0.0323a²+0.4122a+5.9, −0.0191a²+1.0231a+32.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
point J (0.0243a²−1.4161a+49.725, −0.0243a²+0.4161a+50.275, 0.0),
point K′ (0.0341a²−2.1977a+61.187, −0.0236a²+0.34a+5.636, −0.0105a²+0.8577a+33.177),
point B (0.0, 0.0075a²−1.5156a+58.199, −0.0075a²+0.5156a+41.801), and
point W (0.0, 100.0−a, 0.0),
or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
point J (0.0246a²−1.4476a+50.184, −0.0246a²+0.4476a+49.816, 0.0),
point K′ (0.0196a²−1.7863a+58.515, −0.0079a²−0.1136a+8.702, −0.0117a²+0.8999a+32.783),
point B (0.0, 0.009a²−1.6045a+59.318, −0.009a²+0.6045a+40.682), and
point W (0.0, 100.0−a, 0.0),
or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
point J (0.0183a²−1.1399a+46.493, −0.0183a²+0.1399a+53.507, 0.0),
point K′ (−0.0051a²+0.0929a+25.95, 0.0, 0.0051a²−1.0929a+74.05),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
point J (−0.0134a²+1.0956a+7.13, 0.0134a²−2.0956a+92.87, 0.0),
point K′ (−1.892a+29.443, 0.0, 0.892a+70.557),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines JK′, K′A, and AB (excluding point J, point B, and point W).

19. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
point I (72.0, 0.0, 28.0),
point J (48.5, 18.3, 33.2),
point N (27.7, 18.2, 54.1), and
point E (58.3, 0.0, 41.7),
or on these line segments (excluding the points on the line segment EI;
the line segment U is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.

20. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
point M (52.6, 0.0, 47.4),
point M′(39.2, 5.0, 55.8),
point N (27.7, 18.2, 54.1),
point V (11.0, 18.1, 70.9), and
point G (39.6, 0.0, 60.4),
or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.

21. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
point O (22.6, 36.8, 40.6),
point N (27.7, 18.2, 54.1), and
point U (3.9, 36.7, 59.4),
or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.

22. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
point Q (44.6, 23.0, 32.4),
point R (25.5, 36.8, 37.7),
point T (8.6, 51.6, 39.8),
point L (28.9, 51.7, 19.4), and
point K (35.6, 36.8, 27.6),
or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.

23. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
point P (20.5, 51.7, 27.8),
point S (21.9, 39.7, 38.4), and
point T (8.6, 51.6, 39.8),
or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.

24. The refrigeration cycle apparatus according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
point I (72.0, 28.0, 0.0),
point K (48.4, 33.2, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines.

25. The refrigeration cycle apparatus according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments U, JR, RG, and GI that connect the following 4 points:
point I (72.0, 28.0, 0.0),
point J (57.7, 32.8, 9.5),
point R (23.1, 67.4, 9.5), and
point G (38.5, 61.5, 0.0),
or on these line segments (excluding the points on the line segment GI);
the line segment U is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines.

26. The refrigeration cycle apparatus according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
point M (47.1, 52.9, 0.0),
point P (31.8, 49.8, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines.

27. The refrigeration cycle apparatus according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
point M (47.1, 52.9, 0.0),
point N (38.5, 52.1, 9.5),
point R (23.1, 67.4, 9.5), and
point G (38.5, 61.5, 0.0),
or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z), and
the line segments JR and GI are straight lines.

28. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
point P (31.8, 49.8, 18.4),
point S (25.4, 56.2, 18.4), and
point T (34.8, 51.0, 14.2),
or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line.

29. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
point Q (28.6, 34.4, 37.0),
point B″ (0.0, 63.0, 37.0),
point D (0.0, 67.0, 33.0), and
point U (28.7, 41.2, 30.1),
or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines.
